(19) United States
(12) Patent Application Publication
(10) Pub. No.: US 2024/0388545 A1
(43) Pub. Date: Nov. 21, 2024

(54) PACKET PROCESSING METHOD, GATEWAY DEVICE, AND STORAGE SYSTEM

(71) Applicant: HUAWEI TECHNOLOGIES CO., LTD., Shenzhen (CN)

(72) Inventors: Yan XU, Nanjing (CN); Wanhong MENG, Shenzhen (CN); Haiyan CHEN, Wuhan (CN); Kai DU, Beijing (CN); Jun HUANG, Beijing (CN)

(21) Appl. No.: 18/786,881

(22) Filed: Jul. 29, 2024

Related U.S. Application Data
(63) Continuation of application No. PCT/CN2023/071947, filed on Jan. 12, 2023.

(30) Foreign Application Priority Data
Jan. 30, 2022 (CN) 202210114823.1

(51) Int. Cl. H04L 49/901; H04L 5/00; H04L 69/06

(52) U.S. Cl. CPC H04L 49/901; H04L 5/0053; H04L 69/06

(57) ABSTRACT

The technology of this application relates to a packet processing method, a gateway device, and a storage system, and belongs to the field of storage technologies. In this disclosure, a request for accessing a non-volatile memory express (NVMe) node is converted into a request for accessing a remote direct memory access (RDMA) node. Because a storage medium of the NVMe node is a hard disk, and a storage medium of the RDMA node is a memory, the memory can provide a faster read/write speed than the hard disk. Therefore, storage performance is improved. In addition, this helps a conventional NVMe over fabrics (NOF) storage system expand an RDMA memory pool, and improves flexibility of networking and capacity expansion of the storage system.

### CROSS-REFERENCE TO RELATED APPLICATIONS

This application is a continuation of International Application No. PCT/CN2023/071947, filed on Jan. 12, 2023, which claims priority to Chinese Patent Application No. 202210114823.1, filed on Jan. 30, 2022. The disclosures of the aforementioned applications are hereby incorporated by reference in their entireties.

### TECHNICAL FIELD

This application relates to the field of storage technologies, and in particular, to a packet processing method, a gateway device, and a storage system.

### BACKGROUND

A non-volatile memory express (NVMe) is a bus transmission protocol specification based on a device logical interface. The NVMe provides software and hardware standards for a host to access a solid-state disk (SSD) through a peripheral component interconnect express (PCIe) bus. An instruction that complies with a format specified in the NVMe standard may be referred to as an NVMe instruction. An NVMe over fabrics (NOF) protocol is an NVMe-based protocol. The NOF supports transmission of an NVMe instruction according to various transport layer protocols, to expand an application scenario of the NVMe to a storage area network (SAN), and allow a host to access a storage device through a network.

Currently, a basic interaction procedure of an NOF protocol-based storage solution includes: A client sends a first NOF request packet, where the first NOF request packet carries an NVMe instruction. A server receives the first NOF request packet. The server parses the first NOF request packet to obtain the NVMe instruction carried in the first NOF request packet. The server performs an operation corresponding to the NVMe instruction on an NVMe storage medium in the server. The NVMe storage medium is generally a hard disk.

Performance of the hard disk is generally inferior to that of a memory such as a dynamic random access memory (DRAM), and an instruction set for a hard disk operation is more complex than an instruction set for a memory operation, resulting in low performance in the NOF protocol-based storage solution at present.

### SUMMARY

Embodiments of this application provide a packet processing method, a gateway device, and a storage system, to improve storage performance. Technical solutions are described as follows.

According to a first aspect, a packet processing method is provided. The method includes: A gateway device receives a first NOF request packet from a client, where the first NOF request packet carries an NVMe instruction, and the NVMe instruction instructs to perform a read/write operation on a first destination address. The gateway device obtains information about a first RDMA storage node based on the first destination address. The gateway device sends a first RDMA request packet to the first RDMA storage node, where the first RDMA request packet carries an RDMA instruction corresponding to the NVMe instruction.

The three types of network elements: the client, the gateway device, and the RDMA storage node are named based on device functions or device roles in the solution. The client is an entity that initiates the NOF request packet, or an NOF requester. The RDMA storage node is an entity that performs the read/write operation in response to the RDMA request packet, and is also referred to as an RDMA service end. The gateway device is equivalent to an ingress for accessing the RDMA storage node. The NOF request packet sent from the client needs to be transmitted to the RDMA storage node through the ingress. The gateway device includes but is not limited to a server, a server proxy, a router, a switch, a firewall, and the like.

The RDMA instruction corresponds to the NVMe instruction. For example, an operation type indicated by the RDMA instruction is the same as an operation type indicated by the NVMe instruction, and the operation type includes a read operation and a write operation. For example, the first NOF request packet carries an NVMe read instruction, and the first RDMA request packet carries an RDMA read instruction. The first NOF request packet carries an NVMe write instruction, and the first RDMA request packet carries an RDMA write instruction. For another example, to-be-processed data indicated by the RDMA instruction is the same as to-be-processed data indicated by the NVMe instruction. For still another example, to-be-read data indicated by the NVMe instruction is the same as to-be-read data indicated by the RDMA instruction, or to-be-stored data indicated by the NVMe instruction is the same as to-be-stored data indicated by the RDMA instruction.

The first destination address indicates a location of a storage space provided by an NVMe storage medium. Optionally, the first destination address is a logical address (or referred to as a virtual address). Optionally, the first destination address includes a start logical block address (start LBA) and a block number (or referred to as a number of logical block).

In a possible implementation, the information about the first RDMA storage node includes at least one of the following information: a second destination address, network location information of the first RDMA storage node, identifiers of one or more queue pairs (QP) in the first RDMA storage node, and a remote key (R_Key).

The second destination address points to a memory space of the first RDMA storage node. The memory space is a segment of space in a memory, and a location of the memory space in the memory is indicated by the second destination address. There are a plurality of implementations about a form of the second destination address. For example, the second destination address includes a start address and a length, a value of the start address is 0x1FFFF, and a value of the length is 32 KB. The second destination address points to a space that is in the memory of the first RDMA storage node and that starts from the address 0x1FFFF and has a length of 32 KB. For another example, the second destination address includes a start address and an end address, a value of the start address is 0x1FFFF, and a value of the end address is 0x2FFFF. The second destination address points to a space that is in the memory of the first RDMA storage node and that starts from the address 0x1FFFF to the address 0x2FFFF. When data is read, the second destination address points to a memory space that is in the memory of the first RDMA storage node and that stores to-be-read data. When data is written, the second destination address indicates a memory space, of to-be-written data, in the memory of the first RDMA storage node. Optionally, the second destination address is a logical address (or referred to as a virtual address). Optionally, the start address in the second destination address is specifically a virtual address (VA), and the length in the second destination address is specifically a direct memory access length (DMA length).

The network location information of the first RDMA storage node identifies the first RDMA storage node in a network. For example, the network location information is used to guide a network device between the gateway device and the first RDMA storage node to perform routing and forwarding. For example, the network location information of the first RDMA storage node includes at least one of a MAC address, an IP address, a multi-protocol label switching (MPLS) label, or a segment identifier (SID).

A QP includes a send queue (SQ) and a receive queue (RQ). The QP is used to manage various types of messages.

R_Key indicates permission to access the memory of the first RDMA storage node. R_Key is also referred to a memory key. In a possible implementation, R_Key indicates permission to access a specific memory space of the first RDMA storage node. For example, the specific memory space is a memory space storing to-be-read data, or a pre-registered memory space. In another possible implementation, in a scenario in which data is written to the first storage node and a second storage node, R_Key indicates permission to access the memory of the first RDMA storage node and permission to access a memory of the second RDMA storage node.

The DMA length indicates a length of an RDMA operation. For example, if a value of the DMA length is 16 KB, it indicates that an RDMA operation is performed on a memory space with a length of 16 KB. The RDMA operation includes a write operation and a read operation. The write operation is, for example, writing data to a memory. The read operation is, for example, reading data from a memory.

The gateway device performs the method in the first aspect, to convert a request for accessing an NVMe node into a request for accessing an RDMA node. Because a storage medium of the NVMe node is a hard disk, and a storage medium of the RDMA node is a memory, the memory can provide a faster read/write speed than the hard disk. Therefore, the method improves storage performance. Certainly, if the NVMe instruction indicates the read operation, the first RDMA storage node needs to store to-be-read data indicated by the NVMe instruction, to successfully access corresponding data according to the foregoing method. In addition, because an instruction set for a memory operation is simpler than an instruction set for a hard disk operation, the method reduces complexity of executing a read/write instruction by a storage node.

In addition, from a perspective of the client, the client may use a storage service provided by the RDMA storage node when initiating an access according to an original NOF procedure, and does not sense a change of the storage node or require the client to support an RDMA. Therefore, this solution is compatible with an original NOF storage solution, so that a service can be quickly provisioned.

Optionally, the first RDMA request packet further includes the information about the first RDMA storage node.

Optionally, that the gateway device obtains the information about the first RDMA storage node based on the first destination address includes: The gateway device obtains the information about the first RDMA storage node by querying a first correspondence based on the first destination address.

The first correspondence is a correspondence between the first destination address and the information about the first RDMA storage node. The first correspondence indicates the correspondence between the first destination address and the information about the first RDMA storage node.

There are a plurality of implementations about how the first correspondence indicates the correspondence between the first destination address and the information about the first RDMA storage node. Optionally, the first correspondence includes the first destination address and the information about the first RDMA storage node. For example, the first correspondence is equivalent to a table, an index of the table is the first destination address, and a value of the table is the information about the first RDMA storage node. Alternatively, the first correspondence does not include the information about the first RDMA storage node, but includes other information associated with the information about the first RDMA storage node, for example, metadata of the information about the first RDMA storage node, a file name of a file that stores the information about the first RDMA storage node, and a uniform resource locator (URL).

In the foregoing implementation, an addressing task of the storage node is offloaded (addressing is a process of searching for a destination storage node based on a destination NVMe address), to reduce CPU pressure and network I/O pressure of the NOF storage node.

Optionally, after the gateway device sends the first RDMA request packet to the first RDMA storage node, the method further includes: The gateway device receives an RDMA response packet from the first RDMA storage node, where the RDMA response packet is a response packet for the first RDMA request packet. The gateway device generates a first NOF response packet based on the RDMA response packet. The gateway device sends the first NOF response packet to the client.

The first NOF response packet is a response packet for the first NOF request packet. The first NOF response packet indicates making a response to the NVMe instruction in the first NOF request packet. When data is read, the first NOF response packet includes data that is requested to be obtained by the first NOF request packet. Optionally, the first NOF response packet further includes a completion queue element (CQE), and the CQE indicates that an NVMe read operation has been completed. When data is written, the first NOF response packet is an NOF write response packet. The first NOF response packet includes a CQE, and the CQE indicates that an NVMe write operation has been completed, or that the data has been successfully stored.

In the foregoing implementation, the gateway device implements an NOF protocol stack proxy, and replaces the RDMA storage node to return a response packet to the client. Because the response packet sensed by the client is still an NOF packet, the client does not need to sense protocol packet conversion logic. This reduces a difficulty in maintaining the client. In addition, the RDMA storage node does not need to support an NOF protocol. This reduces types of protocols that need to be supported by the RDMA storage node.

Optionally, that the gateway device generates the first NOF response packet based on the RDMA response packet includes: The gateway device obtains RDMA status information based on the RDMA response packet, where the RDMA status information indicates a correspondence between the RDMA response packet and the first RDMA request packet. The gateway device obtains NOF status information by querying a second correspondence based on the RDMA status information, where the NOF status information indicates a correspondence between the first NOF response packet and the first NOF request packet. The gateway device generates the first NOF response packet based on the NOF status information.

The second correspondence is a correspondence between the RDMA status information and the NOF status information. The second correspondence includes the correspondence between the RDMA status information and the NOF status information.

Optionally, the first NOF response packet includes NOF status information.

Optionally, the first NOF request packet includes NOF status information.

There are a plurality of cases about how the NOF status information indicates the correspondence between the first NOF response packet and the first NOF request packet. In a possible implementation, the NOF status information is a packet sequence number in the first NOF request packet. In another possible implementation, the NOF status information is a packet sequence number in the first NOF response packet. In another possible implementation, the NOF status information is a value obtained by converting a packet sequence number in the first NOF request packet according to a specified rule.

In this way, this helps the gateway device return an NOF packet carrying accurate status information to the client, thereby implementing continuity of a session performed between the client and the gateway device according to the NOF protocol, and improving a communication success rate. In addition, an original RDMA protocol does not need to be modified. Therefore, complexity is low.

Optionally, before the gateway device obtains the NOF status information by querying the second correspondence based on the RDMA status information, the method further includes: The gateway device obtains the NOF status information based on the first NOF request packet. The gateway device establishes the second correspondence, where the second correspondence is a correspondence between the NOF status information and the RDMA status information.

In this way, the gateway device associates an NOF status with an RDMA status in a process of interacting with the client and the RDMA node, to provide accurate status information for a process of returning the NOF packet.

Optionally, the first RDMA request packet includes the NOF status information, the RDMA response packet includes the NOF status information. That the gateway device generates the first NOF response packet based on the RDMA response packet includes: The gateway device obtains the NOF status information based on the RDMA response packet; and the gateway device generates the first NOF response packet based on the NOF status information.

In this way, the gateway device can obtain the NOF status information without locally maintaining an additional entry, thereby saving a storage space of the gateway device, and reducing resource overheads caused by table lookup and table writing of the gateway device.

Optionally, the first RDMA request packet includes a first NOF packet header, the RDMA response packet includes a second NOF packet header generated by the first RDMA storage node based on the first NOF packet header, and the first NOF response packet includes the second NOF packet header.

The first NOF packet header is a packet header of the NOF packet. For example, the first NOF packet header is a packet header of a first NOF packet corresponding to the RDMA request packet.

The NOF packet header includes NVMe layer information and a packet header corresponding to a fabric. “Fabric” is a network between a host and a storage medium. Typical fabric forms are, for example, an ethernet, a fiber channel, and an InfiniBand (IB). A specific format of the packet header corresponding to the fabric is related to an implementation of the fabric. The packet header corresponding to the fabric may include a packet header corresponding to a multi-layer protocol. For example, the fabric is implemented according to RoCEv2, and the packet header corresponding to the fabric includes a MAC header (corresponding to a link layer protocol), an IP header (corresponding to a network layer protocol), a UDP header (corresponding to a transport layer protocol), and an IB header (corresponding to a transport layer protocol). Alternatively, the packet header corresponding to the fabric is a packet header corresponding to a protocol. For example, the fabric is implemented according to the InfiniBand, and the packet header corresponding to the fabric is an IB header.

In the foregoing implementation, the gateway device can obtain the NOF status information without locally maintaining an additional entry, thereby saving a storage space of the gateway device, and reducing resource overheads caused by table lookup and table writing of the gateway device. In addition, work of generating the NOF packet header is transferred to the RDMA storage node to be performed, to reduce processing pressure of the gateway device.

Optionally, the RDMA status information includes a packet sequence number (PSN).

Optionally, the NOF status information includes at least one of a PSN, a submission queue head pointer (SQHD), a command identifier (command ID), a destination queue pair (DQP), a virtual address, R_Key, or a direct memory access length.

The PSN is used to support detection and retransmission of a lost packet.

The SQHD indicates a current head of a submission queue (SQ). The SQHD indicates, to the host, an entry that has been consumed in the SQ (namely, a read/write instruction that has been added to the SQ).

The command ID is an identifier of an error-related command.

R_Key is used to describe permission of a remote device to access a local memory, for example, permission of the client to access a memory of the RDMA storage node. R_Key is also referred to a memory key. R_Key is usually used together with a VA. Optionally, R_Key is further used to help hardware identify a page table that translates a virtual address into a physical address.

The DMA length indicates a length of an RDMA operation.

Optionally, the method further includes: The gateway device obtains information about a second RDMA storage node based on the first destination address. When the NVMe instruction indicates the write operation, the gateway device sends a second RDMA request packet to the second RDMA storage node, where the second RDMA request packet carries the RDMA instruction corresponding to the NVMe instruction.

Optionally, the second RDMA request packet further includes the information about the second RDMA storage node.

In this way, a same copy of data can be written to each RDMA storage node in a plurality of RDMA storage nodes, to implement a data backup function.

Optionally, both the first RDMA request packet and the second RDMA request packet are multicast packets; or both the first RDMA request packet and the second RDMA request packet are unicast packets.

Optionally, before the gateway device sends the first RDMA request packet to the first RDMA storage node, the gateway device further obtains the information about the second RDMA storage node based on the first destination address. When the NVMe instruction indicates the read operation, the gateway device selects the first RDMA storage node from the first RDMA storage node and the second RDMA storage node according to a load balancing algorithm.

In this way, a read request can be sent to one RDMA storage node in a plurality of candidate RDMA storage nodes, to support a load balancing feature, and allow the plurality of RDMA nodes to balance processing pressure caused by data reading.

Optionally, the method further includes: The gateway device receives the first correspondence from another device except for the gateway device; or the gateway device generates the first correspondence.

Optionally, that the gateway device generates the first correspondence includes: The gateway device allocates an NVMe logical address to the first RDMA storage node, to obtain the first destination address. The gateway device establishes a correspondence between the first destination address and the information about the first RDMA storage node, to generate the foregoing first correspondence.

In a process of generating the first correspondence, there are a plurality of implementations about how the gateway device obtains the information about the first RDMA storage node. In a possible implementation, the first RDMA storage node actively reports information about the node to the gateway device. For example, the first RDMA storage node generates and sends an RDMA registration packet to the gateway device. The gateway device receives the RDMA registration packet from the first RDMA storage node, and obtains the information about the first RDMA storage node from the RDMA registration packet. In another possible implementation, the gateway device pulls the information about the first RDMA storage node from the first RDMA storage node. For example, the gateway device generates a query request and sends the query request to the first RDMA storage node, where the query request indicates to obtain the information about the first RDMA storage node. The first RDMA storage node receives the query request, generates a query response, and sends the query response to the gateway device, where the query response includes the information about the first RDMA storage node. The gateway device receives the query response, and obtains the information about the first RDMA storage node from the query response.

Optionally, after the gateway device receives the first NOF request packet from the client, the gateway device further obtains the information about the NOF storage node based on the first destination address; the gateway device generates a second NOF request packet based on the first NOF request packet; and the gateway device sends the second NOF request packet to the NOF storage node.

Optionally, after the gateway device sends the second NOF request packet to the NOF storage node, the gateway device further receives a second NOF response packet from the NOF storage node; the gateway device generates a third NOF response packet based on the second NOF response packet; and the gateway device sends the third NOF response packet to the client.

In the foregoing implementation, an original NOF interaction procedure is supported, to maintain compatibility with the original NOF storage solution.

Optionally, the first RDMA storage node is a storage server, a memory, or a storage array.

Optionally, the memory is a dynamic random access memory (DRAM), a storage class memory (SCM), a dual in-line memory module, or a dual-line memory module (DIMM for short).

According to a second aspect, a gateway device is provided. The gateway device has a function of implementing any one of the first aspect or the optional implementations of the first aspect. The gateway device includes at least one unit, and each unit of the gateway device is configured to implement the method in any one of the first aspect or the optional implementations of the first aspect. In some embodiments, the unit in the gateway device is implemented by software, and the unit in the gateway device is a program module. In some other embodiments, the unit in the gateway device is implemented by hardware or firmware. For specific details of the gateway device provided in the second aspect, refer to any one of the first aspect or the optional implementations of the first aspect.

According to a third aspect, a gateway device is provided. The gateway device includes a processor and a network interface, the processor is coupled to a memory, the network interface is configured to receive or send a packet, the memory stores at least one computer program instruction, and the at least one computer program instruction is loaded and executed by the processor, so that the gateway device implements the method provided in any one of the first aspect or the optional implementations of the first aspect.

Optionally, the processor of the gateway device is a processing circuit. For example, the processor of the gateway device is a programmable logic circuit. For example, the processor is a programmable device such as a field-programmable gate array (FPGA) or a coprocessor.

Optionally, the memory of the gateway device is a storage medium. The storage medium of the gateway device includes but is not limited to a memory or a hard disk. For example, the memory is a DRAM, an SCM, or a DIMM. For example, the hard disk is a solid state disk (SSD) or a hard disk drive (HDD).

For specific details of the gateway device provided in the third aspect, refer to any one of the first aspect or the optional implementations of the first aspect. Details are not described herein again.

According to a fourth aspect, a gateway device is provided. The gateway device includes a main control board and an interface board, and may further include a switching board. The gateway device is configured to perform the method in any one of the first aspect or the possible implementations of the first aspect.

According to a fifth aspect, a computer-readable storage medium is provided. The storage medium stores at least one instruction. When the instruction is run on a computer, the computer is enabled to perform the method in any one of the first aspect or the optional implementations of the first aspect.

According to a sixth aspect, a computer program product is provided. The computer program product includes one or more computer program instructions. When the computer program instructions are loaded and run by a computer, the computer is enabled to perform the method in any one of the first aspect or the optional implementations of the first aspect.

According to a seventh aspect, a chip is provided. The chip includes a programmable logic circuit and/or program instructions. When running, the chip is configured to implement the method in any one of the first aspect or the optional implementations of the first aspect. For example, the chip is a network interface card.

According to an eighth aspect, a storage system is provided. The storage system includes the gateway device in the second aspect, the third aspect, or the fourth aspect and one or more RDMA storage nodes, and the one or more RDMA storage nodes include a first RDMA storage node.

The gateway device is configured to: receive a first NOF request packet from a client; obtain information about the first RDMA storage node based on a first destination address; and send a first RDMA request packet to the first RDMA storage node. The first RDMA storage node is configured to receive the first RDMA request packet from the gateway device, and perform a read/write operation on a second destination address according to an RDMA instruction.

In addition to supporting an original NOF procedure, the foregoing storage system further introduces supporting an RDMA storage node. This fully utilizes advantages of RDMA memory storage, and greatly improves overall system performance. In addition, the client is unaware of a change when using an NOF storage service, thereby ensuring availability.

In a possible implementation, the first RDMA storage node is configured to send the information about the first RDMA storage node to the gateway device; and the gateway device is configured to receive the information about the first RDMA storage node sent by the first RDMA storage node, and establish a first correspondence based on the information about the first RDMA storage node.

In a possible implementation, the first RDMA storage node is configured to generate an RDMA response packet based on the first RDMA request packet, and send the RDMA response packet to the gateway device.

The gateway device is configured to receive the RDMA response packet, generate a first NOF response packet based on the RDMA response packet, and send the first NOF response packet to the client.

In a possible implementation, the storage system further includes one or more NOF storage nodes. In this way, a hybrid networking mode of NOF hard disk storage and RDMA memory medium storage is supported. This improves networking flexibility and supports more service scenarios.

According to a ninth aspect, a packet processing method is provided. The method includes: A first RDMA storage node receives a first RDMA request packet from a gateway device, where the first RDMA request packet includes an RDMA instruction and a first NOF packet header, and the RDMA instruction instructs to perform a read/write operation on a second destination address. The first RDMA storage node performs a read/write operation on the second destination address according to the RDMA instruction. The first RDMA storage node sends an RDMA response packet to the gateway device, where the RDMA response packet is a response packet for the first RDMA request packet, the RDMA response packet includes a second NOF packet header, and the second NOF packet header corresponds to the first NOF packet header.

That the second NOF packet header corresponds to the first NOF packet header means that NOF status information carried in the second NOF packet header is the same as NOF status information carried in the first NOF packet header.

In the foregoing method, because the RDMA storage node undertakes some work of generating the NOF packet header, the NOF packet header is returned to the gateway device together with the RDMA response packet. This reduces processing pressure required by the gateway device to restore the NOF packet header. In addition, the gateway device does not need to buffer the NOF packet header in an NOF request packet. This saves an internal storage space of the gateway device.

Optionally, generating the second NOF packet header based on the first NOF packet header includes: padding missing content in the first NOF packet header to obtain the second NOF packet header.

Optionally, generating the second NOF packet header based on the first NOF packet header includes: modifying an invariable cyclic redundancy check (ICRC) in the first NOF packet header to obtain the second NOF packet header.

### BRIEF DESCRIPTION OF DRAWINGS

FIG. 1 is a schematic diagram of a structure of an NVMe SSD according to an example embodiment of this application;

FIG. 2 is a schematic flowchart of communication between a host and an NVMe controller according to an example embodiment of this application;

FIG. 3 is a schematic diagram of a queue pair mechanism according to an example embodiment of this application;

FIG. 4 is a schematic diagram of an architecture of an NOF storage system according to an example embodiment of this application;

FIG. 5 is a schematic diagram of a path for parsing an NOF protocol stack by a storage node according to an example embodiment of this application;

FIG. 6 is a schematic diagram of an architecture of an RDMA system according to an example embodiment of this application;

FIG. 7 is a schematic diagram of a queue pair mechanism according to an example embodiment of this application;

FIG. 8 is a schematic diagram of an application scenario according to an example embodiment of this application;

FIG. 9 is a flowchart of a packet processing method according to an example embodiment of this application;

FIG. 10 is a schematic diagram in which a gateway device processes a packet according to an example embodiment of this application;

FIG. 11 is a flowchart of a packet processing method according to an example embodiment of this application;

FIG. 12 is a schematic diagram of an architecture of a storage system after a gateway device is deployed according to an example embodiment of this application;

FIG. 13 is a schematic diagram of a scenario in which a gateway device serves as a storage node according to an example embodiment of this application;

FIG. 14 is a schematic diagram of a logical function architecture of a gateway device according to an example embodiment of this application;

FIG. 15 is a flowchart of a packet processing method according to an example embodiment of this application;

FIG. 16 is a schematic diagram of a logical function architecture of a gateway device according to an example embodiment of this application;

FIG. 17 is a schematic diagram of functions of an address translation table according to an example embodiment of this application;

FIG. 18 is a schematic diagram of an establishment process and a search process of an NOF context table according to an example embodiment of this application;

FIG. 19 is a flowchart of a packet processing method according to an example embodiment of this application;

FIG. 20 is a flowchart of a packet processing method according to an example embodiment of this application;

FIG. 21 is a schematic diagram of a logical function architecture of a gateway device according to an example embodiment of this application;

FIG. 22 is a flowchart of a packet processing method according to an example embodiment of this application;

FIG. 23 is a flowchart of a packet processing method according to an example embodiment of this application;

FIG. 24 is a schematic diagram of a logical function architecture of a gateway device according to an example embodiment of this application;

FIG. 25 is a flowchart of a packet processing method according to an example embodiment of this application;

FIG. 26 is a schematic diagram of a structure of a packet processing apparatus 700 according to an example embodiment of this application;

FIG. 27 is a schematic diagram of a structure of a gateway device 800 according to an example embodiment of this application; and

FIG. 28 is a schematic diagram of a structure of a gateway device 900 according to an example embodiment of this application.

### DESCRIPTION OF EMBODIMENTS

To make objectives, technical solutions, and advantages of this application clearer, the following further describes implementations of this application in detail with reference to accompanying drawings.

The character “/” in embodiments of this application generally indicates an “or” relationship between associated objects. For example, a read/write operation indicates a read operation or a write operation.

The following explains and describes some terms and concepts.

### (1) NVMe

The NVMe is a bus transmission protocol specification based on a device logical interface (which is equivalent to an application layer in a communications protocol), and is used to access a non-volatile memory medium (for example, a solid state drive using a flash memory) attached through a peripheral component interconnect express (PCIe) bus, although theoretically, a PCIe bus protocol is not necessarily required. The NVMe is a protocol and a set of software and hardware standards that allow a solid state disk (SSD) to use the PCIe bus. PCIe is an actual physical connection channel. An NVM represents an acronym of a non-volatile memory, which is a common flash memory form of the SSD. This specification mainly provides a native interface specification with low latency and internal concurrency for a storage device based on a flash memory, and supports native storage concurrency for a modern central processing unit (CPU), a computer platform, and a related application, so that host hardware and software can fully use a parallel storage capability of a solid-state storage device. Compared with an advanced host controller interface (AHCI) (a protocol affiliated with serial ATA (SATA)) in a previous hard disk drive (HDD) era, the NVMe reduces a waiting time of an input/output (I/O) operation, increases a number of operations at a same time, and provides an operation queue with a larger capacity.

### (2) NVMe Working Principle

In an NVMe specification, an interface between a host and an NVMe SSD (e.g., a typical storage medium in the NVMe) is based on a series of submission and completion queues in pairs. These queues are created by a driver and shared between the driver (which is run on the host) and the NVMe SSD. The queue may be located in a shared memory of the host, or may be located in a memory provided by the NVMe SSD. The submission queue and completion queue are used for communication between the driver and the NVMe SSD after being configured.

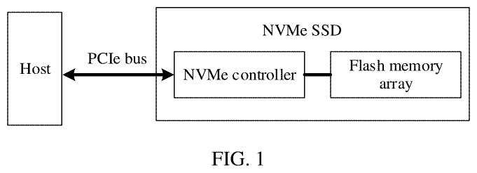

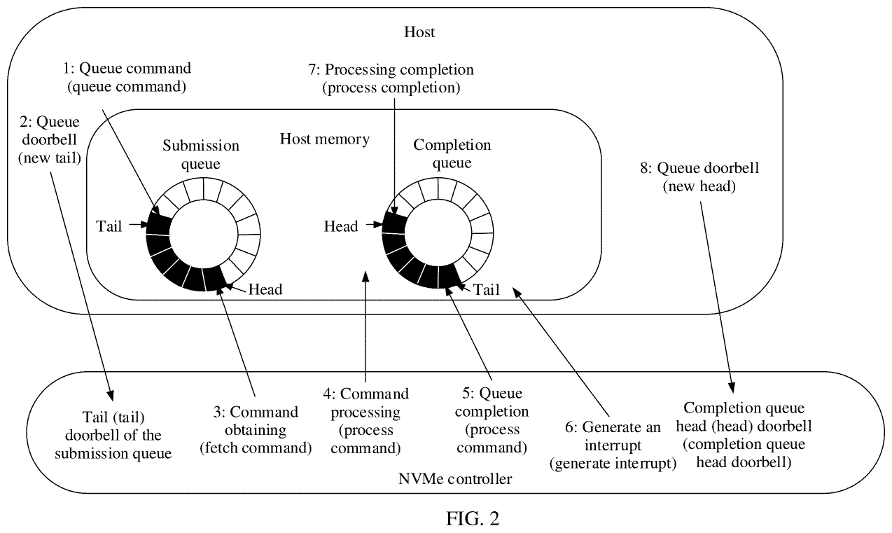

As shown in FIG. 1, an NVMe SSD includes an NVMe controller and a flash memory array. The NVMe controller is responsible for communicating with the host, and the flash memory array is responsible for storing data. FIG. 2 shows a procedure of communication between a host and an NVMe controller. Refer to FIG. 2. Step 1: the host places a new command in a submission queue. Step 2: A driver writes a new tail pointer to a doorbell register, to notify the NVMe controller that a new instruction is to be executed. Step 3: The NVMe controller obtains the instruction from the submission queue. Step 4: The NVMe controller processes the instruction. Step 5: After completing the command, the NVMe controller places an entry in an associated completion queue. Step 6: Generate an interrupt. Step 7: After completing processing the entry, the driver writes an updated head pointer of the completion queue to the doorbell register, and sends the head pointer to the NVMe controller.

Management operations (such as creating and deleting a queue on a device or updating firmware) and common I/O operations (such as reading and writing) have individual queues. This can ensure that the I/O operations are not affected by the long-term running management operations.

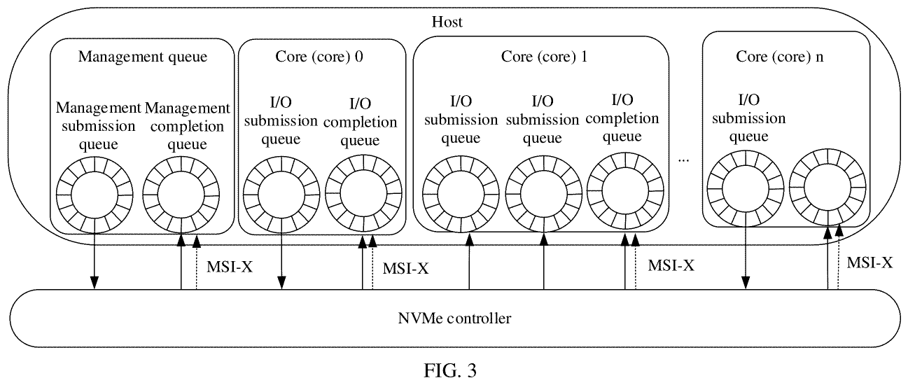

The NVMe specification allows a maximum of 64 K individual queues, and each queue can have a maximum of 64 K entries. In an actual application, a number of queues may be determined based on a system configuration and expected load. For example, for a system with a quad-core processor, a queue pair may be set for each core. This helps implement a lock-free mechanism. However, the NVMe also allows the driver to create a plurality of submission queues for each core and establish different priorities between these queues. Although the submission queue is usually served in a polling manner, the NVMe optionally supports a weighted round robin scheme. This scheme allows some queues to be served more frequently than other queues. FIG. 3 is a schematic diagram of a queue pair mechanism. As shown in FIG. 3, there is a one-to-one correspondence between a submission queue and a completion queue.

### (3) NVMe Instruction

The NVMe instruction is an instruction defined in an NVMe protocol. In the NVMe protocol, an instruction is classified into an administrator (administrator, Admin) instruction and an I/O instruction (the I/O instruction is also referred to as an NVM instruction). The Admin instruction is used to manage and control an NVMe storage medium. The I/O instruction is used to transmit data. Optionally, the NVMe instruction occupies 64 bytes in a packet. The I/O instruction in the NVMe protocol includes an NVMe read instruction and an NVMe write instruction.

### (4) NVMe Read Instruction

The NVMe read instruction is used to read data in an NVMe storage medium. For example, if content of an operation code field at an NVMe layer in an NOF packet is 02 h, it indicates that an NVMe instruction carried in the NOF packet is an NVMe read instruction.

### (5) NVMe Write Instruction

The NVMe write instruction is used to write data to an NVMe storage medium. For example, if content of an operation code field at an NVMe layer in an NOF packet is 01 h, it indicates that an NVMe instruction carried in the NOF packet is an NVMe write instruction.

### (6) NOF

The NOF is a high-speed storage protocol established based on an NVMe specification. The NOF is used for a cross-network access to an NVMe storage medium. The NOF protocol adds a fabric-related instruction based on an NVMe. Due to the NOF protocol, an NVMe application scenario is not limited to an interior of a device, and can be expanded to cross-network communication.

“Fabric” is a network between a host and a storage medium. Typical fabric forms are, for example, an ethernet, a fiber channel, and an InfiniBand (IB). Currently, some technologies attempt to implement a fabric through a remote direct memory access (RDMA), for example, implement a fabric through an RDMA over converged ethernet (RoCE). A manner of implementing a fabric through an RDMA is an NVMe over RDMA technology. For specific details, refer to descriptions of an NVMe over RDMA in the following (8).

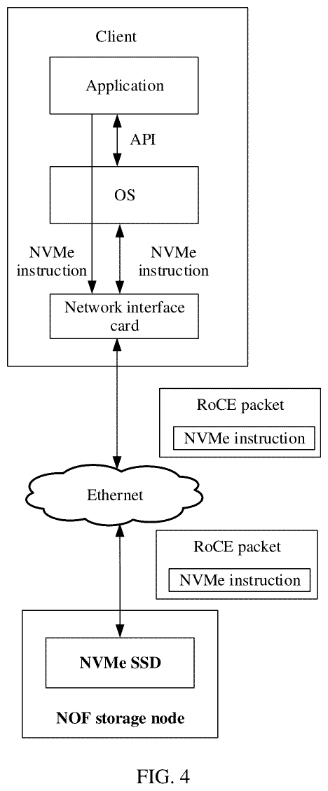

FIG. 4 is a schematic diagram of an architecture of an NOF storage system. In a scenario shown in FIG. 4, a fabric in an NOF technology is implemented according to RoCEv2. In other words, an NVMe is carried over RoCEv2. As shown in FIG. 4, after an upper-layer application sends an NVMe instruction, a network interface card encapsulates the NVMe instruction into an RoCE packet, and sends, through an ethernet, the RoCE packet to an NOF storage node in which an NVMe SSD is located. The architecture shown in FIG. 4 allows a host to access the NVMe SSD across the ethernet.

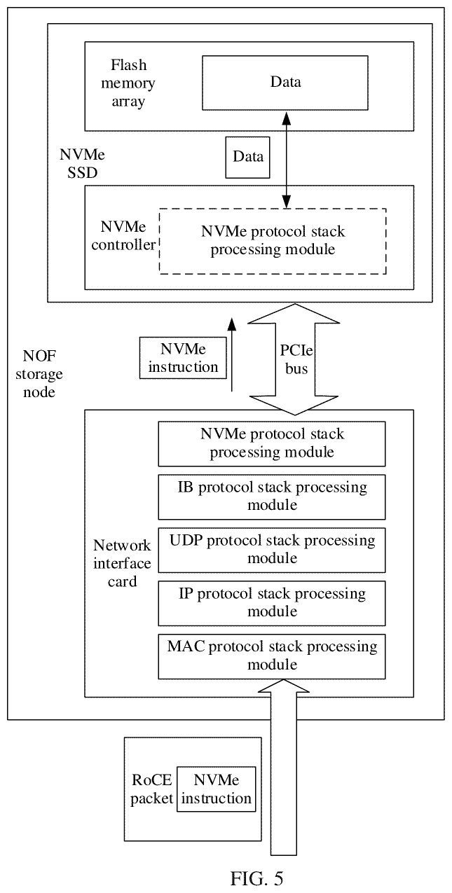

FIG. 5 shows a path for parsing an NOF protocol stack by an NOF storage node. In FIG. 5, an example in which an NOF packet is an RoCE packet is used for description. As shown in FIG. 5, processing modules corresponding to various protocol stacks are disposed in a network interface card of the NOF storage node. After the NOF storage node receives the RoCE packet, the network interface card of the NOF storage node sequentially performs, by using the processing modules, medium access control (MAC) layer protocol stack parsing, internet protocol (IP) protocol stack parsing, user datagram protocol (UDP) protocol stack parsing, IB protocol stack parsing, and NVMe protocol stack parsing on the RoCE packet, to obtain an NVMe instruction carried in the RoCE packet. The network interface card sends the NVMe instruction to an NVMe controller in an SSD through a PCIe bus, and the NVMe controller executes the NVMe instruction to perform a data read/write operation on a flash memory array.

In FIG. 5, an example in which the network interface card is responsible for parsing and processing various protocol stacks is used for description. A parsing and processing task of a protocol stack is optionally executed by a CPU of a storage node or another element.

The foregoing focuses on describing a procedure of processing the NOF packet or the NVMe instruction in the storage node. The following describes a procedure of interaction between devices according to an NOF protocol.

For example, a procedure of interaction between a client A and an NOF storage node B according to the NOF protocol includes step (1) to step (8) as follows. In the following procedure, the NOF is implemented according to the RoCEv2 protocol. In other words, the NOF is an NVMe over RoCEv2 protocol. A non-fragmentation scenario is used as an example for description in the following procedure. In a fragmentation scenario, a PSN in a packet may be updated by adding another value to the PSN instead of adding 1 to the PSN.

Step (1): The client A establishes a connection to the NOF storage node B.

A logical session is established between queue pairs (QP) at both ends, namely, the client A and the NOF storage node B. The client A initializes a packet sequence number (PSN) in a direction from A to B to obtain an initial PSN-AB. The NOF storage node B initializes a PSN in a direction from B to A to obtain PSN-BA. PSN-AB is a PSN in a direction from the client A to the NOF storage node B, and PSN-BA is a PSN in a direction from the NOF storage node B to the client A.

Step (2): The client A sends an RDMA send only (RDMA send only) packet to the NOF storage node B. The RDMA send only packet is a read request.

PSN-AB1 in the RDMA send only packet is a current PSN number in the direction from A to B. If no interaction has been performed after initialization, PSN-AB1 in the RDMA send only packet is initial PSN-AB. If interaction has been performed after initialization, PSN-AB1 in the RDMA send only packet is current PSN-AB1. In the RDMA send only packet, an NVMe layer includes a scatter table (SGL) that specifies a memory address of the client A, where a start logical block address (start LBA) and a block number (block number, or referred to as a number of Logical blocks) specify a destination storage address of the NOF storage node B, and a command identifier (command ID) specifies a sequence number of an NVMe operation.

Step (3): The NOF storage node B generates an RDMA acknowledgment (ACK) packet based on PSN-AB1 as the PSN. The NOF storage node B sends the RDMA ACK packet to the client A.

Step (4): The NOF storage node B generates an RDMA read response packet based on PSN-BA1 as the PSN, and the NOF storage node B sends the RDMA read response packet to the client A. Content of an RDMA extended transport header (RETH) in the RDMA read response packet is an SGL information at the NVMe layer. Content of a payload (payload) in the RDMA read response packet is a specific data value in an NVMe hard disk.

Step (5): The NOF storage node B generates an RDMA send only invalidate (RDMA send only invalidate) packet based on PSN-BA1+1 as the PSN. The NOF storage node B sends the RDMA send only invalidate packet to the client A. Content of an RETH in the RDMA send only invalidate packet is a remote key of the SGL at the NVMe layer. NVMe layer information includes a requested command ID. A submission queue head pointer (SQHD) indicates a head pointer location of a current operation in a submission queue.

Step (6): The client A sends the RDMA send only packet to the NOF storage node B. The RDMA send only packet is used to request to write data to a segment of memory space of the NOF storage node B. If the RDMA send only packet closely follows a previous read request, PSN-AB1 in the RDMA send only packet is the current PSN in the direction from A to B. Otherwise, PSN-AB1 in the RDMA send only packet is current PSN-AB1+1. NVMe layer information in an RDMA send only packet indicating a write operation is the same as NVMe layer information in an RDMA send only packet indicating a read operation. A payload part in the RDMA send only packet is a specific data value to be written to a memory.

Step (7): The NOF storage node B generates an RDMA ACK packet based on PSN-AB1+1 as a PSN. The NOF storage node B sends the RDMA ACK packet to the client A.

Step (8): The NOF storage node B generates an RDMA send packet based on PSN-BA1+2 as a PSN. The NOF storage node B sends the RDMA send packet to the client A. NVMe layer information in an RDMA send packet indicating a write operation is the same as NVMe layer information in an RDMA send packet indicating a read operation. An SQHD in the RDMA send packet indicating the write operation is SQHD+1 returned by the NOF storage node B when a read operation is performed last time.

### (7) RoCE

The RoCE is a network protocol that can carry an RDMA protocol and an NOF protocol. The RoCE allows an RDMA to be used on an ethernet. The RoCE has two versions: RoCEv1 and RoCEv2. RoCEv1 is an ethernet link layer protocol. Therefore, RoCEv1 supports data transmission between any two hosts in a same ethernet broadcast domain in an RDMA manner. RoCEv2 is a network layer protocol. An RoCEv2 packet includes a UDP header and an IP header. Therefore, the RoCEv2 packet can be forwarded by an IP route, to support data transmission between any two hosts on an IP network in an RDMA manner. In some optional embodiments of this application, a gateway device separately interacts with the client and the storage node according to an RoCE protocol.

### (8) NVMe Over RDMA (NOR)

The NVMe over RDMA is a technology of transmitting an NVMe instruction or an execution result of the NVMe instruction by using an RDMA. From a perspective of a protocol stack, an NVMe in the NVMe over RDMA is carried at an upper layer of the RDMA. In an NVMe over RDMA solution, the RDMA functions as a carrier of an NVMe protocol or a transmission channel of the NVMe protocol. For example, a function of the RDMA in the NVMe over RDMA is similar to that of a PCIe bus in a computer. The PCIe bus is used to transmit data between a CPU and a local hard disk. The RDMA in the NVMe over RDMA is used to transmit an NVMe instruction between a host and a remote hard disk across a network.

Some embodiments of this application are quite different from a technical concept of the NVMe over RDMA solution. In some embodiments of this application, an instruction in the RDMA is used to perform a read/write operation on a memory, to improve storage performance by using a performance advantage such as a faster data read/write speed of the memory, and reduce complexity of an instruction set that needs to be processed by a storage node. In the NVMe over RDMA solution, the RDMA is used as the transmission channel of the NVMe, to reduce a latency of transmitting the NVMe instruction across the network. From a perspective of packet content, in some embodiments of this application, content of a packet sent by a gateway device to a storage node is an RDMA instruction, and semantics of the instruction is how to operate a memory. However, in the NVMe over RDMA solution, content of a packet sent to a storage node is an NVMe instruction, and semantics of the instruction is how to operate a hard disk. From a perspective of a storage medium, in some embodiments of this application, a storage medium such as a memory can be used to provide a data read/write service for a client. However, in the NVMe over RDMA solution, a storage medium such as a hard disk is used to provide a data read/write service for a client.

### (9) RDMA

The RDMA is a technology for accessing a memory of a remote device by bypassing an operating system kernel of the remote device. An operating system is usually bypassed in the RDMA technology. This not only saves a large number of CPU resources, but also increases a throughput, and reduces a network communication latency. The RDMA is especially suitable for application in a massively parallel computer cluster.

An RDMA storage node is a storage node that provides a service of reading or writing data in an RDMA manner. There are a plurality of product forms of the RDMA storage node. For example, the RDMA storage node is a storage server, a desktop computer, or the like.

The RDMA has the following characteristics: (1) Data is transmitted between a local device and a remote device through a network. (2) In most cases, a data transmission task is offloaded to an intelligent network interface card without participation of an operating system kernel. (3) When data is transmitted between a user space virtual memory and the intelligent network interface card, the operating system kernel is not involved, and no extra data is moved or copied.

Currently, there are three types of RDMA networks: an InfiniBand, an RoCE, and an internet wide area RDMA protocol (iWARP). The Infiniband is a network designed specially for the RDMA, to ensure reliable transmission in terms of hardware. Both the RoCE and the iWARP are ethernet-based RDMA technologies.

### (10) One-Sided RDMA Operation

The one-sided RDMA operation allows a CPU at a single side, namely, a local device to operate, but does not allow a CPU of a remote device to operate. In other words, in a process of performing the one-sided RDMA operation, the CPU of the remote device is bypassed (CPU bypass). The one-sided RDMA operation is usually used to transmit data. Generally, an RDMA operation is the one-sided RDMA operation. In a process of performing an RDMA read operation or an RDMA write operation, generally, only a local end needs to specify a source address and a destination address, and a remote application does not need to sense this communication. Data reading or writing is completed by a remote network interface card, and then the remote network interface card encapsulates data into a message and returns the message to the local end. The one-sided RDMA operation includes an RDMA read operation and an RDMA write operation.

### (11) RDMA Write Operation

The RDMA write operation is an operation of writing data to a memory of a service end (namely, an RDMA storage node). A basic principle of performing the RDMA write operation is as follows: A client pushes data from a local cache to the memory of the service end based on an address of the memory of the service end and an access permission to the memory of the service end. In an RDMA protocol, the access permission of the client to the memory of the service end is referred to as a remote key (R_Key).

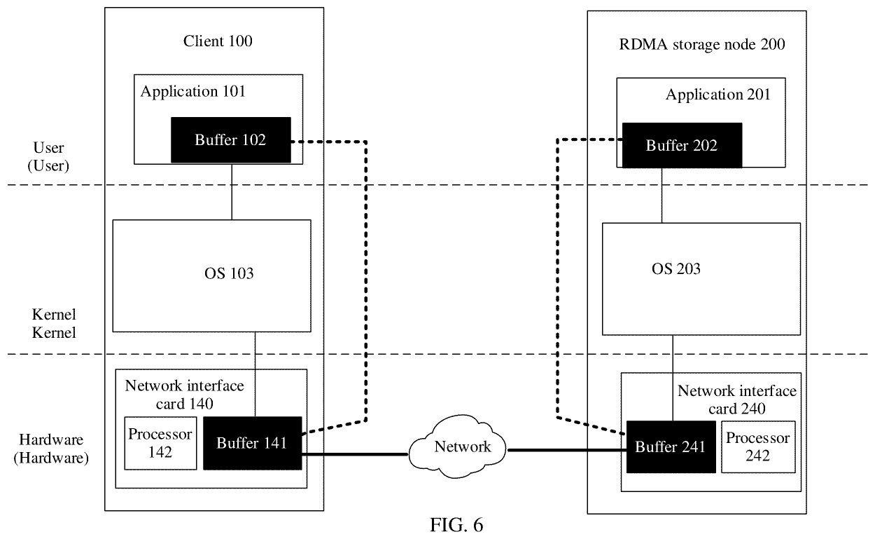

For example, in an RDMA architecture shown in FIG. 6, a basic working procedure of performing the RDMA write operation is as follows: (1) After an application 101 in a client 100 generates an RDMA write request packet, the application 101 places the RDMA write request packet in a buffer 102. A processor 142 of a local network interface card 140 reads the request packet to a buffer 141 of the network interface card 140, and an operating system 103 is bypassed in this process. The RDMA write request packet includes a logical address of a memory space of an RDMA storage node 200, a remote key, and to-be-stored data of the application 101. The remote key indicates that the network interface card 140 has an access permission to a memory of the RDMA storage node 200. (2) The processor 142 of the network interface card 140 sends the RDMA write request packet to a network interface card 240 through a network. (3) A processor 242 of the network interface card 240 checks the remote key in the RDMA write request packet. If it is determined that the remote key is correct, the processor 242 writes data carried in the RDMA write request packet from a buffer 241 of the network interface card 240 to a buffer 202, to store the data in the memory of the RDMA storage node 200.

### (12) RDMA Read Operation

The RDMA read operation is an operation of reading data in a memory of a service end (namely, an RDMA storage node). A basic principle of performing the RDMA read operation is as follows: A network interface card of a client obtains data from a memory of the service end based on an address of the memory of the service end and an access permission (remote key) of the memory of the service end, and pulls the data to a local cache of the client.

### (13) Two-Sided RDMA Operation

The two-sided RDMA operation includes an RDMA send operation and an RDMA receive operation. The two-sided RDMA operation allows a CPU to be bypassed in a data transmission process, but requires CPUs at both sides, namely, a local device and a remote device to operate. In other words, in a process of performing the two-sided RDMA operation, the CPUs at the both sides, namely, the local device and the remote device are completely bypassed. The two-sided RDMA operation is usually used to transmit a control packet. Specifically, if the local device wants to transmit data to a memory of the remote device by performing the RDMA send operation, the remote device needs to first invoke the RDMA receive operation. If the remote device does not invoke the RDMA receive operation, the remote device fails to locally invoke the RDMA send operation. An operating mode of the two-sided operation is similar to conventional socket programming. Overall performance of the two-sided operation is slightly lower than that of a one-sided RDMA operation. The RDMA-send operation and the RDMA-receive operation are usually used to transmit a connection control packet.

### (14) RDMA Connection

In an RDMA, a logical connection is established between applications of two communication parties to perform communication. The logical connection is referred to as an RDMA connection below. The RDMA connection is equivalent to a channel for transmitting a message, and head and tail endpoints of each RDMA connection are two queue pairs.

### (15) Queue Pair (QP)

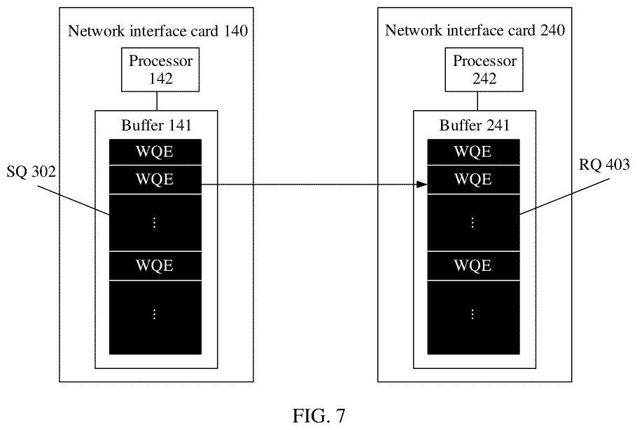

A QP includes a send queue (SQ) and a receive queue (RQ). Various types of messages are managed in these queues. As shown in FIG. 7, the network interface card 140 includes an SQ 302, and the network interface card 140 includes an RQ 403. The SQ 302 and the RQ 403 form a QP, and the SQ 302 and the RQ 403 are equivalent to two endpoints of an RDMA connection. The QP is mapped to a virtual address space of an application, so that the application can directly access the virtual address through the network interface card. In addition to two basic queues described in the QP, an RDMA further provides a completion queue (CQ), and the CQ is used to notify the application that a message on a WQ is processed.

The following describes, by using an example, a procedure of interaction between devices according to an RDMA protocol.

For example, a complete procedure of interaction between a client A and an RDMA storage node B includes step (1) to step (6) as follows. The RDMA protocol on which the following procedure is based is specifically an RoCEv2 protocol.

A non-fragmentation scenario is used as an example for description in the following procedure. In a fragmentation scenario, a PSN in a packet may be updated by adding another value to the PSN instead of adding 1 to the PSN.

Step (1): The client A establishes a connection to the RDMA storage node B.

A logical session is established between QPs at both ends, namely, the client A and the RDMA storage node B. The client A initializes a PSN in a direction from A to B to obtain initial PSN-AB. The RDMA storage node B initializes a PSN in a direction from B to A to obtain PSN-BA. PSN-AB is a PSN in the direction from the client A to the RDMA storage node B, and PSN-BA is a PSN in the direction from the RDMA storage node B to the client A.

Step (2): The RDMA storage node B sends an RDMA send only packet to the client A.

The RDMA send only packet is used to report an address of a memory space of the RDMA storage node B. PSN-BA1 carried in the RDMA send only packet is a current PSN number in the B-A direction. If no interaction has been performed after initialization, PSN-BA1 carried in the RDMA send only packet is initial PSN-BA. If interaction has been performed after initialization, PSN-BA1 carried in the RDMA send only packet is current PSN-BA1. An address of a memory space is carried in an RETH in a packet. The address of the memory space includes a VA, a remote key, and a direct memory access (DMA) length.

Step (3): The client A sends an RDMA read request packet to the RDMA storage node B. The RDMA read request packet is used to request to obtain the address of the memory space of the RDMA storage node B. PSN-AB1 in the RDMA read request packet is a current PSN number in the A-B direction. If no interaction has been performed after initialization, PSN-AB1 in the RDMA read request packet is initial PSN-AB. If interaction has been performed after initialization, PSN-AB1 in the RDMA read request packet is current PSN-AB1. An address of a memory space in the RDMA read request packet is the address of the memory space previously reported by the RDMA storage node B to the client A.

Step (4): The RDMA storage node B generates an RDMA read response packet based on PSN-AB1 as the PSN, and sends the RDMA read response packet to the client A. A payload part in the RDMA read response packet is a specific data value that is read from a memory and that is stored in the memory.

Step (5): The client A sends an RDMA write only packet to the RDMA storage node B. The RDMA write only packet is used to write data to a memory of the RDMA storage node B. If the RDMA write only packet closely follows the previous RDMA read request packet, PSN-AB1 in the RDMA write only packet is a current PSN number in the A-B direction. Otherwise, PSN-AB1 in the RDMA write only packet is current PSN-BA1+1. An address of a memory space in the RDMA write only packet is an address of a segment of memory space previously reported in the B-A direction. A payload part in the RDMA write only packet is a specific data value to be written to the memory.

Step (6): The RDMA storage node B generates an RDMA ACK packet based on PSN-AB1+1 as the PSN, and sends the RDMA ACK packet to the client A.

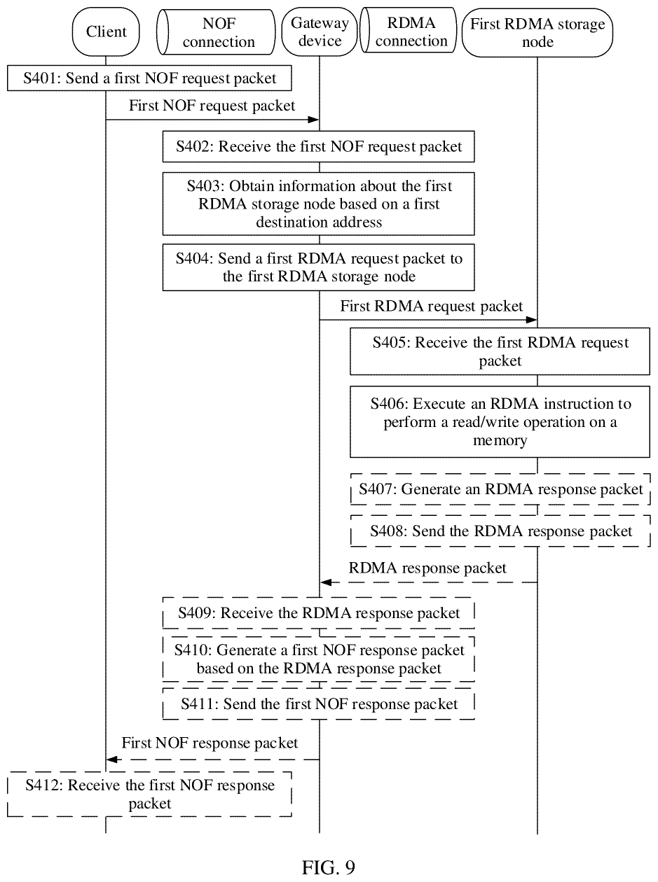

In some embodiments, for technical details about how a gateway device interacts with the RDMA storage node and an example of RDMA status information, refer to the foregoing procedure. For example, with reference to an embodiment corresponding to FIG. 9, the gateway device in the embodiment corresponding to FIG. 9 is optionally equivalent to the client A described above, or a proxy of the client A, and a first RDMA storage node in the embodiment corresponding to FIG. 9 is optionally the RDMA storage node B described above. When data is read, a first RDMA request packet in S404 in the embodiment corresponding to FIG. 9 is optionally the RDMA read request packet in step (3), an RDMA response packet in S408 in the embodiment corresponding to FIG. 9 is optionally the RDMA read response packet in step (4), and the RDMA status information in the RDMA response packet is optionally PSN-AB1 in step (4). For another example, when data is written, a first RDMA request packet in S404 in the embodiment corresponding to FIG. 9 is optionally the RDMA write only packet in step (5), an RDMA response packet in S408 in the embodiment corresponding to FIG. 9 is optionally the RDMA ACK packet in step (6), and the RDMA status information in the RDMA response packet is optionally PSN-AB1+1 in step (6). In addition, step (1) and step (2) in the foregoing procedure are optionally provided as preparatory steps in the embodiment corresponding to FIG. 9, and provide a sufficient implementation basis for the embodiment in FIG. 9. For example, the gateway device is supported in pre-establishing an RDMA connection to a client device in step (1), and an address (a second destination address) of a memory space of the first RDMA storage node is pre-sent to the gateway device in step (2).

### (16) Status Information

The so-called “status information” is a term in the field of computer network communication. The status information indicates a relationship between different packets that are successively exchanged between two communication parties in a session. Generally, each packet exchanged between two communication parties in a session is not an isolated entity, but is related to a previously exchanged packet. For example, each packet in a session carries specific information, and a value of the information remains unchanged in a session process, or a value of the information changes according to a set rule in a session process. The information that remains unchanged in the session or the information whose value changes according to the set rule is status information. A packet usually carries status information for reliability or security. For example, a receive end determines whether a packet loss occurs based on the status information in the packet, and performs retransmission when the packet loss occurs; or a receive end determines whether a sender is trusted based on whether the status information in the packet is correct, and discards the packet when the sender is untrusted. For example, in a TCP protocol, a sequence number (sequence number) carried in a TCP packet is a type of status information.

### (17) RDMA Status Information

The RDMA status information indicates a relationship between different RDMA packets in a session performed according to an RDMA protocol, and a logical sequence of the RDMA packets. For example, after two communication parties establish a connection according to the RDMA protocol, a responder sequentially sends a plurality of RDMA response packets to a requester, the plurality of RDMA response packets respectively include different RDMA status information, and the RDMA status information indicates a sequence of the plurality of RDMA response packets.

Optionally, the RDMA status information specifically indicates a correspondence between the RDMA response packet and an RDMA request packet. For example, the two communication parties exchange a plurality of RDMA request packets and a plurality of RDMA response packets in a session performed according to the RDMA protocol. Each RDMA request packet or RDMA response packet includes RDMA status information. RDMA status information in an RDMA response packet indicates an RDMA request packet corresponding to the RDMA response packet.

Optionally, the RDMA status information is a PSN.

The RDMA status information is information carried in an RDMA packet. For example, the RDMA status information is information carried in an RDMA packet header in the RDMA packet. For example, the RDMA status information is information carried in an IB header or an iWARP packet header.

### (18) NOF Status Information

The NOF status information indicates a relationship between different NOF packets in a session performed according to an NOF protocol, and a logical sequence of the NOF packets. Optionally, the NOF status information specifically indicates a correspondence between the NOF response packet and an NOF request packet. For example, the two communication parties exchange a plurality of NOF request packets and a plurality of NOF response packets in a session performed according to the NOF protocol. Each NOF request packet or NOF response packet includes NOF status information. NOF status information in an NOF response packet indicates an NOF request packet corresponding to the NOF response packet.

Optionally, the NOF status information includes at least one of the following information: a PSN, an SQHD, a command ID, a DQP, a virtual address, a remote key (remote key), or a direct memory access length.

The NOF status information is information carried in an NOF packet. For example, the NOF status information is information carried in an NOF packet header in the NOF packet.

### (19) NOF Packet Header

The NOF packet header is a packet header of an NOF packet. The NOF packet header includes NVMe layer information and a packet header corresponding to a fabric. A specific format of the packet header corresponding to the fabric is related to an implementation of the fabric. The packet header corresponding to the fabric may include a packet header corresponding to a multi-layer protocol. For example, the fabric is implemented according to RoCEv2, and the packet header corresponding to the fabric includes a MAC header (corresponding to a link layer protocol), an IP header (corresponding to a network layer protocol), a UDP header (corresponding to a transport layer protocol), and an IB header (corresponding to a transport layer protocol). Alternatively, the packet header corresponding to the fabric is a packet header corresponding to a protocol. For example, the fabric is implemented according to the InfiniBand, and the packet header corresponding to the fabric is an IB header.

### (20) RETH

The RETH is a transport layer packet header in an RDMA protocol. The RETH includes some additional fields for an RDMA operation. Optionally, the RETH includes a virtual address (VA) field, a remote key (R_Key) field, and a direct memory access length (DMA length) field. A format of the RETH is optionally shown in Table 1 below.

TABLE 1

| | | | | |
|---|---|---|---|---|
| Bit | | | | |
| Byte | 31 to 24 | 23 to 16 | 15 to 8 | 7 to 0 |

| | |
|---|---|
| 0 to 3 | VA (63 to 32) |
| 4 to 7 | VA (31 to 0) |
| 8 to 11 | Remote key |
| 12 to 15 | DMA length |

### (21) Packet Sequence Number (PSN)

The PSN is a value carried in a packet transport header. The PSN is used to support detection and retransmission of a lost packet.

### (22) Send Queue Head Pointer (SQHD)

The SQHD indicates a current head of a subimission queue (SQ). The SQHD indicates, to a host, an entry that has been consumed in the SQ (namely, a read/write instruction that has been added to the SQ).

### (23) Command ID

The command ID is an identifier of an error-related command. If an error is not related to a specified command, a command ID field is optionally set to FFFFh.

### (24) Virtual Address (VA)

The VA indicates a start address of a buffer. A length of the VA is, for example, 64 bits.

### (25) Remote Key (R_Key)

R_Key is used to describe permission of a remote device to access a local memory, for example, permission of a client to access a memory of an RDMA storage node. R_Key is also referred to a memory key. R_Key is usually used together with a VA. Optionally, R_Key is further used to help hardware identify a page table that translates a virtual address into a physical address.

### (26) Direct Memory Access Length (DMA Length)

The DMA length indicates a length of an RDMA operation. The DMA length is a field name in an RDMA-related standard. The DMA length may also be referred to as an RDMA length.

### (27) Host

The host is a main body part in a computer. The host generally includes a CPU, a memory, and an interface. A connection relationship between the host and an SSD may be implemented in a plurality of manners. Optionally, the SSD is disposed inside the host, and the SSD is a component inside the host. Alternatively, the SSD is disposed outside the host and is connected to the host.

### (28) Storage Node

The storage node is an entity that supports a data storage function. In a possible implementation, one storage node is an independent storage device. In another possible implementation, one storage node is a device integrating a plurality of storage devices, or is a distributed system or a cluster including a plurality of storage devices. For example, for an RDMA storage node, in a possible implementation, one RDMA storage node is a storage server that supports an RDMA, and the storage server provides an RDMA-based data read/write service by using a local memory. In another possible implementation, one RDMA storage node includes a plurality of storage servers that support an RDMA, and memories in the storage servers form a memory pool that supports the RDMA. The storage node provides an RDMA-based data read/write service by using a memory, included in one or more storage servers, in the memory pool.

### (29) Memory

The memory is an internal memory that directly exchanges data with a processor. The memory usually can read and write data at any time, is fast, and serves as a temporary data memory for an operating system or another running program. The memory is, for example, a random access memory, or a read-only memory (ROM). For example, the random access memory is a dynamic random access memory (DRAM) or a storage class memory (SCM).

The DRAM is a semiconductor memory, and is a volatile memory device like most random access memories (RAMs).

The SCM uses a composite storage technology that combines features of both a conventional storage apparatus and a memory. The storage class memory can provide a higher read/write speed than a hard disk, but has a lower access speed than the DRAM, and has lower costs than the DRAM.

The DRAM and the SCM are merely examples for description in embodiments. The memory optionally includes another random access memory, for example, a static random access memory (SRAM). The read-only memory is, for example, a programmable read-only memory (PROM) or an erasable programmable read only memory (EPROM).

In some other embodiments, the memory is a dual in-line memory module or a dual-line memory module (DIMM), namely, a module including a dynamic random access memory (DRAM), or an SSD.

Optionally, the memory is configured to have a power failure protection function. The power failure protection function means that data stored in the memory is not lost even when a system is powered on again after a power failure. A memory with a power failure protection function is referred to as a non-volatile memory.

### (30) Logical Block (LB)

The LB is also referred to as a block. The LB is a smallest storage unit defined in an NVMe. For example, an LB is a storage space whose size is 2 KB or 4 KB.

### (31) Logical Unit Number (LUN)

In a SAN, the LUN is a number for identifying a logical unit, and the logic unit is a device addressed through a SCSI. In other words, a storage system partitions a physical hard disk into parts with logical addresses and allows a host to access the logical addresses. Such a partition is referred to as a LUN. Generally, the LUN is a logical disk created on a SAN storage device.

Some embodiments of this application relate to a procedure of mutual conversion between NOF and RDMA protocol packets. For brevity, in some embodiments of this application, an “NOF-RDMA” form briefly represents a process of converting an NOF packet into an RDMA packet, and an “RDMA-NOF” form briefly represents a process of converting the RDMA packet into the NOF packet.

The following describes an application scenario of embodiments of this application by using an example.

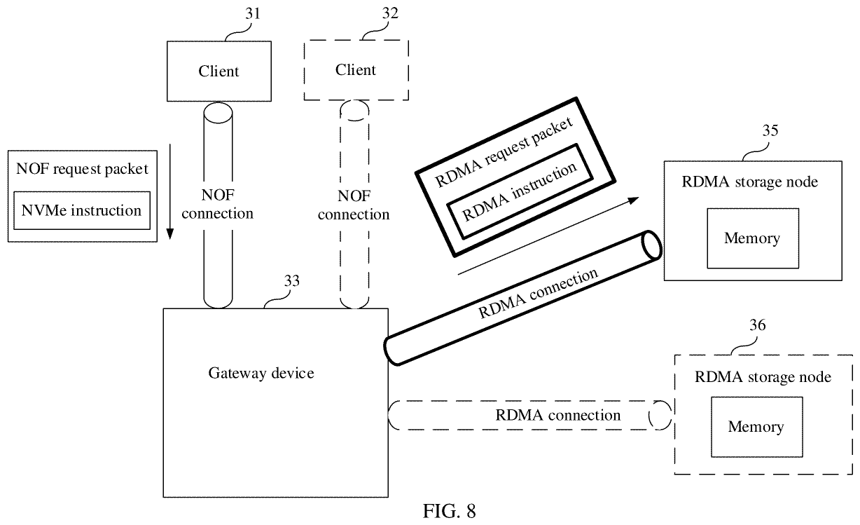

FIG. 8 is a schematic diagram of an application scenario according to an embodiment of this application. The scenario shown in FIG. 8 includes a client 31, a gateway device 33, and an RDMA storage node 35. The following describes each device in FIG. 8 by using an example.

### (1) Client 31

There are a plurality of cases about a deployment location of the client 31. For example, the client 31 is deployed in a user network, or is deployed in a local area network. For example, the client 31 is deployed in an enterprise intranet. For another example, the client 31 is deployed in an internet, is deployed on cloud, or is deployed in a cloud network such as public cloud, industry cloud, or private cloud. For another example, the client 31 is deployed in a backbone network (for example, the client is a router having a data storage requirement), and a deployment location of the client is not limited in embodiments.

The client 31 has a plurality of possible product forms. For example, the client 31 may be a terminal, a server, a router, a switch, or the like. The terminal includes but is not limited to a personal computer, a mobile phone, a server, a notebook computer, an IP phone, a camera, a tablet computer, a wearable device, and the like.

The client 31 plays a role of an NOF request packet initiator. A data reading procedure is used as an example. When the client 31 needs to obtain pre-stored data, the client 31 generates and sends an NOF read request packet, to trigger the following method embodiment shown in FIG. 9. A data writing procedure is used as an example. When the client 31 needs to store data, the client 31 generates and sends an NOF write request packet, to trigger the following method embodiment shown in FIG. 9.

The client 31 further plays a role of an NOF response packet destination. The data reading procedure is used as an example. After the client 31 receives an NOF read response packet, the client 31 obtains read data from the NOF read response packet, and performs service processing based on the data. The data writing procedure is used as an example. After the client 31 receives an NOF write response packet, the client 31 obtains NOF response information from the NOF write response packet, and confirms, based on the NOF response information, that data is successfully stored.

### (2) Gateway Device 33

The gateway device 33 is an entity deployed between the client 31 and the RDMA storage node 35. The gateway device 33 is configured to forward a packet exchanged between the client 31 and the RDMA storage node 35.

In some embodiments, the gateway device 33 serves as both an NOF proxy (proxy) and an RDMA proxy. From a perspective of the client 31, the gateway device 33 is equivalent to an NOF server, and the gateway device 33 replaces the NOF server to interact with the client 31. As shown in FIG. 8, the gateway device 33 establishes an NOF connection to the client 31 according to an NOF protocol, and the gateway device 33 can receive, through the NOF connection, an NOF request packet sent by the client 31. From a perspective of the RDMA storage node 35, the gateway device 33 is equivalent to an RDMA client, and the gateway device 33 replaces the client to interact with the RDMA storage node 35. As shown in FIG. 8, the gateway device 33 establishes an RDMA connection to the RDMA storage node 35 according to an RDMA protocol, and the gateway device 33 can send an RDMA request packet to the RDMA storage node 35 through the RDMA connection. For details about how the gateway device 33 implements a proxy function, refer to the following method embodiments.

The gateway device 33 has a plurality of possible product forms. In some embodiments, the gateway device 33 is a network device. For example, the gateway device 33 is a router, a switch, a firewall, or the like. In some other embodiments, the gateway device 33 is a server. For example, the gateway device 33 is a storage server. In some other embodiments, the gateway device 33 is implemented by using a programmable component such as a field-programmable gate array (FPGA) or a coprocessor. For example, the gateway device 33 is a dedicated chip. In some other embodiments, the gateway device 33 is a general-purpose computer device, and the computer device runs a program in a memory by using a processor, to implement a function of the gateway device 33.

Optionally, the gateway device 33 provides packet forwarding and proxy services for a plurality of clients. As shown in FIG. 8, the network further includes a client 32. After the client 32 initiates the NOF request packet, the gateway device processes, in a similar manner, the NOF request packet sent by the client 32.

A scenario in which one gateway device is deployed shown in FIG. 8 is merely an example, and there are optionally more or fewer gateway devices deployed in a system. For example, there is only one gateway device, or there are dozens or hundreds of gateway devices, or more gateway devices. A number of gateway devices deployed in the system is not limited in embodiments. When a plurality of gateway devices are deployed, in a possible implementation, a load balancer is deployed before the gateway devices, and the load balancer is configured to distribute request packets from the clients to the gateway devices, so that the gateway devices operate in a load balancing manner, thereby balancing processing pressure of individual gateway devices.

### (3) RDMA Storage Node 35

The RDMA storage node 35 is configured to provide a service of reading or writing data in an RDMA manner. The RDMA storage node 35 is also referred to as an RDMA service end. The RDMA storage node 35 has a memory. In a possible implementation, a network interface of the RDMA storage node 35 is connected to a network interface of the gateway device 33. In a possible implementation, the RDMA storage node 35 stores data of the client 31.

Optionally, a plurality of RDMA storage nodes are deployed in the system. As shown in FIG. 8, optionally, an RDMA storage node 36 is further deployed in the system, and the RDMA storage node 36 has a feature similar to that of the RDMA storage node 35.

The following describes method procedures in embodiments of this application by using examples.

FIG. 9 is a flowchart of a packet processing method according to an embodiment of this application.

The method shown in FIG. 9 relates to a case in which a storage system includes a plurality of RDMA storage nodes. To distinguish different RDMA storage nodes, a “first RDMA storage node” and a “second RDMA storage node” are used to distinguish and describe the different RDMA storage nodes.

Optionally, with reference to FIG. 1, a client in the embodiment shown in FIG. 9 is the host in FIG. 1.

Optionally, with reference to FIG. 2, a client in the embodiment shown in FIG. 9 is the host in FIG. 2.

Optionally, with reference to FIG. 3, a client in the embodiment shown in FIG. 9 is the host in FIG. 3.

Optionally, with reference to FIG. 6, a gateway device in the embodiment shown in FIG. 9 serves as an RDMA protocol stack proxy of the client 100 in FIG. 6, and the gateway device replaces the client 100 to interact with the RDMA storage node 200 in FIG. 6. The gateway device includes the network interface card 140 in FIG. 6, and the network interface card 140 is used to perform steps for which the gateway device is responsible in the embodiment shown in FIG. 9.

Optionally, with reference to FIG. 7, a gateway device in the embodiment shown in FIG. 9 includes the network interface card 140 in FIG. 7. The network interface card 240 in FIG. 7 is disposed in a first RDMA storage node in the embodiment shown in FIG. 9. The gateway device establishes an RDMA connection to the first RDMA storage node by using the network interface card 140 and performs interaction. For example, the gateway device adds a first RDMA request packet to the SQ 302 in FIG. 7, to implement S404 in the embodiment shown in FIG. 9.

The gateway device adds the first RDMA request packet to the SQ 302 in FIG. 7, to implement S404 in the embodiment shown in FIG. 9. The first RDMA storage node implements, based on the RQ 403 in FIG. 7, S405 in the embodiment shown in FIG. 9.

Optionally, with reference to FIG. 8, a network deployment scenario on which the method shown in FIG. 9 is based is shown in FIG. 8. For example, with reference to FIG. 8, the first RDMA storage node in the method shown in FIG. 9 is the RDMA storage node 35 in FIG. 8, the client in the method shown in FIG. 9 is the client 31 in FIG. 8, and the gateway device in the method shown in FIG. 9 is the gateway device 33 in FIG. 8.

The method shown in FIG. 9 includes S401 to step S406 as follows.

S401: The client sends a first NOF request packet.

The first NOF request packet carries an NVMe instruction.

The NVMe instruction instructs to perform a read/write operation on a first destination address. For a concept of the NVMe instruction, refer to (3) of the foregoing term explanation part. Optionally, the NVMe instruction carried in the first NOF request packet is specifically an I/O instruction.

When data is read, optionally, the first NOF request packet is an NOF read request packet, the NVMe instruction carried in the first NOF request packet is an NVMe read instruction, and the NVMe instruction carried in the first NOF request packet instructs to perform a read operation on the first destination address. For a concept of the NVMe read instruction, refer to (4) of the foregoing term explanation part.

When data is written, optionally, the first NOF request packet is an NOF write request packet, the NVMe instruction carried in the first NOF request packet is an NVMe write instruction, and the NVMe instruction carried in the first NOF request packet instructs to perform a write operation on the first destination address. For a concept of the NVMe write instruction, refer to (5) of the foregoing term explanation part.

Optionally, the first destination address indicates a location of a storage space provided by an NVMe storage medium. For example, when the data is read, the first destination address indicates a location, of to-be-read data, in the NVMe storage medium. When the data is written, the first destination address indicates a location, of to-be-stored data, in the NVMe storage medium. Optionally, the first destination address is a logical address (or referred to as a virtual address).

There are a plurality of possible implementations about a data form of the first destination address. Optionally, a form of the first destination address meets a specification of an NVMe protocol. In other words, the first destination address is an NVMe address. For example, the first destination address includes a start logical block address (start LBA) and a block number.

In a possible implementation, the first destination address includes a LUN ID, a start address, and a data length. Specifically, a memory space of the first RDMA storage node is not directly exposed to the client, but is virtualized into a logical unit (LU) for the client to use. In other words, from a perspective of the client, storage resources sensed by the client are LUNs instead of memories on the RDMA storage node. The gateway device communicates with the client based on LUN semantics. For concepts of the LU and the LUN, refer to (31) of the foregoing term concept explanation part. Optionally, a step of mapping a memory space to an LUN is optionally performed by the gateway device or a control plane device. Optionally, the first RDMA storage node provides an RDMA memory space for the LUN at a granularity of a page. In other words, the RDMA memory space is allocated by a page or an integer multiple of the page. A size of a page is, for example, 4 KB or 8 KB.

In another possible implementation, the first destination address and the following second destination address (an address of the memory space) are a same address. Specifically, a network element such as the gateway device or the control plane device exposes the memory space of the first RDMA storage node to the client, so that the client can sense the memory of the RDMA storage node. The gateway device communicates with the client based on memory semantics.

Optionally, the first NOF request packet includes the first destination address. For example, the first NOF request packet has a start LBA field and a block number field. Content of the start LBA field and the block number field indicates the first destination address.

Optionally, the first NOF request packet includes NOF status information.

S402: The gateway device receives the first NOF request packet from the client.

Optionally, the gateway device pre-establishes an NOF connection to the client. The gateway device receives the first NOF request packet through the NOF connection to the client. The NOF connection is a logical connection established according to an NOF protocol.

There are a plurality of cases about a transmission manner of the first NOF request packet. The following uses a case 1 and a case 2 as examples for description.

Case 1: After being sent from the client, the first NOF request packet is forwarded to the gateway device by using one or more forwarding devices.

The case 1 supports a scenario in which the one or more forwarding devices are deployed between the client and the gateway device. After the client sends the first NOF request packet, the forwarding device receives the first NOF request packet, and forwards the first NOF request packet to the gateway device.

The forwarding device through which the first NOF request packet passes includes but is not limited to a layer-2 forwarding device (for example, a switch), a layer-3 forwarding device (for example, a router or a switch), and the like. The forwarding device includes but is not limited to a wired network device or a wireless network device.

Case 2: After being sent from the client, the first NOF request packet directly arrives at the gateway device.

The case 2 supports a scenario in which the client is directly and physically connected to the gateway device. The gateway device is a next-hop node of the client.

S403: The gateway device obtains information about the first RDMA storage node based on the first destination address.

The gateway device obtains the first destination address from the first NOF request packet. The gateway device obtains information about a destination storage node based on the first destination address, to obtain the information about the first RDMA storage node.

In some embodiments, a process in which the gateway device obtains the first destination address includes: The gateway device obtains a start LBA from the start LBA field in the first NOF request packet, obtains the block number from the block number field in the first NOF request packet, and obtains a block size based on an attribute of the NOF connection. The gateway device obtains the first destination address based on the start LBA, the block number, and the block size.

When data is read, the first RDMA storage node is a storage node of the to-be-read data, namely, a storage node in which data requested to be obtained in the first NOF request packet is stored. When data is written, the first RDMA storage node is a storage node of the to-be-stored data, namely, a storage node to which data requested to be stored in the first NOF request packet is written. There are a plurality of cases about specific content of the information about the first RDMA storage node. For example, the information about the first RDMA storage node is a device identifier of the first RDMA storage node. For another example, the information about the first RDMA storage node is a network address of the first RDMA storage node. For another example, the information about the first RDMA storage node is a memory address of the first RDMA storage node. For another example, the information about the first RDMA storage node is any information that can identify the RDMA connection of the first RDMA storage node. For another example, the information about the first RDMA storage node is a port number of the first RDMA storage node. For another example, the information about the first RDMA storage node is a session ID of a session between the gateway device and the first RDMA storage node. For another example, the information about the first RDMA storage node is a public key of the first RDMA storage node. For another example, the information about the first RDMA storage node is permission information (for example, R_Key) for accessing a memory of the first RDMA storage node.

In a possible implementation, the information about the first RDMA storage node includes at least one of the following information: a second destination address, network location information of the first RDMA storage node, identifiers of one or more QPs in the first RDMA storage node, and R_Key. R_Key indicates permission to access the memory of the first RDMA storage node.

The second destination address points to the memory space of the first RDMA storage node. When data is read, the second destination address indicates a location, of the to-be-read data, in the memory space of the first RDMA storage node. When data is written, the second destination address indicates a location, of the to-be-stored data, in the memory space of the first RDMA storage node. Optionally, the second destination address is a logical address (or referred to as a virtual address). There are a plurality of possible implementations about a data form of the second destination address. Optionally, a form of the second destination address meets a specification of an RDMA protocol. In other words, the second destination address is an RDMA address. For example, the second destination address includes a VA and a DMA length. Optionally, the second destination address is other data that can indicate a location in the memory, for example, a memory space ID, and a start address and a length of the memory space.

The network location information of the first RDMA storage node identifies the first RDMA storage node in a network. Optionally, there is an intermediate network device between the gateway device and the first RDMA storage node. The network location information indicates the intermediate network device to perform routing and forwarding. Specifically, after the gateway device sends the first RDMA request packet, the first RDMA request packet first arrives at the intermediate network device. The intermediate network device obtains the network location information of the first RDMA storage node based on the first RDMA request packet. The intermediate network device searches for a local route forwarding entry based on the network location information, and routes and forwards the first RDMA request packet, so that the first RDMA request packet is transmitted to the first RDMA storage node.

In some embodiments, the network location information includes at least one of a MAC address, an IP address, a multi-protocol label switching (MPLS) label, or a segment identifier (SID).

For example, there is a layer-2 network between the gateway device and the first RDMA storage node, the network location information is a MAC address of the first RDMA storage node, and the MAC address identifies the first RDMA storage node in the layer-2 network.

For another example, there is an IP network between the gateway device and the first RDMA storage node, the network location information is an IP address of the first RDMA storage node, and the IP address identifies the first RDMA storage node in the IP network.

For another example, there is an MPLS network between the gateway device and the first RDMA storage node, the network location information is an MPLS label of the first RDMA storage node, and the MPLS label identifies the first RDMA storage node in the MPLS network.

For another example, there is a segment routing (SR) network between the gateway device and the first RDMA storage node, the network location information is an SID of the first RDMA storage node, and the SID identifies the first RDMA storage node in the SR network.

The identifier of the QP indicates a QP in the first RDMA storage node. A QP is equivalent to a logical channel between the gateway device and the first RDMA storage node. Optionally, the first RDMA storage node includes a plurality of QPs. A first correspondence includes an identifier of each of the plurality of QPs in the first RDMA storage node.

S404: The gateway device sends the first RDMA request packet to the first RDMA storage node.

The gateway device generates the first RDMA request packet based on the information about the first RDMA storage node and an RDMA instruction corresponding to the NVMe instruction. The gateway device sends the generated first RDMA request packet to the first RDMA storage node.

The first RDMA request packet is a request packet in the RDMA protocol. Optionally, the first RDMA request packet is a one-sided RDMA operation packet. For example, when data is read, the first NOF request packet is an NOF read request packet, and the first RDMA request packet is an RDMA read request (RDMA read request) packet. For another example, when data is written, the first NOF request packet is an NOF write request packet, and the first NOF request packet includes to-be-stored data. The first RDMA request packet is an RDMA write request (RDMA write request) packet. The first RDMA request packet includes the to-be-stored data in the first NOF request packet. The first RDMA request packet carries the RDMA instruction corresponding to the NVMe instruction, and the information about the first RDMA storage node.

The RDMA instruction instructs to perform a read/write operation on the second destination address in an RDMA manner. When the NVMe instruction carried in the first NOF request packet is the NVMe read instruction, the RDMA instruction carried in the first RDMA request packet instructs to perform an RDMA read operation on the second destination address. For a concept of the RDMA read operation, refer to the description in (12) of the foregoing term explanation part. When the NVMe instruction carried in the first NOF request packet is the NVMe write instruction, the RDMA instruction carried in the first RDMA request packet instructs to perform an RDMA write operation on the second destination address. For a concept of the RDMA write operation, refer to the description in (11) of the foregoing term explanation part.

Optionally, the first RDMA request packet includes the second destination address. For example, the first RDMA request packet includes an RETH, and the RETH in the first RDMA request packet includes a VA field and a DMA length field. The second destination address is carried in the VA field and the DMA length field.

In some embodiments, the NVMe instruction carried in the first NOF request packet and the RDMA instruction carried in the first RDMA request packet have different semantics. The semantics of the NVMe instruction is to perform an operation on an NVMe medium (hard disk). The semantics of the RDMA instruction is to perform an operation on the memory.

Optionally, the gateway device supports a function of converting an NVMe instruction into an RDMA instruction. The gateway device converts the NVMe instruction carried in the first NOF request packet into the corresponding RDMA instruction, to generate the first RDMA request packet. In a possible implementation, the gateway device stores a correspondence between the NVMe instruction and the RDMA instruction. After the gateway device receives the first NOF request packet, the gateway device obtains the NVMe instruction carried in the first NOF request packet, and the gateway device queries the correspondence between the NVMe instruction and the RDMA instruction according to the NVMe instruction, to obtain the RDMA instruction corresponding to the NVMe instruction. The gateway device encapsulates the RDMA instruction into an RDMA request packet, to generate the first RDMA request packet. In another possible implementation, based on a difference between the NVMe instruction and the RDMA instruction, the gateway device modifies all or some parameters in the NVMe instruction, to convert the NVMe instruction into the RDMA instruction.

Optionally, the first RDMA request packet includes RDMA status information.

Optionally, the gateway device pre-establishes the RDMA connection to the first RDMA storage node. The gateway device sends the first RDMA request packet to the first RDMA storage node through the RDMA connection to the first RDMA storage node. The RDMA connection is a logical connection established according to the RDMA protocol.

S405: The first RDMA storage node receives the first RDMA request packet.

S406: The first RDMA storage node executes the RDMA instruction to perform a read/write operation on the memory.

The first RDMA storage node obtains the second destination address and the RDMA instruction from the first RDMA request packet. The first RDMA storage node finds, from a local memory, a memory space corresponding to the second destination address. The first RDMA storage node executes the RDMA instruction to perform a read/write operation on the memory space.

When data is read, the first RDMA storage node executes an RDMA read instruction, to perform an RDMA read operation on the memory space corresponding to the second destination address, and obtain data stored in the memory space corresponding to the second destination address. When data is written, the first RDMA storage node obtains to-be-stored data from the first RDMA request packet. The first RDMA storage node performs, according to the RDMA write instruction, an RDMA write operation on the memory space corresponding to the second destination address, and stores the data in the memory space corresponding to the second destination address.

The foregoing describes a procedure of interaction between three sides, namely, the client, the gateway device, and the RDMA storage node in a request packet transmission process in S401 to S406. The following analyzes technical effect achieved by the foregoing procedure. For details, refer to the following five descriptions.

1. Because the gateway device converts an access (the first NOF request packet from the client) initiated to an NOF or NVMe storage node into an access (the first RDMA request packet) to the RDMA storage node, storage performance is improved.

From a perspective of a storage medium, a storage medium provided by the RDMA node is a memory, and performance of the memory is better than that of an NVMe hard disk. The gateway device converts an NOF request packet into an RDMA request packet, and converts the NVMe instruction into the RDMA instruction, which is equivalent to converting a hard disk operation into a memory operation, to fully utilize a performance advantage of memory storage and improve performance. From a perspective of an instruction set, an instruction set of the memory operation is simpler than an instruction set of the hard disk operation. This reduces complexity of executing a read/write instruction by a storage node, and further improves performance.

2. Because the gateway device determines the information about the RDMA storage node (the information about the first remote direct memory access RDMA storage node) based on an NVMe destination logical address (the first destination address), and supports addressing offloading, pressure of a CPU of the storage node is reduced.

In this embodiment, addressing is a process of searching for a destination storage node based on a destination NVMe address. The so-called “offloading” (e.g., offload) is usually transferring a task that is originally executed by a CPU to specific hardware for execution. In a related technology, addressing is usually performed by a CPU of an NOF storage node. Specifically, in the related technology, the CPU of the NOF storage node needs to determine, based on the destination NVMe address, whether the destination storage node is the node. If the destination storage node is not the node, the NOF storage node needs to reconstruct a request packet and then forward the constructed request packet to a final destination storage node. An addressing process, a request packet reconstructing process, and a packet forwarding process all occupy a large number of processing resources of the CPU of the storage node, and the packet forwarding process further brings network I/O pressure to the storage node.

In this embodiment, an addressing task (for example, a step of determining the first RDMA storage node based on the first destination address) is executed by the gateway device, which is equivalent to offloading an addressing task of the NOF storage node. This reduces pressure of the CPU of the NOF storage node, and reduces network I/O pressure caused by packet forwarding on the storage node. In addition, because a destination node location can be determined at a network layer (gateway device) instead of being redirected to a service layer (NOF storage node), a network traffic forwarding mode is optimized.

3. Because the gateway device is deployed in a system, and the gateway device establishes a logical connection (RDMA connection) to the RDMA storage node, the gateway device takes over an original back-end expansion function of the storage node. This optimizes a packet forwarding path, and reduces a packet forwarding latency.

In an NOF storage network in the related technology, when the client accesses a storage node, a forwarding path of an NOF request packet is logically a client→a network device→an NOF front-end storage node→an NOF back-end storage node. It can be seen that the forwarding path needs at least two hops of intermediate nodes, namely, the network device and the NOF front-end storage node, resulting in a long packet forwarding path and a large latency. The NOF front-end storage node is configured to forward a packet to the NOF back-end storage node at a destination storage address instead of the node.

In this embodiment, when the client accesses a storage node, a forwarding path of a request packet is logically the client→the gateway device→an RDMA storage node, and forwarding of an NOF front-end storage node is not needed. This shortens a packet forwarding path, and reduces a packet forwarding latency.

4. Because the gateway device performs a processing procedure based on the NOF request packet initiated by the client, and does not need to require the client to initiate an RDMA packet, the client does not need to be changed. This reduces a difficulty in service provisioning.

From a perspective of the client, the client may use a storage service provided by the RDMA storage node when initiating an access according to an original NOF procedure, and does not sense a change of the storage node or require the client to support an RDMA. Therefore, this solution is compatible with an original NOF storage solution, so that a service can be quickly provisioned.

5. Because the gateway device is deployed in the system, and the gateway device establishes the logical connection (RDMA connection) to the RDMA storage node, a difficulty in capacity expansion of the storage system is reduced, and expansibility of the storage system is improved.

In the related technology, when a storage node is newly added to an NOF storage system, the client is usually required to establish a connection to the newly added storage node, and a storage capacity provided by the newly added storage node can be used only after the client is connected to the newly added storage node, resulting in a high requirement on the client and a large difficulty in capacity expansion.

In this embodiment, because work of establishing an RDMA connection to an RDMA storage node is performed by the gateway device, when an RDMA storage node is newly added to the storage system, the gateway device establishes a connection to and interacts with the newly added RDMA storage node, and a storage capacity of the newly added RDMA storage node can be provided for the client for use. From the perspective of the client, the client does not need to sense the newly added RDMA storage node, and the client does not need to establish a connection to the newly added RDMA storage node. The client can use a storage capacity of the newly added RDMA storage node by using a previously established connection to the gateway device. Obviously, this reduces a requirement on the client, and reduces a difficulty in capacity expansion, meets a requirement for flexible capacity expansion of the storage system, and improves expansibility.

Optionally, based on S401 to S406 above, the method shown in FIG. 9 further includes S407 to S412 below. S401 to S406 above are a procedure of interaction in an NOF-RDMA direction. S407 to S412 below are a procedure of interaction in an RDMA-NOF direction.

S407: The first RDMA storage node generates an RDMA response packet.

S408: The first RDMA storage node sends the RDMA response packet.

The RDMA response packet is a response packet for the first RDMA request packet. The RDMA response packet indicates making a response to the RDMA instruction in the first RDMA request packet. For example, when data is read, the RDMA response packet is an RDMA read response packet. Executing the RDMA instruction includes a process of performing the RDMA read operation, and the RDMA response packet includes data read from the memory space of the first RDMA storage node. For example, the read data is carried in a payload field of the RDMA read response packet. For example, when data is written, the RDMA response packet is an RDMA ACK packet.

Optionally, the RDMA response packet includes RDMA status information. The RDMA status information indicates a correspondence between the RDMA response packet and the first RDMA request packet. Optionally, a value of the RDMA status information in the RDMA response packet is the same as a value of the RDMA status information in the first RDMA request packet. Alternatively, a value of the RDMA status information in the RDMA response packet is different from a value of the RDMA status information in the first RDMA request packet, and the value of the RDMA status information in the RDMA response packet and the value of the RDMA status information in the first RDMA request packet meet a set rule (for example, a difference is 1).

S409: The gateway device receives the RDMA response packet from the first RDMA storage node.

S410: The gateway device generates a first NOF response packet based on the RDMA response packet.

The first NOF response packet is a response packet for the first NOF request packet. The first NOF response packet indicates making a response to the NVMe instruction in the first NOF request packet.

When data is read, the first NOF response packet includes data that is requested to be obtained by the first NOF request packet. A process of generating the first NOF response packet includes: The gateway device obtains, from the RDMA response packet, data stored in the memory space of the first RDMA storage node. The gateway device generates the first NOF response packet based on the data stored in the memory space of the first RDMA storage node. Optionally, the first NOF response packet further includes a CQE, and the CQE indicates that an NVMe read operation has been completed.

When data is written, the first NOF response packet is an NOF write response packet. The first NOF response packet includes a CQE, and the CQE indicates that an NVMe write operation has been completed, or that the data has been successfully stored.

Optionally, the first NOF response packet includes NOF status information. The NOF status information indicates a correspondence between the first NOF response packet and the first NOF request packet. Optionally, a value of the NOF status information in the first NOF response packet is the same as a value of the NOF status information in the first NOF request packet. For example, the first NOF request packet and the first NOF response packet include a same virtual address, a same remote key, and a same direct memory access length. Alternatively, a value of the NOF status information in the first NOF request packet is different from a value of the NOF status information in the first NOF response packet, and the value of the NOF status information in the first NOF request packet and the value of the NOF status information in the first NOF response packet meet a set rule (for example, a difference is 1). For example, a difference between a PSN in the first NOF request packet and a PSN in the first NOF response packet is equal to a specified value.

S411: The gateway device sends the first NOF response packet to the client.

S412: The client receives the first NOF response packet.

The foregoing describes a procedure of interaction between three sides, namely, the client, the gateway device, and the RDMA storage node in a response packet transmission process in S407 to S412. In S407 to S412, the gateway device implements an NOF protocol stack proxy, and replaces the RDMA storage node to return a response packet to the client. Because the response packet sensed by the client is still an NOF packet, the client does not need to sense protocol packet conversion logic. This reduces a difficulty in maintaining the client. In addition, the RDMA storage node does not need to support an NOF protocol. This reduces types of protocols that need to be supported by the RDMA storage node.

With reference to the embodiment shown in FIG. 9, the foregoing describes an overall procedure of interaction between the client, the gateway device, and the RDMA storage node. The following describes specific implementations that may be used in some steps in the embodiment shown in FIG. 9.

In this embodiment of this application, there are a plurality of implementations about how the gateway device obtains the information about the RDMA storage node (for example, the information about the first RDMA storage node) based on the destination NVMe address (for example, the first destination address). The following describes some possible implementations by using examples.

Optionally, the gateway device obtains the information about the RDMA storage node by querying a correspondence. The following describes this implementation.

Because some embodiments of this application relate to correspondences between different information, the following uses a “first correspondence” and a “second correspondence” to distinguish and describe the correspondences between the different information, to distinguish the different correspondences.

For example, a correspondence used when the destination storage node is determined is referred to as the first correspondence. Optionally, in the method shown in FIG. 9, after the gateway device receives the first NOF request packet, the gateway device obtains the first destination address from the first NOF request packet, and the gateway device obtains the information about the first RDMA storage node by querying the first correspondence based on the first destination address, to determine that the destination storage node corresponding to the first destination address is the first RDMA storage node. Then, the gateway device generates the first RDMA request packet based on the information about the first RDMA storage node. The first RDMA request packet includes the information about the first RDMA storage node.

The first correspondence is a correspondence between the first destination address and the information about the first RDMA storage node. The first correspondence includes the first destination address and the information about the first RDMA storage node.

Optionally, the first correspondence is content of an entry in a table. For example, the first correspondence is a combination of content of two fields in a same entry. In the two fields, one field indicates the first destination address, and the other field indicates the information about the first RDMA storage node. In a possible implementation, the first correspondence is specifically content of an entry in an address translation table. For the address translation table, refer to the following description of an example 1.

There are a plurality of implementations about how the gateway device obtains the first correspondence. The following uses two possible implementations as an example for description. Refer to the following implementation A and implementation B.

Implementation A: The gateway device generates the first correspondence.

The implementation A is a solution in which the gateway device is responsible for address orchestration. Specifically, the gateway device allocates an NVMe logical address to the first RDMA storage node, to obtain the first destination address. The gateway device establishes a correspondence between the first destination address and the information about the first RDMA storage node, to generate the foregoing first correspondence.

In a process of generating the first correspondence, there are a plurality of implementations about how the gateway device obtains the information about the first RDMA storage node. The following uses four possible implementations as an example for description. Refer to the following obtaining manner 1 to obtaining manner 4.

Obtaining manner 1: The first RDMA storage node actively reports information about the node to the gateway device.

The first RDMA storage node sends the information about the first RDMA storage node to the gateway device. The gateway device receives the information about the first RDMA storage node sent by the first RDMA storage node, to obtain the information about the first RDMA storage node.

There are a plurality of cases about an occasion on which the first RDMA storage node reports information. In a possible implementation, the first RDMA storage node sends the information about the first RDMA storage node to the gateway device when establishing the RDMA connection to the gateway device. In another possible implementation, the first RDMA storage node sends the information about the first RDMA storage node to the gateway device when the information about the node is updated. For example, memory defragmentation, the information about the first RDMA storage node may be updated in scenarios such as network location change, IP address reallocation, data migration. Optionally, when it is found that the information about the node is updated, the first RDMA storage node sends updated information about the node to the gateway device. In another possible implementation, the first RDMA storage node sends the information about the first RDMA storage node to the gateway device during power-on, startup, or restart. In another possible implementation, the first RDMA storage node sends the information about the first RDMA storage node to the gateway device when receiving an instruction.

There are a plurality of specific implementations in which the first RDMA storage node reports information. In a possible implementation, the first RDMA storage node generates an RDMA packet and sends the RDMA packet to the gateway device, where the RDMA packet carries the information about the first RDMA storage node. In a specific example, the first RDMA storage node generates an RDMA registration packet and sends the RDMA registration packet to the gateway device, where the RDMA registration packet carries the information about the first RDMA storage node. The RDMA registration packet is used to register the memory space of the first RDMA storage node as a space used for an RDMA operation. Optionally, the RDMA registration packet is a packet for a double-sided operation in an RDMA. For example, the RDMA registration packet is a send packet or a receive packet. In another possible implementation, the first RDMA storage node reports the information about the node to the gateway device according to another inter-device communication protocol except for the RDMA. For example, the first RDMA storage node reports the information about the node to the gateway device based on a private protocol packet, a routing protocol packet, or the like, or through a communication interface between a storage node and a control plane.

Obtaining manner 2: The gateway device pulls the information about the first RDMA storage node from the first RDMA storage node.

For example, the gateway device generates a query request and sends the query request to the first RDMA storage node, where the query request indicates to obtain the information about the first RDMA storage node. The first RDMA storage node receives the query request, generates a query response, and sends the query response to the gateway device, where the query response includes the information about the first RDMA storage node. The gateway device receives the query response, and obtains the information about the first RDMA storage node from the query response.

There are a plurality of implementations about types of protocols corresponding to the query request and the query response. For example, the query request and the query response each are a network configuration (NETCONF) packet or a simple network management protocol (SNMP) packet.

Obtaining manner 3: The gateway device obtains the information about the first RDMA storage node from a control plane or management plane network element.

The gateway device generates a query request and sends the query request to the control plane or management plane network element, where the query request indicates to obtain the information about the first RDMA storage node. The control plane or management plane network element receives the query request, generates a query response, and sends the query response to the gateway device, where the query response includes the information about the first RDMA storage node. The gateway device receives the query response, and obtains the information about the first RDMA storage node from the query response.

There are a plurality of implementations about the control plane or management plane network element. For example, a storage node selected from storage nodes in the storage system serves as the control plane or management plane network element. Optionally, the control plane or management plane network element is an NOF storage node or an RDMA storage node. For another example, an independent network element is deployed as the control plane or management plane network element.

Obtaining manner 4: The gateway device obtains the information about the first RDMA storage node through static configuration.

Specifically, a network administrator configures the information about the first RDMA storage node in the gateway device by using a command line or a web interface, or in another manner. The gateway device obtains the information about the first RDMA storage node based on a configuration operation of the network administrator.

When the first correspondence is generated, there are a plurality of implementations about how the gateway device allocates an NVMe logical address to the first RDMA storage node. In general, the gateway device allocates the NVMe logical address to the first RDMA storage node based on a constraint condition that NVMe logical addresses corresponding to different storage nodes in the storage system are not repeated.

In a possible implementation, the gateway device not only obtains the information about the first RDMA storage node, but also obtains information about other RDMA storage nodes. The gateway device creates a storage resource pool based on information about RDMA storage nodes. A storage space of the storage resource pool comes from memory spaces of the RDMA storage nodes. Then, the gateway device performs unified addressing on each memory space in the storage resource pool, so that each memory space has a unique global address. The global address means that a memory space indicated by the address is unique in the storage resource pool, and physical memory spaces corresponding to different global addresses are not repeated. A global address of the memory space of the first RDMA storage node is the NVMe logical address allocated to the first RDMA storage node. Optionally, a hard disk space of an NOF storage node is also included in the storage resource pool, which is equivalent to pooling memory spaces provided by RDMA storage nodes and hard disk spaces of NOF storage nodes, to implement unified management. For example, the gateway device not only obtains the information about the RDMA storage nodes, but also obtains information about NOF storage nodes. The gateway device creates the storage resource pool based on the information about the RDMA storage nodes and the information about the NOF storage nodes. For more details of implementing address orchestration by the gateway device, refer to the following description in an example 3.

Implementation B: The gateway device receives the first correspondence from another device except for the gateway device.

The implementation B is a solution in which the another device except for the gateway device is responsible for address orchestration. For example, the control plane or management plane network element is responsible for address orchestration. The control plane or management plane network element allocates an NVMe logical address to the first RDMA storage node, to obtain the first destination address. The control plane or management plane network element establishes a correspondence between the first destination address and the information about the first RDMA storage node, to generate the foregoing first correspondence. The control plane or management plane network element sends the first correspondence to the gateway device. The gateway device receives the first correspondence sent by the control plane or management plane network element.

For how the control plane or management plane network element obtains the information about the first RDMA storage node and allocates the NVMe logical address when generating the first correspondence, refer to the description in the implementation A. The steps described in the implementation A are performed by the control plane or management plane network element instead of the gateway device.

Optionally, the control plane or management plane network element collaborates with the gateway device to generate the first correspondence. The gateway device is responsible for reporting information about the first RDMA storage node to the control plane or management plane network element, and the control plane or management plane network element generates the first correspondence based on the information reported by the gateway device.

The foregoing describes a solution in which the gateway device determines the destination storage node by querying the correspondence. The following analyzes technical effect of this manner.

The gateway device determines the destination storage node by querying the correspondence, thereby reducing implementation complexity, and quickly determining the destination storage node in the packet forwarding process. Especially, because processing logic of a manner of querying the correspondence is simple and modeled, it is easy to offload the processing logic to dedicated hardware for execution, and resources of a main control processor do not need to be consumed. In a possible implementation, the first correspondence and a forwarding entry are stored in a memory on an interface board (also referred to as a service board), and an action of querying the first correspondence is performed by a processor on the interface board, so that content of an NOF request packet does not need to be sent to the main control processor. This saves computing power of the main control processor and improves forwarding efficiency.

That the foregoing gateway device determines the RDMA storage node by querying the correspondence is an optional implementation in embodiments of this application. In some other embodiments, the gateway device determines the RDMA storage node in another implementation. The following uses some other implementations as examples for description.

For example, when data is written, the gateway device determines the destination storage node based on a quality of service (QOS) policy. For example, if the client has a high service level agreement (SLA) requirement, the gateway device determines the RDMA storage node as the destination storage node. If the client has a low SLA requirement, the gateway device determines the NOF storage node as the destination storage node.

For another example, when data is written, the gateway device determines the destination storage node based on a load balancing strategy. Specifically, after the gateway device receives the first NOF request packet, the gateway device selects a storage node with a largest free capacity from the storage nodes as the destination storage node based on current free capacities of the storage nodes in the storage system, to ensure that data is written to the storage nodes as evenly as possible.

For another example, another device except for the gateway device performs a step of querying the correspondence, and then notifies the gateway device of the destination storage node obtained by querying the correspondence.

For another example, the client specifies the destination storage node. For example, the first NOF request packet sent by the client includes an identifier of the first RDMA storage node. The foregoing manners of determining the destination storage node are all optional manners. How the gateway device determines the destination storage node after receiving the first NOF request packet is not limited in embodiments.

In this embodiment of this application, how the gateway device generates an NOF response packet to reply to the client includes a plurality of implementations. The following describes, by using examples, some implementations that may be used when the NOF response packet is generated.

Optionally, after receiving the RDMA response packet returned by the RDMA storage node, the gateway device obtains the NOF status information through some means, and generates the NOF response packet based on the NOF status information.

The following describes some possible implementations about how the gateway device obtains the NOF status information. Refer to the following implementation I and implementation II.

Implementation I: The gateway device obtains the NOF status information by querying the correspondence.

For example, the correspondence used when the NOF status information is obtained is referred to as a second correspondence. Optionally, in the method S410 shown in FIG. 9, the gateway device obtains the RDMA status information based on the RDMA response packet; the gateway device obtains the NOF status information by querying the second correspondence based on the RDMA status information; and the gateway device generates the first NOF response packet based on the NOF status information.

The second correspondence is a correspondence between the RDMA status information and the NOF status information. The second correspondence includes the correspondence between the RDMA status information and the NOF status information. For a concept of the RDMA status information, refer to the description in (17) of the foregoing term explanation part. For a concept of the NOF status information, refer to the description in (18) of the foregoing term explanation part.

Optionally, the second correspondence is content of an entry in a table. For example, the second correspondence is a combination of content of two fields in a same entry. In the two fields, one field indicates the RDMA status information, and the other field indicates the NOF status information. In a possible implementation, the second correspondence is specifically content of an entry in an NOF context table. For the NOF context table, refer to the following description of the example 1.

There are a plurality of implementations about how the gateway device obtains the second correspondence. Optionally, the gateway device establishes the second correspondence in a process of converting the NOF request packet into the RDMA request packet. For example, with reference to the method shown in FIG. 9, after the gateway device receives the first NOF request packet, the gateway device obtains the NOF status information based on the first NOF request packet; and the gateway device obtains the RDMA status information based on a current status of the RDMA connection to the RDMA storage node. The gateway device establishes the correspondence between the NOF status information and the RDMA status information.

The following uses an example in which the RDMA status information is an RDMA PSN and the NOF status information is an NOF PSN to describe a possible implementation about how to establish the second correspondence.

For example, when the gateway device performs the method shown in FIG. 9, the gateway device obtains an NOF PSN carried in the first NOF request packet, obtains an RDMA PSN carried in an RDMA request packet (namely, the first RDMA request packet) to be sent this time, and establishes a correspondence between the NOF PSN and the RDMA PSN.

A basic principle of obtaining the RDMA PSN by the gateway device is that when the gateway device establishes a session with the RDMA storage node according to the RDMA protocol, the gateway device initializes the RDMA PSN to obtain an RDMA PSN. Then, each time the gateway device needs to send an RDMA request packet to the RDMA storage node once, the gateway device first updates, according to a set rule, an RDMA PSN carried in a last RDMA request packet, includes an updated RDMA PSN in the RDMA request packet that needs to be sent this time, and then sends the RDMA request packet.

A specific manner in which the gateway device updates an RDMA PSN in an interaction process is determined based on processing logic of an RDMA protocol stack. For example, in a non-fragmentation scenario, the RDMA PSN is updated to the RDMA PSN plus 1; or in a fragmentation scenario, the RDMA PSN is updated to the RDMA PSN plus a number of fragments. A specific manner of updating the RDMA PSN is not limited in embodiments.

The second correspondence described above is a correspondence between the RDMA PSN and the NOF PSN. In some other embodiments, the RDMA PSN in the second correspondence is replaced with other RDMA status information, and the NOF PSN in the second correspondence is replaced with other NOF status information. Specific content of the RDMA status information and the NOF status information in the second correspondence is not limited in embodiments.

The foregoing manner of establishing the correspondence between the NOF status information and the RDMA status information is optional. In some other embodiments, a correspondence between the NOF status information and other information is established, and the gateway device obtains the NOF status information by searching for the correspondence between the NOF status information and the other information. For example, the gateway device establishes a correspondence between the NOF status information and the information (for example, a device identifier) about the first RDMA node. For another example, the gateway device maintains a session table. In a process of a session performed between the gateway device and the client according to the NOF protocol, each time the gateway device exchanges a packet with the client, the gateway device stores current NOF status information into the session table, and the gateway device determines, based on latest stored NOF status information in the session table, NOF status information that needs to be used when an NOF response packet is currently sent.

The foregoing implementation I describes a solution in which the gateway device obtains the NOF status information by querying the correspondence. The following analyzes technical effect of this manner. Refer to the following two points.

1. This reduces implementation complexity, and it is easy to offload a task to dedicated hardware for execution. For a principle herein, refer to the foregoing description of the technical effect of determining the destination storage node by querying the correspondence.

2. An original RDMA protocol does not need to be modified, and therefore, compatibility with the original RDMA is better.

Implementation II: The gateway device first includes the NOF status information in the RDMA request packet, and sends the RDMA request packet to the RDMA storage node, and then the gateway device obtains the NOF status information from the RDMA response packet returned by the RDMA storage node.

For example, with reference to the method shown in FIG. 9, after the gateway device receives the first NOF request packet, the gateway device obtains the NOF status information based on the first NOF request packet. The gateway device includes the NOF status information in the first RDMA request packet, to obtain the first RDMA request packet including the NOF status information. The gateway device sends the first RDMA request packet including the NOF status information to the first RDMA storage node. After the RDMA storage node receives the first RDMA request packet, the RDMA storage node obtains the NOF status information from the first RDMA request packet. The RDMA storage node includes the NOF status information to the RDMA response packet, to obtain the RDMA response packet including the NOF status information. The RDMA storage node sends the RDMA response packet including the NOF status information. After the gateway device receives the RDMA response packet, the gateway device obtains the NOF status information based on the RDMA response packet; and the gateway device generates the first NOF response packet based on the NOF status information.

There are a plurality of cases about locations at which the NOF status information is carried in the first RDMA request packet and the RDMA response packet. In a possible implementation, the NOF status information is located between an RDMA header and a payload. In another possible implementation, the NOF status information is located in an RDMA header. Optionally, a new type of packet header or a new type of TLV is extended in the RDMA protocol, and the new type of packet header or TLV is used to carry the NOF status information. Alternatively, some reserved fields in the RDMA protocol are used to carry the NOF status information. How to carry the NOF status information in the RDMA packet is not limited in embodiments.

According to the method in the foregoing implementation II, the gateway device can obtain the NOF status information without locally maintaining an additional entry, thereby saving a storage space of the gateway device, and reducing resource overheads caused by table lookup and table writing of the gateway device.

The foregoing description that the gateway device generates the NOF response packet by obtaining the NOF status information is an optional implementation in this embodiment of this application. In another possible implementation, main processing work of generating an NOF packet header is performed on the RDMA storage node. Refer to the following implementation III.

Implementation III: The RDMA storage node performs processing to obtain some or all content of the NOF packet header, and the gateway device reuses a processing result of the RDMA storage node to generate the NOF response packet.

Optionally, before sending the RDMA request packet to the RDMA storage node, the gateway device pre-generates the NOF packet header, pads content of some fields in the NOF packet header, and sends the RDMA request packet including the NOF packet header to the RDMA storage node. After the RDMA storage node receives the RDMA request packet, the RDMA storage node further processes the NOF packet header, for example, pads content of a blank field in the NOF packet header, or modifies content of a field that has been padded by the gateway device. Then, the RDMA storage node carries a processed NOF packet header in the RDMA response packet, and returns the RDMA response packet including the NOF packet header. After the gateway device receives the RDMA response packet returned by the RDMA storage node, the gateway device generates the NOF response packet based on the NOF packet header in the RDMA response packet after receiving the RDMA response packet.

There are a plurality of implementations about a field that is in the NOF packet header and that is pre-padded by the gateway device. Optionally, the gateway device pads, based on the NOF status information, a field that is in the NOF packet header and that is used to carry the NOF status information. Optionally, the gateway device further pads one or more of content of a MAC header, content of an IP header, or content of a UDP header in the NOF packet header. A type of a field that is in the NOF packet header and that is pre-padded by the gateway device may be set based on a service scenario. A specific field that is in the NOF packet header and that is pre-padded by the gateway device is not limited in embodiments.

With reference to the method shown in FIG. 9, for example, the gateway device generates a first RDMA request packet including a first NOF packet header, and sends the first RDMA request packet including the first NOF packet header to the first RDMA storage node. After the first RDMA storage node receives the first RDMA request packet, the first RDMA storage node obtains the first NOF packet header from the first RDMA request packet; and the first RDMA storage node generates a second NOF packet header based on the first NOF packet header, generates an RDMA response packet including the second NOF packet header, and sends the RDMA response packet. After the gateway device receives the RDMA response packet, the gateway device generates a first NOF response packet based on the second NOF packet header in the RDMA response packet.

Optionally, an NOF packet header is encapsulated at an inner layer of an RDMA packet header. A specific process in which the gateway device generates the first NOF response packet includes: The gateway device strips an RDMA packet header at an outer layer from the RDMA response packet, and uses a remaining part of an obtained RDMA response packet as the NOF response packet.

The following describes the implementation III by using an example in which an NOF is an RoCE.

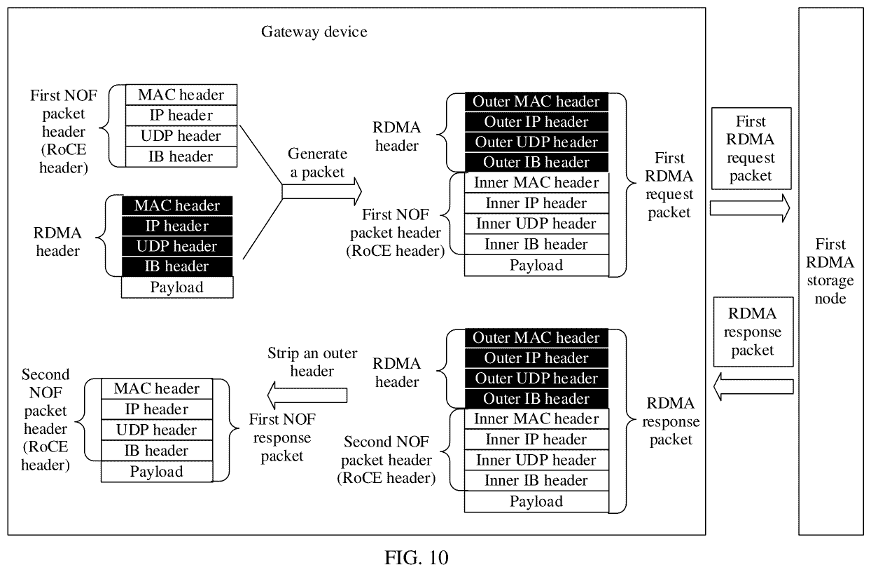

For example, refer to FIG. 10. The gateway device pre-generates an RoCE header (namely, the first NOF packet header), and the RoCE header includes a MAC header, an IP header, a UDP header, and an IB header. The gateway device pads content of the MAC header, IP header, UDP header, and IB header with information to be returned to the client. The gateway device encapsulates an RDMA header and a padded RoCE header to obtain the first RDMA request packet. The RoCE header is encapsulated at an inner layer of the RDMA header. The first RDMA storage node generates an RDMA response packet based on the RoCE header in the RDMA request packet. An RoCE header (the second NOF packet header) in the RDMA response packet is encapsulated at an inner layer of an RDMA header. The gateway device strips the RDMA header at an outer layer of the RDMA response packet, uses a remaining part of the RDMA response packet as the first NOF response packet, and returns the first NOF response packet to the client.

In the foregoing implementation III, the gateway device can obtain the NOF status information without locally maintaining an additional entry, thereby saving a storage space of the gateway device, and reducing resource overheads caused by table lookup and table writing of the gateway device. In addition, work of generating the NOF packet header is transferred to the RDMA storage node to be performed, to reduce processing pressure of the gateway device.

In the implementation III, the step of pre-generating the NOF packet header by the gateway device is an optional implementation. In some other embodiments, the RDMA storage node is responsible for encapsulating the NOF packet header into the RDMA packet.

Optionally, when data is written, the gateway device supports writing a same copy of data to each RDMA storage node in a plurality of RDMA storage nodes, to implement a data backup function. The following describes, by using examples, some possible implementations about how to implement data backup.

A case in which one copy of data is written to two RDMA storage nodes is used as an example. For example, in the method shown in FIG. 9, the first NOF request packet is an NOF write request packet, the first NOF request packet carries the NVMe write instruction, and the NVMe write instruction instructs to perform a write operation on the first destination address. After receiving the first NOF request packet, the gateway device obtains the information about the first RDMA storage node and information about a second RDMA storage node based on the first destination address. In this case, the gateway device not only generates the first RDMA request packet based on the first NOF request packet, but also generates a second RDMA request packet based on the first RDMA request packet. The gateway device not only sends the first RDMA request packet to the first RDMA storage node, but also sends the second RDMA request packet to the second RDMA storage node.

The second RDMA request packet and the first RDMA request packet have similar features. The second RDMA request packet also includes the to-be-stored data carried in the first NOF request packet. The second RDMA request packet includes an RDMA write instruction corresponding to the NVMe write instruction. In addition, the second RDMA request packet further includes the information about the second RDMA storage node. For example, the second RDMA request packet includes a third destination address, network location information of the second RDMA storage node, and identifiers of one or more QPs in the second RDMA storage node. The third destination address is an address of a memory space in the second RDMA storage node.

For a processing action of the first RDMA storage node for the first RDMA request packet, refer to the embodiment shown in FIG. 9. A processing action of the second RDMA storage node for the second RDMA request packet is similar to the processing action of the first RDMA storage node. Specifically, the second RDMA storage node executes an RDMA instruction in the second RDMA request packet, finds a location, corresponding to the third destination address, in a memory, and stores data in the second RDMA request packet in the location, corresponding to the third destination address, in the memory.

For how the gateway device obtains the information about the second RDMA storage node, refer to the foregoing description of obtaining the information about the first storage node. A manner of querying the correspondence is used as an example. For example, the first correspondence not only includes the first destination address and the information about the first RDMA storage node, but also includes the information about the second RDMA storage node. Therefore, the gateway device can obtain the information about the second RDMA storage node after searching for the first correspondence.

The foregoing case in which information about two RDMA storage nodes is obtained based on one destination NVMe address, to write one copy of data to the two RDMA storage nodes is an example for description. A number of RDMA storage nodes that can be determined based on one destination NVMe address is not limited in embodiments. For example, in a scenario in which data is stored according to a multi-copy mechanism, a number of RDMA storage nodes that is determined based on one destination NVMe is optionally equal to a number of copies. For another example, in a scenario in which data is stored according to an erasure code (EC) mechanism, a number of RDMA storage nodes that is determined based on one destination NVMe is optionally equal to a sum of numbers of data blocks and parity blocks in one strip.

When data is written, when information about a plurality of RDMA storage nodes is obtained based on one destination NVMe address, there are a plurality of implementations about how the gateway device sends an RDMA write request packet to the plurality of RDMA storage nodes. The following uses two sending manners as an example for description.

Sending manner 1: The gateway device sends the RDMA write request packet to the plurality of RDMA storage nodes in a multicast mode.

There are plurality of implementations about the multicast mode that may be used by the gateway device. For example, the multicast mode includes but is not limited to bit index explicit replication (BIER), internet protocol version 6 (IPv6)-based BIER (BIERv6), an internet group management protocol (IGMP), protocol independent multicast (protocol independent multicast, PIM), a multicast source discovery protocol, a multicast border gateway protocol (MBGP), and the like. The multicast mode that is available only for the gateway device is not limited in embodiments.

When the multicast mode is used, both the first RDMA request packet and the second RDMA request packet are multicast packets. For example, the first RDMA request packet and the second RDMA request packet each include a multicast packet header encapsulated at an outer layer of an RDMA packet header. For example, the multicast packet header includes an identifier of a multicast group that the first RDMA storage node and the second RDMA storage node join. For another example, the multicast packet header includes a device identifier of the first RDMA storage node or the second RDMA storage node in a multicast domain. The multicast packet header includes but is not limited to a BIER header, a BIERv6 header, an IGMP header, a PIM header, and the like.

Sending manner 2: The gateway device sends the RDMA write request packet to each RDMA storage node in a unicast mode.

When the unicast mode is used, both the first RDMA request packet and the second RDMA request packet are unicast packets.

Optionally, when data is read, the gateway device supports sending a read request to one RDMA storage node in a plurality of candidate RDMA storage nodes, to support a load balancing feature, and allow the plurality of RDMA nodes to balance processing pressure caused by data reading. The following describes, by using examples, some possible implementations about how to implement load balancing.

That two RDMA storage nodes share the read request is used as an example. For example, in the method shown in FIG. 9, the first NOF request packet is an NOF read request packet, the first NOF request packet carries the NVMe read instruction, and the NVMe read instruction instructs to perform a read operation on the first destination address. The gateway device obtains the information about the first RDMA storage node and the information about the second RDMA storage node based on the first destination address. In this case, the gateway device selects an RDMA storage node from the first RDMA storage node and the second RDMA storage node according to a load balancing algorithm. When the RDMA storage node selected by the gateway device is the first RDMA storage node, the gateway device sends the first RDMA request packet to the first RDMA storage node. When the RDMA storage node selected by the gateway device is the second RDMA storage node, the steps that are described in the method shown in FIG. 9 and that are performed by the first RDMA storage node are performed by the second RDMA storage node.

There are a plurality of specific implementation about the load balancing algorithm used by the gateway device. For example, the load balancing algorithm is a consistent hashing algorithm. For another example, the load balancing algorithm is to select, from a plurality of RDMA storage nodes corresponding to the destination NVMe address, a storage node with a lowest data access frequency. A type of the load balancing algorithm used by the gateway device is not limited in embodiments.

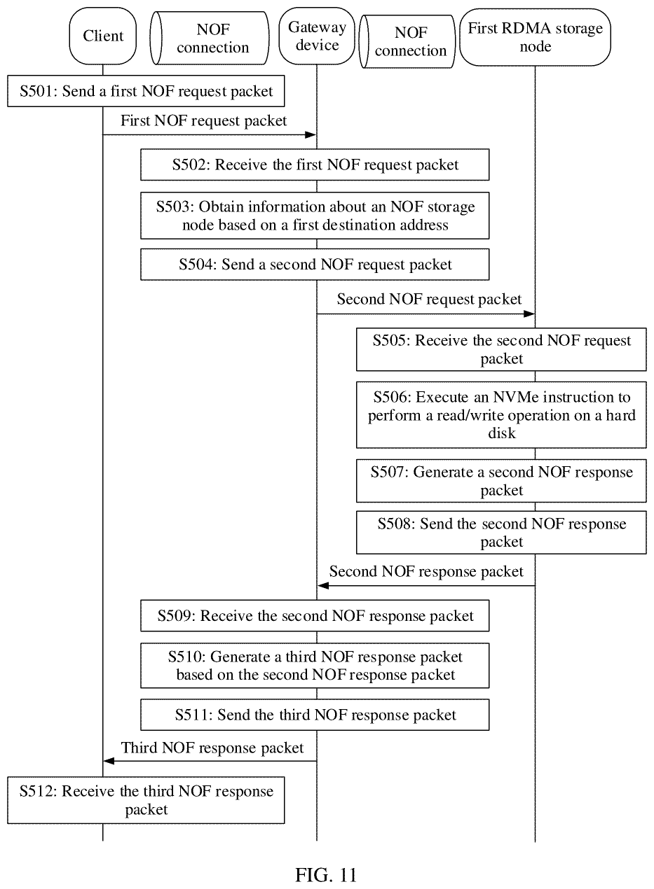

The foregoing embodiments focus on the procedure about how the gateway device interacts with the RDMA storage node according to the RDMA protocol. In some embodiments, the gateway device further supports interaction with the NOF storage node according to the NOF protocol. The following describes, by using an example, a procedure of interaction between the gateway device and the NOF storage node. For example, some data that the client requests to access is not stored in the RDMA storage node, but is stored in the NOF storage node. In this case, the gateway device obtains, by using the method corresponding to FIG. 11, the data that the client requests to access and that is stored in the NOF storage node. For another example, a current storage capacity of the RDMA storage node in the system is insufficient, and may not meet a data storage requirement of the client. In this case, the gateway device stores data of the client in a storage space of the NOF storage node by using the method corresponding to FIG. 11.

FIG. 11 is a flowchart of a packet processing method according to an embodiment of this application. The method shown in FIG. 11 includes step S501 to step S512 as follows.

S501: A client sends a first NOF request packet.

S502: A gateway device receives the first NOF request packet from the client.

S503: The gateway device obtains information about an NOF storage node based on a first destination address.

The gateway device obtains the first destination address from the first NOF request packet. The gateway device obtains information about a destination storage node based on the first destination address, to obtain the information about the NOF storage node.

An implementation about how the gateway device obtains the information about the NOF storage node is similar to the implementation of obtaining the information about the first RDMA storage node in the embodiment shown in FIG. 9. For example, information about a storage node is obtained by querying a correspondence. For example, for a first correspondence, a correspondence between the first destination address and information about a first RDMA storage node is replaced with a correspondence between the first destination address and the information about the NOF storage node. Therefore, the gateway device can obtain the information about the NOF storage node after searching for the correspondence.

In some embodiments, the gateway device modifies the first NOF request packet to obtain a second NOF request packet. For example, the first NOF request packet includes first NOF status information, and the gateway device modifies the first NOF status information into second NOF status information, to obtain the second NOF request packet including the second NOF status information.

The first NOF status information is status information exchanged between the client and the gateway device according to an NOF protocol. The second NOF status information is status information exchanged between the gateway device and the NOF storage node according to the NOF protocol.

S504: The gateway device sends the second NOF request packet to the NOF storage node.

The second NOF request packet includes an NVMe instruction, the first destination address, and the information about the NOF storage node.

S505: The NOF storage node receives the second NOF request packet.

S506: The NOF storage node executes the NVMe instruction to perform a read/write operation on a hard disk.

S507: The NOF storage node generates a second NOF response packet.

The second NOF response packet is a response packet for the second NOF request packet.

S508: The NOF storage node sends the second NOF response packet.

S509: The gateway device receives the second NOF response packet from the NOF storage node.

S510: The gateway device generates a third NOF response packet based on the second NOF response packet.

In some embodiments, the gateway device modifies the second NOF response packet to obtain the third NOF response packet. For example, the second NOF response packet includes third NOF status information, and the gateway device modifies the third NOF status information into fourth NOF status information, to obtain the third NOF response packet including the fourth NOF status information.

The third NOF status information is status information exchanged between the gateway device and the NOF storage node according to the NOF protocol. The fourth NOF status information is status information exchanged between the client and the gateway device according to the NOF protocol.

S511: The gateway device sends the third NOF response packet to the client.

The third NOF response packet is a response packet for the first NOF request packet.

S512: The client receives the third NOF response packet.

The gateway device supports an original NOF interaction procedure by performing the method provided in this embodiment, to keep compatible with an original NOF storage solution, and a large number of live-network devices do not need to be replaced.

At least some content in the embodiment corresponding to FIG. 9 and the embodiment corresponding to FIG. 11 may be combined with each other.

For example, in another possible implementation in which the two embodiments are combined, the gateway device selectively performs, through determining, one of the embodiment corresponding to FIG. 9 and the embodiment corresponding to FIG. 11. In a possible implementation, a correspondence on the gateway device includes a node type identifier, and the node type identifier identifies whether a storage node is an RDMA storage node or an NOF storage node. After receiving an NOF request, the gateway device determines whether a node type identifier corresponding to a destination NVMe address in the correspondence indicates an RDMA storage node or an NOF storage node. If the node type identifier indicates the RDMA storage node, the embodiment corresponding to FIG. 9 is performed. If the node type identifier indicates the NOF storage node, the embodiment corresponding to FIG. 11 is performed. In another possible implementation, after the gateway device obtains information about an RDMA storage node and information about an NOF storage node based on a destination address, the gateway device selects a storage node from the RDMA storage node and the NOF storage node as a responder of an NOF request packet according to a specified policy (such as load balancing, capacity balancing, or a QoS policy). If the gateway device selects the RDMA storage node, the embodiment corresponding to FIG. 9 is performed. If the gateway device selects the NOF storage node, the embodiment corresponding to FIG. 11 is performed.

For another example, in another possible implementation in which the two embodiments are combined, both the embodiment corresponding to FIG. 9 and the embodiment corresponding to FIG. 11 are performed. In other words, after receiving an NOF request packet from the client, the gateway device not only interacts with an RDMA storage node, but also interacts with an NOF storage node. In an example, in the RDMA storage node and the NOF storage node, one type of node is used as an active node, and the other type of node is used as a standby node. After receiving the NOF request packet from the client, the gateway device sends an RDMA request to the RDMA storage node, and sends an NOF request to the NOF storage node, to separately store data in a memory of the RDMA storage node and a hard disk of the NOF storage node.

The following describes the technical solution with reference to some specific application scenarios by using examples.

The following example is applied to a storage service of an IP-SAN storage area network (SAN).

A SAN is an architecture that connects a storage medium to a computer (such as a server) through a network. The SAN supports expansion of a storage medium that can be carried only on a single server to a plurality of servers through the network, thereby greatly improving a storage capacity and expansibility. The SAN is classified into a fiber channel-storage area network (FC-SAN) and an IP-SAN. A main difference between the FC-SAN and the IP-SAN is: in the FC-SAN, a storage medium and a server are connected through an FC network, in other words, data is transmitted between the storage medium and the server through the FC network; and in the IP-SAN, a storage medium and a computer are connected through an IP network, in other words, data is transmitted between the storage medium and the server through the IP network.

In various implementations of the IP-SAN, effect of establishing the IP-SAN storage network according to an NVMe instruction-based NOF protocol is good. Therefore, the following example is described by using an example in which improvement is made according to the NOF. A basic principle of establishing the IP-SAN storage network according to the NOF protocol is as follows: For an NVMe, in a hardware form, an NVMe subsystem (NOF storage node) is directly connected to a host through a PCIe bus, and a host bus adapter (HBA) is not needed in a path. This reduces system overheads. On the host side, the NVMe subsystem reduces an I/O scheduling layer and has an independent command layer, thereby shortening an I/O path and ensuring a low latency. In addition, an NVMe command queue may support a maximum of 64 K command queues, and each command queue supports a maximum of 64 K commands. In conclusion, the NVMe provides higher performance and efficiency. As expansion of the NVMe, the NOF inherits advantages of the NVMe. Therefore, the effect of establishing the IP-SAN storage network according to the NOF protocol is good.

In some other embodiments, a solution of the following example is applied to an instruction based on another type of storage protocol except for the NVMe, and a storage system based on the instruction. In this scenario, a part, related to the storage protocol, in the following example is modified. A specific implementation is similar to that in the following example.

The following example implements a gateway device, and the gateway device can replace a conventional network forwarding device. Based on implementation of layer-2 and layer-3 forwarding, the gateway device supports the following four functions.

### (1) Implementing an RDMA Protocol Stack

Because the gateway device provided in this example supports the RDMA protocol stack, the gateway device can establish a connection to an RDMA storage node and perform interaction according to the RDMA protocol.

### (2) Implementing an NOF Protocol Stack

The gateway device provided in this example implements the NOF protocol stack, and can act as a proxy for an NOF storage node to interact with the client.

### (3) Implementing Mutual Packet Conversion Between the Two Storage Protocols: The NOF and the RDMA

The gateway device provided in this embodiment is deployed, so that an RDMA storage Node can be Expanded in an NOF Storage Network.

(4) Implementing Mutual Conversion Between Logical Addresses Corresponding to the Two storage protocols: the NOF and the RDMA

The gateway device stores an address translation table. After a destination NVMe address for an NOF operation is parsed out, the destination NVMe address can be translated into an RDMA address based on the address translation table. In addition, the gateway device converts an NVMe instruction into an RDMA instruction, to convert a conventional operation on a destination NVMe hard disk based on the NOF into an operation directed to a memory of an RDMA node.

The following example can improve performance and capacity expansion flexibility of a conventional NOF storage solution.

Compared with the conventional NOF solution, for the client, the solution of the following example is compatible with the original solution. The client does not need to be improved, and does not need to sense a change of a storage node. The client can use a storage service provided by an NOF storage node, and can also use a storage service provided by an RDMA storage node with better performance. For the storage node, the gateway device offloads an address management task of the storage node, and takes over a back-end expansion function of a storage server. The gateway device can process an NOF request, and perform directing to a destination storage node based on a destination NVMe address in the NOF request, and the storage node does not need to expand the back-end NOF. This reduces CPU pressure and network I/O pressure of the storage node.

The following describes, by using an example, a system architecture to which the following example is applied.

The following example implements a gateway device. An RDMA storage node does not need to establish a logical connection to the client, but establishes a logical connection to the gateway device.

The gateway device is equivalent to a general entry of storage resources. The gateway device manages storage spaces of both an NOF storage node and an RDMA storage node. In addition, the gateway device can map a destination address in an NOF request of the client to an address of a memory space of the RDMA node, so that an original full-path NOF storage service supports both an NOF storage service and an RDMA storage service with better performance.

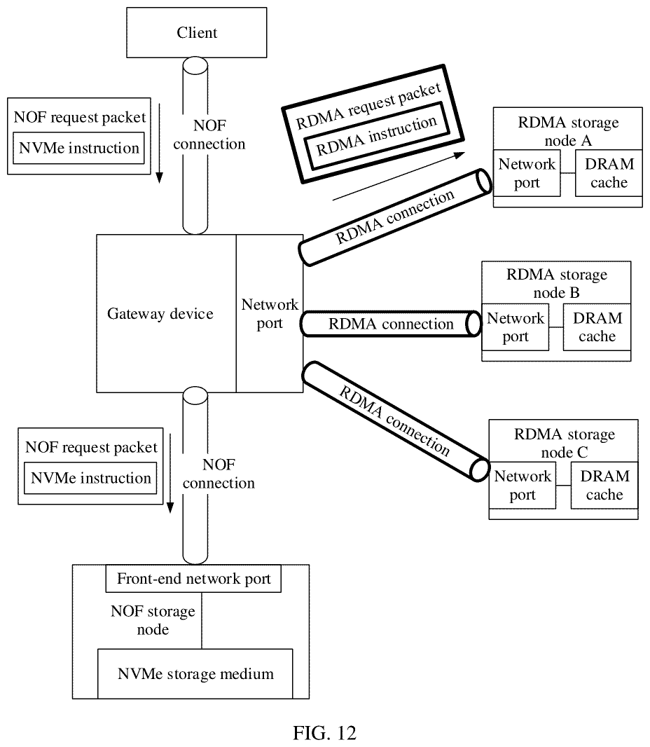

FIG. 12 is a schematic diagram of an architecture of a storage system after a gateway device is deployed according to an embodiment of this application. FIG. 12 is described by using an example in which a memory accessed based on an RDMA is a DRAM cache. In FIG. 12, different types of lines are used to distinguish and identify an NOF-related feature from an RDMA-related feature.

The storage system shown in FIG. 12 includes a client, a gateway device, an NOF storage node, an RDMA storage node A, an RDMA storage node B, and an RDMA storage node C. The NOF storage node includes an NVMe storage medium. Each of the RDMA storage node A, the RDMA storage node B, and the RDMA storage node C includes a DRAM cache.

As shown in FIG. 12, the gateway device is deployed between the client and the storage nodes. The gateway device establishes an NOF connection to the client according to the NOF protocol. In addition, the gateway device establishes an RDMA connection to the RDMA storage node A, the RDMA storage node B, and the RDMA storage node C according to the RDMA protocol. In addition, the gateway device establishes an NOF connection to the NOF storage node according to the NOF protocol.

As shown in FIG. 12, after the client sends an NOF request packet through the NOF connection, the NOF request packet reaches the gateway device. After receiving the NOF request packet, the gateway device determines whether a storage node, corresponding to a destination address in an NVMe instruction in the NOF request packet, in a locally stored correspondence, is an NOF storage node or an RDMA storage node. If the storage node corresponding to the destination address is the RDMA storage node, the gateway device converts the NOF request packet into an RDMA request packet including an RDMA instruction, and sends the RDMA request packet to the RDMA storage node corresponding to the destination address, so that the RDMA storage node performs a read/write operation on the DRAM cache in an RDMA manner. For example, if the storage node corresponding to the destination address is the RDMA storage node A in FIG. 12, the gateway device sends the RDMA request packet to the RDMA storage node A. If the storage node corresponding to the destination address is the NOF storage node, the gateway device does not need to perform a step of protocol packet conversion, and sends the NOF request packet to the NOF storage node, so that the NOF storage node performs a read/write operation on the NVMe storage medium.

That a memory medium in the RDMA storage node is a DRAM cache is an optional manner. In some other embodiments, the RDMA storage node uses another type of memory medium, for example, an SCM, an SRAM, a DIMM, or a memory hard disk. A type of the memory medium in the RDMA storage node is not limited in embodiments.

FIG. 12 is a simplified schematic diagram. Other hardware elements such as a processor are omitted and not shown in FIG. 12, and a hardware structure of a device is specifically described in another embodiment.

According to the gateway device and the method procedure provided in this embodiment, when capacity expansion is needed, an original capacity expansion solution is optionally used, or an RDMA storage node is added. The newly added RDMA storage node establishes a connection to the gateway device. An address correspondence of the newly added RDMA storage node is added to an address mapping table of the gateway device. Because a memory space accessed based on an RDMA is used to provide an expanded storage capacity, performance is better. In addition, this capacity expansion manner has advantages of NOF-based horizontal capacity expansion and vertical capacity expansion.

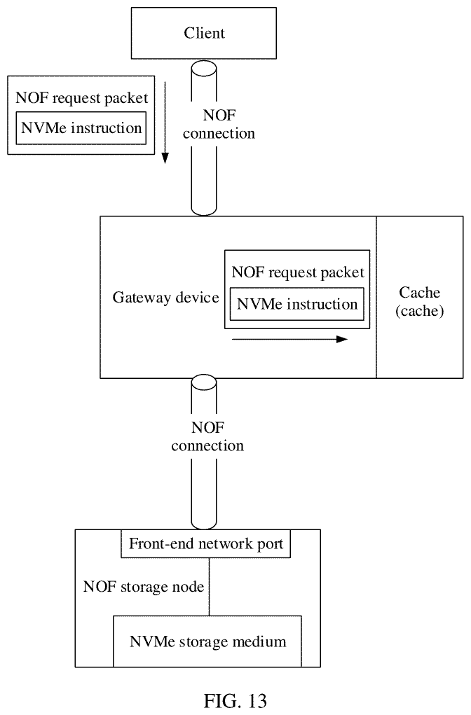

Optionally, if a cache of the gateway device has a sufficient storage space, the gateway device serves as a storage node to provide a storage service for the client. In this scenario, the NOF request packet is terminated on the gateway device, the gateway device operates the cache to perform a data read/write operation, and the gateway device constructs an NOF response packet to interact with the client. FIG. 13 is a schematic diagram of a scenario in which the gateway device serves as a storage node. As shown in FIG. 13, the gateway device locally executes an NVMe instruction in the NOF request packet, performs the data read/write operation on the cache of the gateway device, and does not need to forward the request packet to a storage node.

Some embodiments provided in this application implement a gateway device. The gateway device can support layer-2 and layer-3 forwarding of a conventional ethernet, and provides the following functions on this basis.

(1) Processing an NOF protocol stack and an RDMA protocol stack.

The gateway device can process the RDMA protocol stack, to implement a connection and interaction between the gateway device and an RDMA storage node. The gateway device can process the NOF protocol stack, parse information about the NOF protocol stack, and maintain status information of the NOF protocol stack, thereby implementing a proxy function of returning an NOF packet to the client.

(2) NOF and RDMA protocol logic conversion mechanism

On the basis of implementing the NOF protocol stack and the RDMA protocol stack, the gateway device implements NOF-RDMA packet conversion and RDMA-NOF packet conversion based on information about current interaction of the NOF packet and the RDMA packet and known status information of previous interaction. Specifically, an NOF request packet is converted into an RDMA request packet, and an RDMA response packet is converted into an NOF response packet.

(3) Address translation table in an NOF-RDMA direction

This embodiment provides the address translation table in the NOF-RDMA direction. The address translation table is deployed on the gateway device. The address translation table implements mapping from an NVMe destination logical address in the NOF to an RDMA destination logical address. In a procedure of converting an NOF request packet into an RDMA request packet, the gateway device parses a destination address in an NVMe instruction in the NOF packet, finds a memory address of a corresponding RDMA node and other information by searching for the address translation table, and constructs the RDMA packet based on a table lookup result.

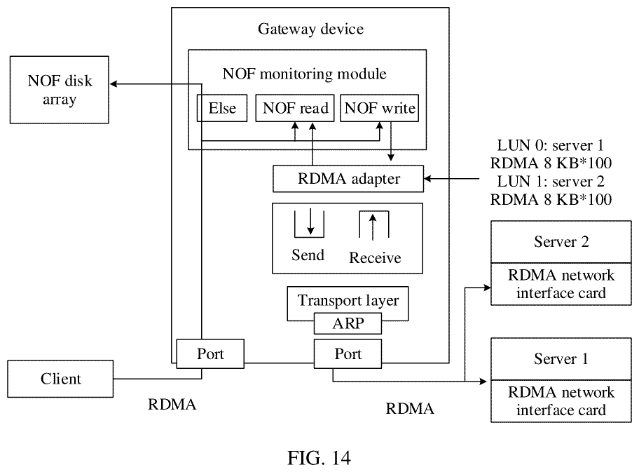

A logical combination of the foregoing functions in the gateway device is shown in FIG. 14.

Both a server 1 and a server 2 in FIG. 14 are examples of RDMA storage nodes. The server 1 and the server 2 each are configured with an RDMA network interface card. An RDMA storage node server 1 registers a memory space with a length of 8 KB*100 for an RDMA read/write operation, and a logical storage address corresponding to the memory space of the RDMA storage node server 1 is an LUN 0. An RDMA storage node server 2 registers a memory space with a length of 8 KB*100 for an RDMA read/write operation, and a logical storage address corresponding to the memory space of the RDMA storage node server 2 is an LUN 1. A disk array in FIG. 14 is an example of an NOF storage node.

A gateway device shown in FIG. 14 includes an NOF monitoring module, an RDMA adapter, and a plurality of ports.

The NOF monitoring module is configured to identify an NOF packet. After the NOF monitoring module receives the NOF packet, if the NOF monitoring module identifies that a destination storage node of the NOF packet is an NOF disk array, the NOF monitoring module forwards the NOF packet to the NOF disk array; or if the NOF monitoring module identifies that a destination storage node of the NOF packet is an RDMA storage node, the NOF packet is sent to the RDMA adapter, and the RDMA adapter converts the NOF packet into an RMDA packet and sends the RDMA packet to an RDMA node. In addition, the RDMA adapter further processes an RDMA response packet sent by the RDMA node, converts the RDMA response packet into an NOF response packet, and sends the NOF response packet to a client.

As shown in FIG. 14, an RDMA memory space provided by the server 1 includes 100 pages whose sizes are 8 KB. An RDMA memory space provided by the server 2 includes 100 pages whose sizes are 8 KB.

The gateway device virtualizes the RDMA memory space provided by the server 1 into an LUN 0, and virtualizes the RDMA memory space provided by the server 2 into an LUN 1. The LUN 0 and the LUN 1 are presented to the client as an available storage space. After the client sends an NOF request packet, the RDMA adapter in the gateway device parses a destination NVMe address in the NOF request packet. If an LUN ID in the destination NVMe address is an LUN 0, the RDMA adapter converts the NOF request packet into an RDMA request packet to be sent to the server 1. If an LUN ID in the destination NVMe address is an LUN 1, the RDMA adapter converts the NOF request packet into an RDMA request packet to be sent to the server 2.

The NOF monitoring module corresponds to a part of logic, an address translation table, and an NOF proxy packet sending module in a packet parsing module in the following example. The RDMA adapter is a module configured to perform NOF-RDMA logic conversion. The RDMA adapter corresponds to a module used for NOF-RDMA logic conversion in the following example, for example, an NOF context table in an example 1 and additional packet information processing in an example 2.

In FIG. 14, a dedicated gateway device is selected to implement the gateway device in this embodiment, to improve packet forwarding performance. That the dedicated gateway device is used to implement the foregoing functions is not limited in embodiments. In some other embodiments, a server, a conventional network device, an FPGA device, or the like is used as a gateway device to implement the foregoing functions.

The following describes, by using some examples, a method procedure performed by a gateway device.

In the following example, a two-sided RDMA operation is used in a pre-connection process and a configuration process. A pre-connection is a process of establishing a connection between nodes. The configuration process is mainly a process in which a storage node reports an address of a memory space and information about the node. In the following example, a one-sided RDMA operation is used in an actual data access process.

In the following example, the gateway device performs special processing on a read operation or a write operation of the one-sided operation to improve performance. Optionally, no special processing is performed on the two-sided operation of the gateway device. The gateway device performs normal parsing according to a specification. When an RDMA storage node reports an address of a memory space through the two-sided operation, after the gateway device obtains, through parsing, the address of the memory space, optionally, the gateway device notifies an NOF storage node of the address of the memory space. The NOF storage node performs unified address orchestration on addresses of memory spaces of RDMA storage nodes and addresses of hard disk spaces of NVMe storage nodes, to obtain an NVMe logical address, and then configures the NVMe logical address in the gateway device. Alternatively, if the gateway device performs unified address orchestration, the gateway device does not need to report the address of the memory space to the NOF storage node, and the gateway device directly manages and controls addresses of all memory spaces and addresses of all hard disk spaces.

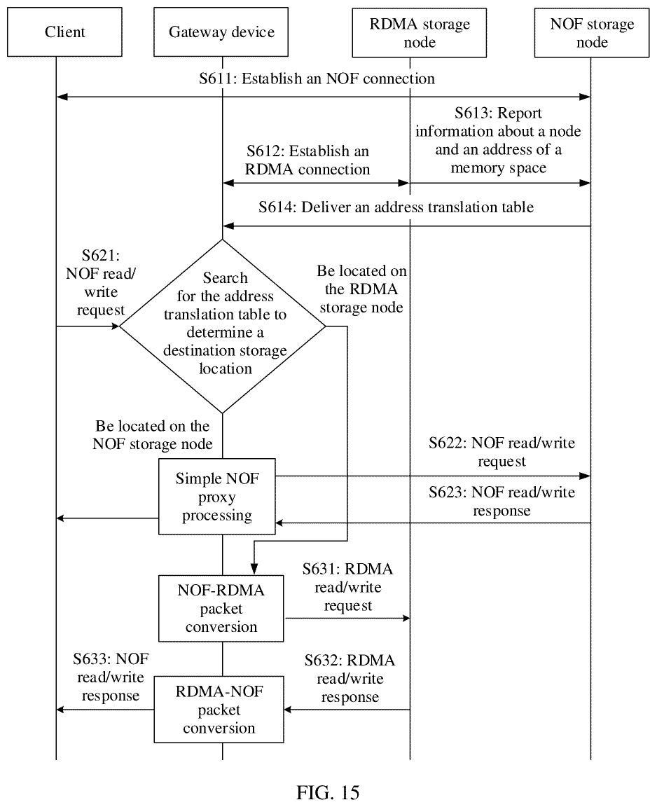

FIG. 15 is a flowchart according to an embodiment of this application. FIG. 15 mainly shows a procedure of implementing an NOF protocol proxy by the gateway device and a procedure of implementing NOF-RDMA protocol packet conversion. The procedure shown in FIG. 15 includes S61 to S63 as follows.

S61: Pre-connection and configuration phase.

S61 includes S611 to S614:

S611: A client establishes an NOF connection to an NOF storage node.

S612: The gateway device establishes an RDMA connection to an RDMA storage node.

S613: The RDMA storage node reports information about the node and an address of a memory space to the NOF storage node.

S614: The NOF storage node receives the node information and the address of the memory space that are sent by the RDMA storage node. The NOF storage node performs unified address orchestration and delivers an address translation table to the gateway device.

In the foregoing procedure, performing address orchestration by the NOF storage node is an optional implementation. In some other embodiments, the gateway device performs address orchestration.

The foregoing procedure is an initialization process. If an RDMA storage node needs to be added in a running process of a storage system, the newly added RDMA storage node may be added to the entire storage system by repeatedly performing S612, S613, and S614.

S62: NOF protocol proxy procedure

As shown in S621 in FIG. 15, the client sends an NOF request packet. The NOF request packet is an NOF read request packet or an NOF write request packet. The gateway device receives the NOF request packet from the client. The gateway device parses the NOF request packet to obtain a destination storage address in an NVMe instruction in the packet. The gateway device searches for the address translation table in the gateway device based on the destination storage address, to obtain information about a destination storage node. If the destination storage address is located in the NOF storage node, the following S622 and S623 are performed.

S622: The gateway device performs simple proxy processing on the NOF request packet, and sends the processed NOF request packet to the NOF storage node.

S623: The NOF storage node receives the NOF request packet. The NOF storage node sends a corresponding NOF response packet for the NOF request packet.

The gateway device receives the NOF response packet. The gateway device performs simple proxy processing on the NOF response packet, and sends the processed NOF response packet to the client.

When the NOF request packet is the NOF read request packet, the NOF response packet is an NOF read response packet. When the NOF request packet is the NOF write request packet, the NOF response packet is an NOF write response packet.

S63: NOF-RDMA packet conversion procedure

If the gateway device searches for the address translation table in the gateway device, to obtain the destination storage address located in the RDMA storage node, the gateway device performs the following S631 to S633.

S631: The gateway device encapsulates a one-sided RDMA operation request packet based on NOF-RDMA conversion logic and information about a destination RDMA node. The gateway device sends the one-sided RDMA operation request packet to the RDMA storage node.

When the NOF request packet sent by the client is the NOF read request packet, the RDMA request packet sent by the gateway device is an RDMA read request packet. When the NOF request packet sent by the client is the NOF write request packet, the RDMA request packet sent by the gateway device is an RDMA write request packet.

S632: The RDMA storage node receives the one-sided RDMA operation request packet from the gateway device. The RDMA storage node executes an RDMA instruction based on the one-sided RDMA operation request packet, and generates and sends a one-sided RDMA operation response packet. After the gateway device obtains the one-sided RDMA operation response packet from the RDMA storage node, the gateway device converts the one-sided RDMA operation response packet into an NOF response packet based on RDMA-NOF conversion logic.

When the one-sided RDMA operation response packet sent by the RDMA storage node is an RDMA read response packet, the NOF response packet converted by the gateway device is an NOF read response packet. When the one-sided RDMA operation response packet sent by the RDMA storage node is an RDMA write response packet, the NOF response packet converted by the gateway device is an NOF write response packet.

S633: The gateway device sends the NOF response packet to the client.

### Example 1

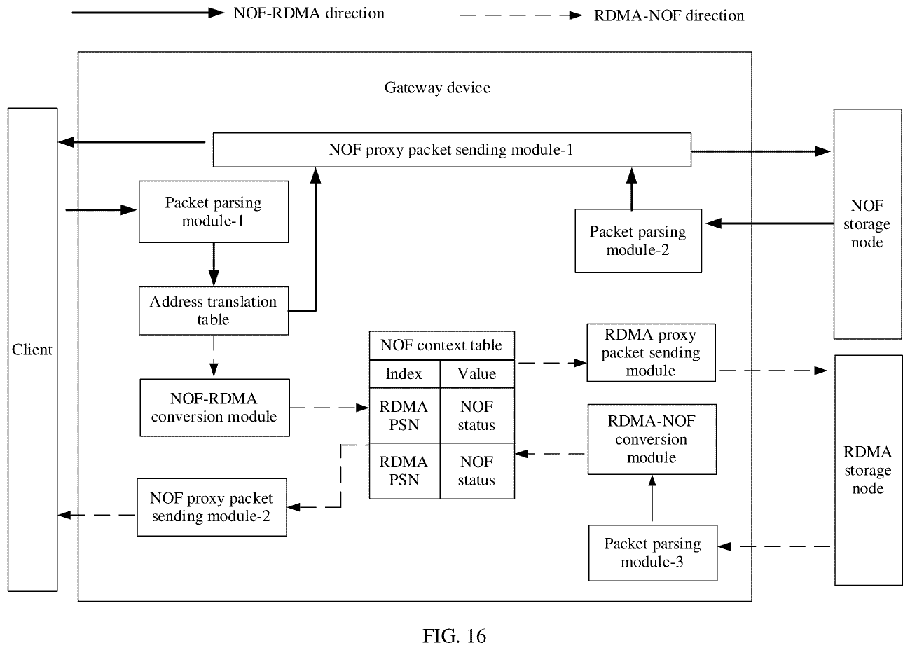

FIG. 16 is a schematic diagram of an internal logical function architecture of the gateway device. The example 1 is an implementation of an inside of the gateway device. The gateway device implements an NOF-RDMA protocol packet conversion function. When the NOF request packet of the client reaches the gateway device, the gateway device parses the NVMe instruction carried in the NOF request packet. The gateway device determines the destination storage node based on the address translation table and the destination storage address in the NVMe instruction. There are two cases about the destination storage node:

In a case (1), the destination storage node is an NOF storage node.

When the destination storage node is the NOF storage node, the gateway device maintains an original NOF interaction procedure by performing a simple NOF protocol proxy operation.

In a case (2), the destination storage node is an RDMA storage node.

When the destination storage node is the RDMA storage node, the gateway device converts the NVMe instruction into an RDMA instruction. During instruction conversion, the gateway device stores NOF status information (the NOF status information is referred to as NOF context in this embodiment of this application) to an NOF context table. Then, the gateway device encapsulates a corresponding RDMA request according to the converted RDMA instruction. The gateway device sends the RDMA request to a corresponding RDMA storage node.

After the RDMA storage node returns an RDMA response packet, the gateway device implements RDMA-NOF conversion, and the gateway device restores the NOF status information based on content in the NOF context table. The gateway device encapsulates the NOF response packet based on the NOF status information and sends the NOF response packet to the client.

As shown in FIG. 16, modules in the gateway device mainly include a packet parsing module, an address translation table, an NOF proxy packet sending module, an NOF and RDMA packet conversion module, an NOF context table, and an RDMA proxy packet sending module.

There are modules with a same name in FIG. 16, for example, a packet parsing module-1 and a packet parsing module-2. The modules with the same name have same or similar processing logic. To simplify an entire procedure, the modules with the same name are numbered with suffixes to be dispersed at different positions in the procedure. The modules are not specially distinguished in the following descriptions.

### Packet Parsing Module

The packet parsing module is configured to parse a packet, and extract a protocol type and packet content from an NOF packet and an RDMA packet. The packet parsing module provides the following specific functions (1) to (5).

### (1) Packet Parsing and Classification

The packet parsing module parses transport layer information in the packet. The packet parsing module determines whether the packet is an NOF packet or an RDMA packet based on a port number in the transport layer information in the packet. If the packet is the NOF packet or the RDMA packet, the packet parsing module sends the packet to a subsequent corresponding protocol stack (namely, an NOF protocol stack or an RDMA protocol stack), so that the subsequent protocol stack continues to parse the packet. If the packet is not the NOF packet or the RDMA packet, the packet parsing module directly forwards the packet based on original forwarding logic without special processing.

According to protocol specifications, the NOF packet and the RDMA packet each include a UDP header. A destination port number in the UDP header is 4791. An upper layer of a UDP layer in the protocol stack is an IB layer. Whether the packet is the RDMA packet or the NOF packet can be determined based on operation code (OPcode) specified at the IB layer and operation code at an upper layer of the IB layer. Optionally, the NOF packet and the RDMA packet enter the gateway device through different inbound interfaces, and the gateway device determines, based on an inbound interface of the packet and the port number in the packet, whether the packet is the RDMA packet or the NOF packet.

### (2) NOF Protocol Stack Parsing

The packet parsing module parses the NOF packet, where the parsed NOF packet includes a request packet in a direction from the client to a storage node and a response packet in a direction from the storage node to a host. The packet parsing module parses fabric information and an NVMe instruction in the NOF packet. Optionally, the fabric information is RoCEv2 information. For example, the fabric information includes MAC layer information, IP layer information, UDP layer information, and IB layer information.

### (3) RDMA Protocol Stack Parsing

The packet parsing module parses the RDMA packet. The parsed RDMA packet is a response packet in a direction from the storage node to the client.

The packet parsing module parses information about an RDMA field in the RDMA packet.

### (4) Information Extraction

The packet parsing module extracts the information that is carried in fields and that is parsed by protocols in (2) and (3), and caches the information for subsequent modules to use.

### (5) Output

After the packet parsing module parses the packet, the packet parsing module outputs the NOF packet or the RDMA packet to a subsequent corresponding processing module. Another packet except for the NOF packet and the RDMA packet is not specially processed and is forwarded based on normal logic.

### Address Translation Table

The address translation table indicates a correspondence between a destination NVMe address and information about the destination storage node. The address translation table records actual node information corresponding to the destination storage address in the NVMe instruction in the NOF protocol. The following describes the address translation table in detail. For details, refer to (1) to (5) as follows.

### (1) Format of the Address Translation Table

In the address translation table, a destination NVMe logical address is an index, and the information about the destination storage node is a value.

The destination NVMe logical address in the protocol includes content of a start LBA field, content of a block number field, and a block size included in an attribute of the connection.

The information about the destination storage node includes network location information (such as layer-2 and layer-3 information) of the storage node and a DQP (a logical connection of the RDMA storage node or the NOF storage node is determined based on the DQP). The layer-2 and layer-3 information is used to determine a physical channel, and the layer-2 and layer-3 information is used to find a specific device (namely, a storage node). The layer-2 information is, for example, a MAC address, and the layer-3 information is, for example, an IP address.

If the destination storage node is an RDMA storage node, the address translation table further includes RETH information corresponding to the RDMA storage node (namely, a segment of registered memory addresses reported by the RDMA storage node).

### (2) Function of the Address Translation Table

After the NOF packet is parsed, the gateway device queries the address translation table based on the destination NVMe address in the NVMe instruction, to obtain the information about the destination storage node corresponding to the destination NVMe address in the address translation table.

The gateway device can determine, based on the information about the destination storage node, whether the destination storage node is an NOF node or an RDMA node, to enter subsequent different processing logic. The gateway device can further determine a logical connection to the destination storage node and a logical address of a storage space in the destination storage node based on the information about the destination storage node. A logical address of a hard disk space of the NOF node does not need to be mapped, and a logical address of a memory space of the RDMA node is mapped to an RETH in the address translation table.

Optionally, each entry in the address translation table further includes a flag bit, and the flag bit identifies whether the destination storage node is the NOF node or the RDMA node. The gateway device determines, based on a value of the flag bit corresponding to the destination NVMe address, whether the destination storage node is the NOF node or the RDMA node.

### (3) Supporting a Multi-Channel RDMA by the Address Translation Table

RDMA connections of two nodes are optionally distinguished based on different QPs. Each channel of RDMA manages its own resources. The address translation table stores information of QP mapping between the destination storage address and each RDMA storage node, to support RDMA multi-access.

The RDMA multi-access means supporting accessing one RDMA node through a plurality of logical channels. One RDMA node has a plurality of QP pairs, and each QP pair is a logical channel. Different QPs of a same RDMA storage node in the address translation table correspond to different entries. Therefore, the different QPs of the same RDMA storage node can be distinguished based on the address translation table, to support accessing the RDMA node through different logical channels. Because a plurality of channels have higher performance and availability than a single channel, the multi-channel RDMA is supported based on the address translation table. This can improve performance and availability.

### (4) Supporting Load Balancing and Hot Standby by the Address Translation Table

The address translation table can map a specific destination logical address to a plurality of RDMA storage nodes.

When an NOF request is a write request, after the gateway device finds a plurality of RDMA storage nodes based on the address translation table, the gateway device sends an RDMA write request to each found RDMA node, to synchronously write data to the plurality of RDMA storage nodes. Optionally, the gateway device sends the RDMA write request according to a multicast mechanism, that is, the RDMA write request is multicast to the plurality of RDMA service nodes.

When an NOF request is a read request, after the gateway device finds a plurality of RDMA storage nodes based on the address translation table, the gateway device randomly selects one RDMA storage node from the plurality of found RDMA storage nodes according to a consistent hashing algorithm or another load balancing algorithm, and the gateway device sends an RDMA read request to the selected RDMA storage node, thereby improving system performance and stability. The specifically applied load balancing algorithm is determined based on a service and a device capability.

### (5) Output Result of the Address Translation Table

The gateway device determines, based on the information about the destination storage node obtained by querying the address translation table, whether the destination storage node is an NOF storage node or an RDMA storage node.

If the destination storage node is the NOF storage node, the gateway device obtains network location information and logical connection information of the NOF node, and subsequently performs processing by using an NOF proxy module.

If the destination storage node is the RDMA storage node, the gateway device obtains network location information, logical connection information, and a destination memory address of the RDMA node, and subsequently performs processing by using the NOF-RDMA packet conversion module.

For example, the address translation table is shown as Table 2 below.

TABLE 2
Address translation table

| | | | Information about the | | |
|---|---|---|---|---|---|
| Destination | | | destination storage node | | |
| NVMe address | | | Network location | Identifier | Memory |
| Start | Block | Block | information of the | of a QP | address |
| LBA | size | number | destination storage node | (DQP) | (RETH) |
| 0x0000 | 512 | 32 | IP address of an | QP 1 | RETH 1 |
| 0x4000 | 512 | 32 | RDMA server 1 | QP 1 | RETH 2 |
| 0x8000 | 512 | 64 | | QP 2 | RETH 3 |
| 0x10000 | 512 | 128 | MAC address of an | QP 10 | RETH 4 |
| | | | RDMA server 2 | | |
| | | | MPLS label of an | QP 20 | RETH 5 |
| | | | RDMA server 3 | | |
| 0x20000 | 512 | 128 | IP address of an NOF | QP 1 | NA |
| | | | server 1 | | |

In the address translation table shown as Table 2, the destination NVMe address is an index or a key used for table lookup, and the information about the destination storage node is a query result obtained through table lookup or a value corresponding to the key. In Table 2, the identifier of the QP is simplified and represented in a form of “QP+number”. In Table 2, specific content of an RETH is simplified and represented in a form of “RETH+number”, namely, an address of a segment of memory space in a server.

The destination NVMe address shown in Table 2 includes three attributes: the start LBA, the block size, and the block number.

When in the destination NVMe address, the start LBA is 0x0000, the block size is 512, and the block number is 32, a logical address range represented by the destination NVMe address is 0x0000 to 0x3FFF, and the information about the destination storage node found based on the destination NVMe address is the information about the RDMA server 1, for example, includes the IP address of the RDMA server 1, the QP 1, and the RETH 1.

When in the destination NVMe address, the start LBA is 0x4000, the block size is 512, and the block number is 32, a logical address range represented by the destination NVMe address is 0x4000 to 0x7FFF, and the information about the destination storage node found based on the destination NVMe address is the information about the RDMA server 1, for example, includes the IP address of the RDMA server 1, the QP 1, and the RETH 2.

When in the destination NVMe address, the start LBA is 0x8000, the block size is 512, and the block number is 64, a logical address range represented by the destination NVMe address is 0x8000 to 0xFFFF, and the information about the destination storage node found based on the destination NVMe address is the information about the RDMA server 1, for example, includes the IP address of the RDMA server 1, the QP 2, and the RETH 3.

The RDMA server 1 includes two queue pairs corresponding to the QP 1 and the QP 2. A queue pair identified by the QP 1 is corresponding to a memory space identified by an RETH 1 in the RDMA server 1, and a queue pair identified by the QP 2 is corresponding to a memory space identified by an RETH 2 in the RDMA server 1.

When in the destination NVMe address, the start LBA is 0x10000, the block size is 512, and the block number is 128, a logical address range represented by the destination NVMe address is 0x10000 to 00x1FFFF and 0x20000 to 0x2FFFF, and the information about the destination storage node found based on the destination NVMe address is information about the RDMA server 2 and information about the RDMA server 3, for example, includes the MAC address of the RDMA server 2, the QP 10, the RETH 4, the MPLS label of the RDMA server 3, the QP 20, and the RETH 5. The RDMA server 2 and the RDMA server 3 have a load balancing relationship.

When in the destination NVMe address, the start LBA is 0x20000, the block size is 512, and the block number is 128, it indicates that the logical address range is 0x0000 to 0x3FFF, and the information about the destination storage node found based on the destination NVMe address is information about the NOF server 1. In this case, an NOF storage service is provided.

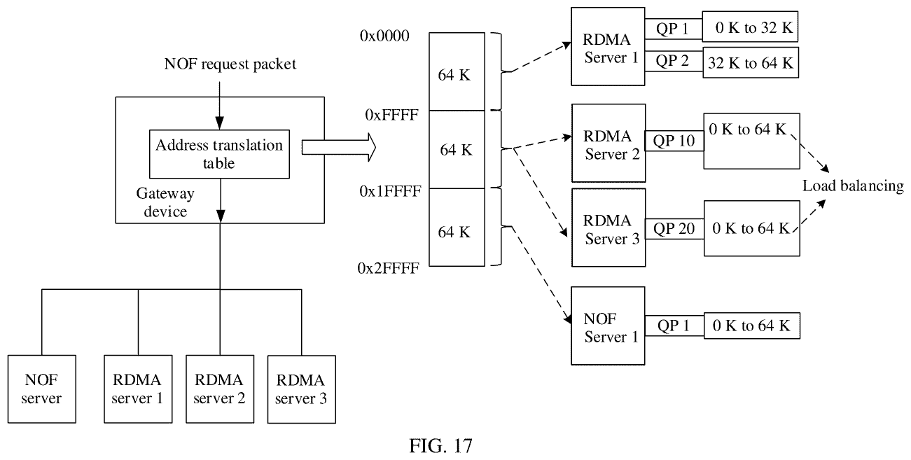

The following describes, by using an example, an address translation table with reference to FIG. 17.

Content of the address translation table shown in FIG. 17 is shown in Table 2. FIG. 17 shows that there are three logical address segments with a length of 64 KB in the address translation table. The first logical address segment with the length of 64 KB in the address translation table is from an address 0x0000 to an address 0xFFFF. A destination storage node corresponding to the first address segment is the RDMA server 1. The first address segment in the address translation table corresponds to identifiers of two QPs (a QP 1 and a QP 2 in FIG. 17) in the RDMA server 1, and the two logical channels QP 1 and QP 2 respectively correspond to two memory address segments of the RDMA server 1. The second logical address segment with the length of 64 KB in the address translation table is from the address 0xFFFF to an address 0x1FFFF. Destination storage nodes corresponding to the second logical address segment are two RDMA nodes: the RDMA server 2 and the RDMA server 3. The RDMA server 2 and the RDMA server 3 store same data, to indicate that redundancy backup and load balancing can be implemented on one logical address segment. The third logical address segment with the length of 64 KB in the address translation table is from the address 0x1FFFF to an address 0x2FFFF. A destination storage node corresponding to the third logical address segment in the address translation table is the NOF server 1, to indicate that an NOF node compatible with an original NOF network.

### NOF Proxy Packet Sending Module

The NOF proxy packet sending module is configured to take over an original NOF packet forwarding procedure, and modify or construct the NOF packet based on an NOF connection state and NOF proxy logic. The NOF proxy packet sending module provides the following specific functions (1) to (3).

### (1) NOF Protocol Stack Proxy

The NOF protocol stack proxy is similar to an NOF protocol stack of the packet parsing module. The NOF protocol stack of the packet parsing module is mainly responsible for parsing a packet, and an NOF protocol stack of the NOF proxy packet sending module is mainly responsible for processing an NOF packet proxy. The NOF packet proxy provides functions of maintaining the NOF protocol connection state, and modifying or constructing the NOF packet.

### (2) Modification or Construction of the NOF Packet

Because the gateway device performs proxy processing on the NOF packet, information above a network layer in the NOF packet changes. The gateway device does not directly forward the received NOF packet. Therefore, the NOF proxy packet sending module needs to modify the NOF packet or construct the NOF packet based on the NOF connection state.

After the gateway device receives the NOF request packet of the client, the gateway device modifies the NOF request packet, and sends a modified NOF request packet to the NOF storage node. After the gateway device receives the NOF response packet of the NOF storage node, the gateway device modifies the NOF response packet, and sends a modified NOF response packet to the client.

After receiving the RDMA response packet of the RDMA storage node, the gateway device constructs the NOF response packet, and sends the NOF response packet to the client.

### (3) Output

An output result of the NOF proxy packet sending module is an NOF response packet sent to the client or an NOF request packet sent to the NOF storage node.

The NOF and RDMA packet conversion module is configured to perform mutual conversion between an NOF protocol packet and an RDMA protocol packet. The NOF and RDMA packet conversion module includes two submodules: an NOF-RDMA conversion module and an RDMA-NOF conversion module. The following describes the NOF and RDMA packet conversion module in detail. Refer to (1) to (3) as follows.

### (1) NOF-RDMA Conversion Module

The NOF-RDMA conversion module is configured to implement conversion from the NOF protocol packet to the RDMA protocol packet. Specifically, after a destination RDMA storage node is determined from the NOF request packet based on the address translation table, the NOF request packet enters the NOF-RDMA conversion module. In this case, the NVMe instruction in the NOF protocol has been parsed out. The NOF-RDMA conversion module processes the NOF request packet of the client to obtain the RDMA request packet.

The NOF-RDMA conversion module obtains RDMA status information based on parameters such as an address and a QP of the destination RDMA storage node, and subsequently uses the RDMA status information obtained herein. The parameters such as the address and the QP of the destination RDMA storage node are obtained, for example, based on the address translation table. The RDMA status information is obtained, for example, by using the RDMA proxy packet sending module.

The NOF-RDMA conversion module converts the NVMe instruction into the RDMA instruction. An NVMe read operation is converted into an RDMA read operation, and an NVMe write operation is converted into an RDMA write operation. The NOF-RDMA conversion module pre-pads an RDMA protocol-based fixed field in the RDMA request packet according to an RDMA protocol standard. A module following the NOF-RDMA conversion module supplements RDMA protocol information that needs to be carried in the RDMA request packet, and sends a RDMA request packet including complete RDMA protocol information to the RDMA proxy packet sending module.

### (2) RDMA-NOF Conversion Module

The RDMA-NOF conversion module is configured to implement RDMA-NOF protocol packet conversion. Specifically, after being processed by the packet parsing module, the RDMA response packet returned by the RDMA storage node enters the RDMA-NOF conversion module. In this case, information, in the RDMA protocol, carried in the packet has been parsed out. The RDMA-NOF conversion module converts the information in the RDMA protocol into information in the NOF protocol.

When receiving an RDMA read response packet, the RDMA-NOF conversion module parses out data and a PSN from the RDMA read response packet, and the RDMA-NOF conversion module converts the RDMA read response packet into an NOF read response packet or constructs an NOF read response packet based on the PSN and the data.

When receiving an RDMA write response packet, the RDMA-NOF conversion module parses out a PSN from the RDMA write response packet, and converts the RDMA write response packet into an NOF write response packet or constructs an NOF write response packet based on the PSN.

The RDMA-NOF conversion module pre-pads an NOF protocol-based fixed field in the NOF response packet according to an NOF protocol standard. A module following the RDMA-NOF conversion module supplements NOF protocol information that needs to be carried in the NOF response packet, and sends an NOF response packet including complete NOF protocol information to the NOF proxy packet sending module.

Processing logic of the NOF-RDMA conversion module is different from that of the RDMA-NOF conversion module. When the RDMA-NOF conversion module processes the packet, the NOF status information has not been obtained, and a next module of the RDMA-NOF conversion module, namely, the NOF context table, needs to obtain the NOF status information. Therefore, the RDMA-NOF conversion module can pre-pad only information about an NVMe part in the NOF protocol.

### (3) Output

An output result of the NOF and RDMA packet conversion module is a packet in which some fixed fields and a field with known information in the target protocol are padded. For the NOF-RDMA conversion process, the target protocol is the RDMA protocol. For the RDMA-NOF conversion process, the target protocol is the NOF protocol.

NOF context table

The following specifically describes the NOF context table in terms of (1) to (4).

### (1) Format of the NOF Context Table

An index in the NOF context table is a value of an RDMA PSN. In the NOF-RDMA packet conversion procedure, the RDMA PSN in the NOF context table is generated by the gateway device in the process of generating the RDMA packet, and the RDMA PSN is, for example, from the RDMA proxy packet sending module.

In the RDMA-NOF packet conversion procedure, the RDMA PSN in the NOF context table is obtained by the gateway device by parsing an RDMA PSN field in the RDMA packet.

### (2) Content of Status Information in the NOF Context Table

The content of the status information in the NOF context table includes all missing NOF status information that needs to be returned to the client. Optionally, the status information is obtained by directly parsing the packet during NOF-RDMA conversion or by the gateway device through calculation. For example, the NOF is an RoCE (the RoCE protocol is a specific representation of a fabric). The NOF status information includes a PSN, a DQP, and an RETH at an RoCE layer, an SQHD and a command ID at an NVMe layer, and the like. The NOF status information that needs to be obtained includes but is not limited to the foregoing cases. A specific parameter may vary based on an actual application scenario. The PSN, the SQHD, and the command ID are obtained by the gateway device through calculation, and a specific calculation method is to perform addition correction based on a current value.

### (3) Function of the NOF Context Table

The NOF context table is responsible for maintaining a correspondence between a state in the NOF connection and a state in the RDMA connection. When the gateway device converts the NOF packet into the RDMA packet and interacts with the RDMA storage node based on the RDMA packet, there is no NOF status information in interaction at an RDMA side. The process of converting the NOF packet into the RDMA packet is similar to a CPU switching process, and there is no information about a current process (which is similar to interaction between the gateway and the client based on the NOF in this embodiment) in a switched new process (which is similar to interaction between the gateway and the RDMA storage node based on the RDMA in this embodiment). Therefore, a CPU stores the information about the current process (which is similar to the NOF status information in this embodiment) into the context table. Here, the concept of the context processed by the CPU is used to help understand the function of the NOF context table. The NOF context table is designed, so that when the NOF is converted to the RDMA, the gateway device stores current NOF status information in the NOF context table. After completing RDMA interaction, the gateway device restores the NOF status information based on the NOF context table.

### (4) Output

In the NOF-RDMA conversion process, the gateway device stores the NOF status information in the NOF context table, and subsequently, the RDMA proxy packet sending module continues to perform processing. In the RMDA-NOF conversion process, the gateway device searches for the NOF context table to obtain the NOF status information, and outputs the NOF status information to the NOF proxy packet sending module, thereby providing required parameters for the process of sending the NOF packet.

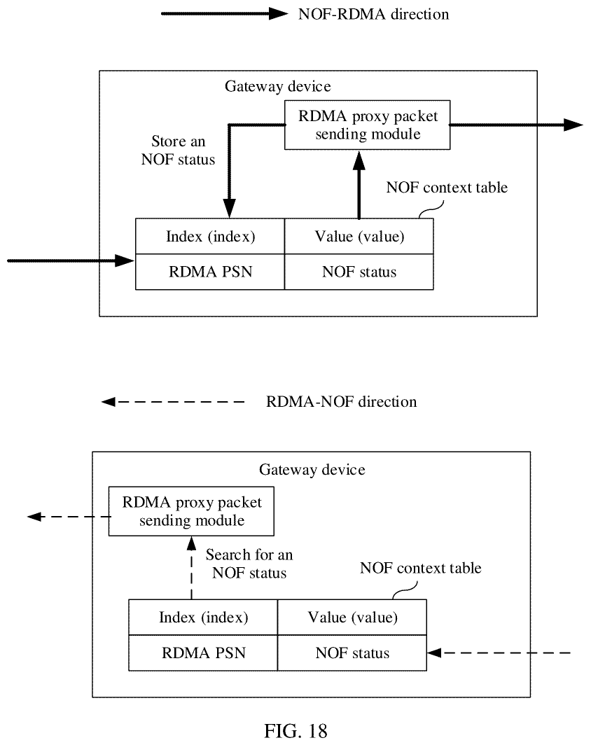

FIG. 18 shows an establishment process and a search process of the NOF context table. FIG. 18 is described by using an example in which the RDMA status information is an RDMA PSN. As shown in FIG. 18, in an NOF-RDMA direction, in the process of converting the NOF request packet into the RDMA request packet, a current RDMA PSN is obtained from the RDMA proxy packet sending module, the current RDMA PSN is used as an index in the NOF context table, an NOF status is obtained based on the NOF request packet, and the NOF status is used as a value, corresponding to the index, in the NOF context table, to establish the NOF context table. In an RDMA-NOF direction, in the process of converting the RDMA response packet into the NOF response packet, a PSN is obtained from the RDMA response packet, the NOF context table is searched for the NOF status information based on the PSN as an index, and the found NOF status information is provided to the NOF proxy packet sending module.

RDMA proxy packet sending module

The RDMA proxy packet sending module is similar to the NOF proxy packet sending module. A main difference between the RDMA proxy packet sending module and the NOF proxy packet sending module is that the RDMA proxy packet sending module serves as a proxy of the RDMA protocol. In addition, the RDMA proxy packet sending module is used in a packet sending phase only in the process of interacting with the RDMA storage node. The RDMA proxy packet sending module provides the following specific functions (1) to (3).

### (1) RDMA Protocol Stack Proxy

The gateway device implements the RDMA protocol stack. The gateway device, as the client, establishes a connection to the RDMA storage node. The RDMA proxy packet sending module mainly uses a part that is of the RDMA protocol stack and that is used by the client to send a packet.

### (2) RDMA Packet Construction

After NOF-RDMA instruction conversion is performed and the NOF status information is stored in the NOF context table, the RDMA proxy packet sending module constructs the RDMA request packet.

### (3) Output

An output result of the RDMA proxy packet sending module is an RDMA request packet sent to the RDMA storage node.

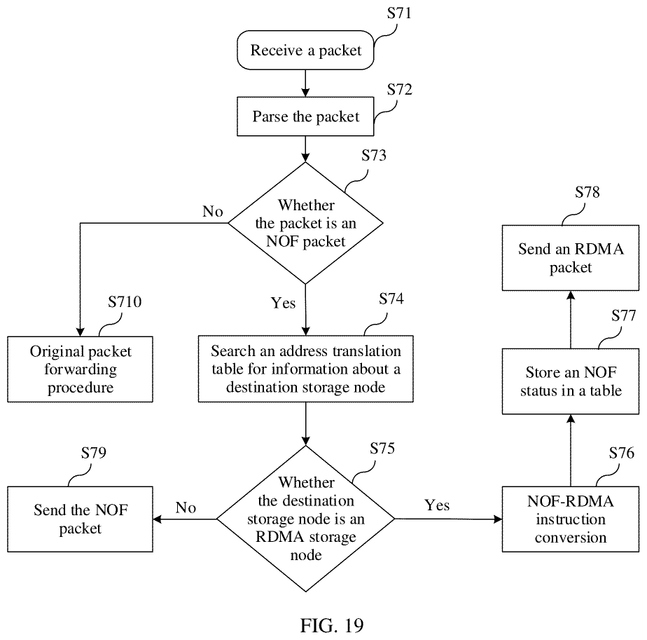

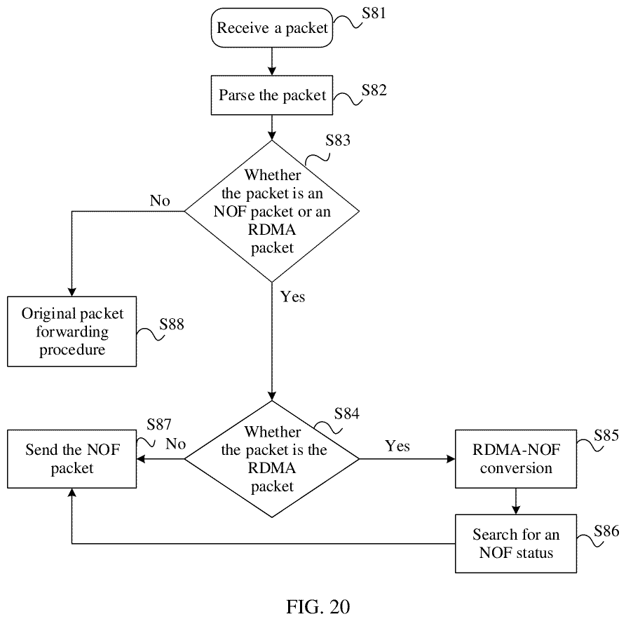

FIG. 19 and FIG. 20 each are a complete flowchart of a method performed by the gateway device in the example 1. FIG. 19 is the complete flowchart of the method performed by the gateway device in a direction from a client to a storage node. FIG. 20 is the complete flowchart of the method performed by the gateway device in a direction from a storage node to a client.

As shown in FIG. 19, a method procedure performed by the gateway device in the direction from the client to the storage node includes S71 to S710 as follows.

S71: The gateway device receives a packet.

S72: The gateway device parses the received packet.

S73: The gateway device determines whether the received packet is an NOF packet. If the received packet is the NOF packet, the gateway device performs S74. If the received packet is not the NOF packet, the gateway device performs S710.

S74: The gateway device searches an address translation table for information about a destination storage node.

S75: The gateway device determines whether the destination storage node is an RDMA storage node. If the destination storage node is the RDMA storage node, the gateway device performs S76. If the destination storage node is not the RDMA storage node, the gateway device performs S79.

S76: The gateway device performs NOF-RDMA instruction conversion.

S77: The gateway device stores an NOF status in an NOF context table.

S78: The gateway device implements an RDMA proxy function, and sends an RDMA packet.

S79: The gateway device implements an NOF proxy function, and sends an NOF packet.

S710: The gateway device forwards the packet according to an original packet forwarding procedure.

As shown in FIG. 20, a method procedure performed by the gateway device in the direction from the storage node to the client includes S81 to S88 as follows.

S81: The gateway device receives a packet.

S82: The gateway device parses the received packet.

S83: The gateway device determines whether the received packet is an NOF packet or an RDMA packet. If the received packet is the NOF packet or the RDMA packet, the gateway device performs S84. If the received packet is neither the NOF packet nor the RDMA packet, the gateway device performs S88.

S84: The gateway device determines whether the received packet is the RDMA packet. If the received packet is the RDMA packet, the gateway device performs S85. If the received packet is not the RDMA packet (that is, the received packet is the NOF packet), the gateway device performs S87.

S85: The gateway device converts information in the RDMA packet into information in an NOF protocol.

S86: The gateway device searches an NOF context table for NOF status information based on RDMA status information in the RDMA packet.

S87: The gateway device sends the NOF packet.

S88: The gateway device forwards the packet according to an original packet forwarding procedure.

The foregoing example 1 provides a new gateway device, where the gateway device is located at a gateway location of a storage node. The gateway device supports an NOF protocol stack and an RDMA protocol stack. The gateway device has an NOF-RDMA protocol stack conversion capability. In addition, the gateway device can direct a destination node based on a destination logical storage address.

Effect achieved by the example 1 includes but is e not limited to (1) to (3) as follows.

(1) An RDMA storage medium is a memory, and performance of the memory is better than that of an existing NVMe hard disk. Due to the gateway device provided in the example 1, an NOF storage network can support an RDMA, thereby exploiting an advantage of memory storage and improving performance.

(2) In an original storage solution, all service processing tasks are executed by a service end (namely, the storage node). The gateway device provided in the example 1 can offload some service processing tasks of the service end (that is, the gateway device replaces the service end to execute some service processing tasks), thereby reducing CPU pressure of the service end and improving overall performance.

(3) As described in (2), some service processing tasks of the service end (namely, the storage node) are offloaded to the gateway device. This can shorten a packet forwarding path, and further improve the overall performance.

It can be learned from the solution of the example 1 that, in the example 1, an existing NOF storage network structure is changed, and a case in which only an NOF storage node can be expanded at an original storage backend is changed. The gateway device in this embodiment can support expansion of an RDMA storage node in the NOF storage network.

In addition, in the example 1, a current situation in which all storage media in an existing NOF storage network are hard disks is changed, and hard disk operation semantics of an NVMe can be converted into memory operation semantics of an RDMA, to implement collaboration between a hard disk storage service and a memory storage service.

In addition, when there are a plurality of storage nodes, the gateway device can complete directing of a destination storage logical address, thereby reducing CPU pressure of an existing storage node.

In addition, the example 1 may be provided as a non-invasive expansion support solution. Non-intrusion means that the example 1 does not change current service deployment, thereby avoiding impact on an existing running system of a service. The example 1 can be used as an enhanced mode to optimize service performance.

### Example 2

The example 2 is an alternative solution of the NOF context table in the example 1.

A main difference between the example 2 and the example 1 lies in that the example 2 transmits an RDMA packet in a piggeback or piggeback-like mode. In the piggeback mode, a local end includes specified information in a packet and sends, to a peer end, the packet carrying the specified information, and then the peer end returns the specified information to the local end. In the example 2, the specified information is NOF status information or content of an NOF packet header.

When a destination storage node is an RDMA storage node, the gateway device does not store the NOF status information in the NOF context table, but pre-pads the existing NOF status information into a response packet header, and then encapsulates the response packet header including the NOF status information into an RDMA request packet. The NOF status information is used as additional header information in the RDMA request packet.

The RDMA storage node needs to sense this protocol change. The RDMA storage node does not process the additional header information; or the RDMA storage node processes the additional header information as required, for example, the RDMA storage node calculates an ICRC. In a process of generating an RDMA response packet, the RDMA storage node includes the additional header information in the RDMA response packet. The RDMA storage node sends an RDMA response packet including the additional header information, so that the additional header information is returned to the gateway device. The gateway device restores, based on this additional field, status information that needs to be carried in an NOF response packet. The gateway device constructs an NOF response packet and sends the NOF response packet to the client.

In this solution, because the NOF context table does not need to be stored, an internal storage space of the gateway device is saved, and a process of table lookup and writing is reduced.

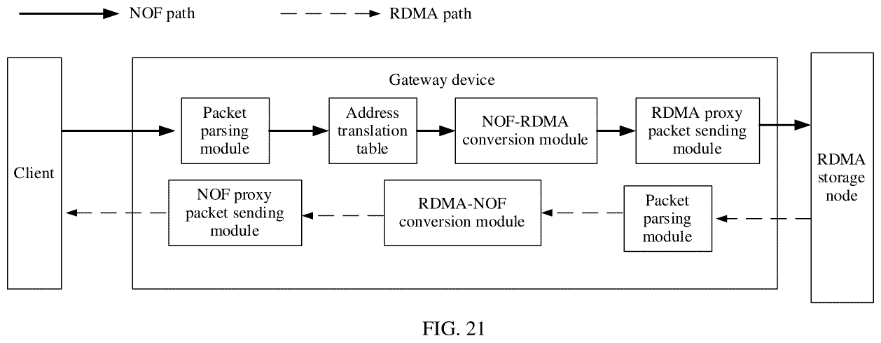

FIG. 21 is a diagram of a logical function architecture in the example 2. As shown in FIG. 21, a gateway device in the example 2 also includes a packet parsing module, an address translation table, an NOF-RDMA conversion module, an RDMA proxy packet sending module, and an NOF proxy packet sending module. The packet parsing module, the NOF-RDMA conversion module, and the address translation table in the example 2 are similar to those in the example 1.

In the example 2, processing of the additional header information is added to the RDMA proxy packet sending module and the NOF proxy packet sending module. The following describes service logic, newly added in the example 2, of the two modules: the RDMA proxy packet sending module and the NOF proxy packet sending module.

RDMA proxy packet sending module

The RDMA proxy packet sending module in the example 2 reserves an original function of the RDMA proxy packet sending module in the example 1. When constructing an RDMA packet, the RDMA proxy packet sending module in the example 2 adds a step of adding the additional header information to the RDMA packet. There are two specific implementations for the example 2. The following separately describes the two implementations by using an example in which a fabric layer of an NOF uses an RoCEv2 protocol.

Implementation (1): The gateway device includes the NOF status information in the RDMA packet.

Specifically, it is specified that each additional field in the RDMA packet carries specific information in the NOF status information. The additional header information carried in the additional field is similar to a value (namely, the NOF status information) in the NOF context table in the example 1. The additional header information in the RDMA packet is equivalent to a value of an entry in the NOF context table in the example 1. It may also be understood that the NOF status information does not need to be locally stored in the gateway device as a value of an entry in the NOF context table, but flows with the packet.

The RDMA storage node does not process the additional header information. The RDMA storage node receives only the RDMA packet carrying the additional field, extracts the additional header information from the additional field, and encapsulates the additional header information into the RDMA response packet after conventional service logic processing of the RDMA is completed. After receiving the RDMA response packet, the gateway device reads the additional header information according to a standard, and constructs the NOF response packet based on the additional header information.

Implementation (2): The gateway device pre-generates an NOF packet header, and uses the NOF packet header as the additional header information.

The gateway device constructs the NOF packet header in advance. The gateway device pads all existing NOF information to be returned to the client in the NOF packet header. Then, the gateway device uses the NOF packet header as the additional header information, and sends an RDMA request packet including the NOF packet header to the RDMA storage node. After the RDMA storage node receives the RDMA request packet, the RDMA storage node continues to process and modify the NOF packet header in the RDMA request packet. For example, the RDMA storage node supplements missing content of the NOF packet header, and calculates an ICRC of the packet. The RDMA storage node continues to use a processed NOF packet header as the additional header information, and encapsulates the NOF packet header into the RDMA response packet, so that the NOF packet header is used as an inner header in the RDMA response packet.

After receiving the RDMA response packet, the gateway device strips an outer packet header from the RDMA response packet. The gateway device uses a part starting from the inner header (NOF packet header) in the RDMA response packet as the NOF response packet.

The NOF proxy packet sending module in the example 2 and the RDMA proxy packet sending module in the example 2 are used together.

Compared with the example 1 in which the NOF status information is obtained from the NOF context table, in the example 2, the NOF proxy packet sending module obtains the NOF status information from the additional header information in the packet, and subsequent processing is similar to that in the example 1.

The NOF proxy packet sending module in the example 2 strips an outer header from the RDMA response packet, and forwards a packet after the outer header is stripped. Optionally, the NOF proxy packet sending module in the example 2 modifies a layer-2 part of the packet or a layer-3 part of the packet based on a network condition.

In the example 2, because the packet carries the additional header information, the additional header information occupies an additional space of the packet.

The additional space, in the packet, that needs to be occupied in the implementation (1) in the example 2 is consistent with a length of each entry in the NOF context table in the example 1. For example, an occupied additional space in the packet is about 20 B to 30 B in an RoCEv2 scenario.

In the implementation (2) in the example 2, because a complete layer-2 header and a complete layer-3 header are added to the packet, the added layer-2 header and the added layer-3 header need to occupy some additional spaces. Based on statuses of the layer-2 header and the layer-3 header, a space occupied by the added layer-2 header and the added layer-3 header in the packet is about 40 B to 50 B. Because there is a restriction relationship between a maximum transmission unit (MTU) of a forwarding physical layer and a length of a general RDMA packet under the corresponding MTU, after the NOF packet header is added to the packet, an overall packet length still meets a restriction of the MTU. Therefore, no extra fragmentation is caused.

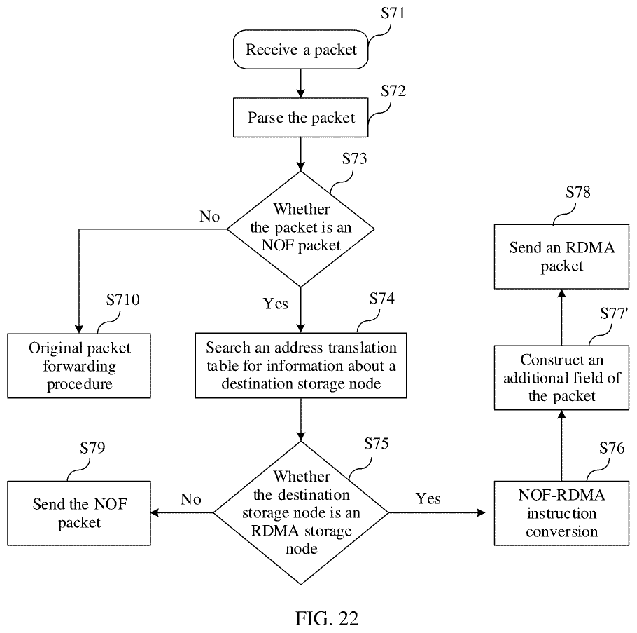

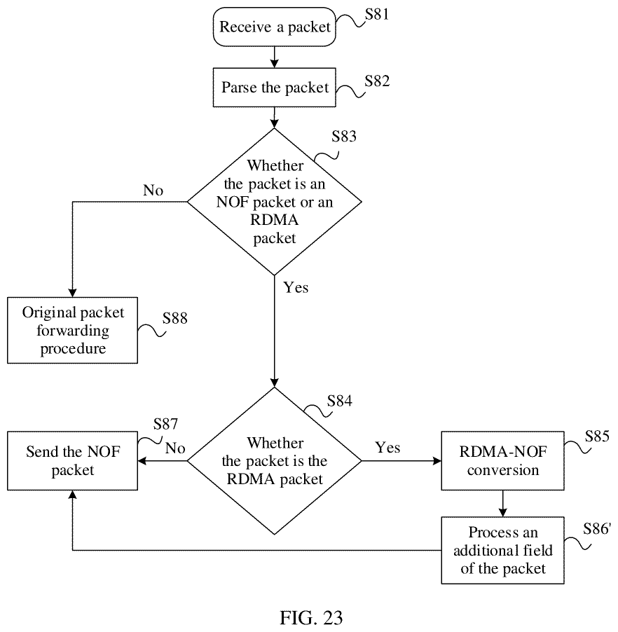

FIG. 22 and FIG. 23 each are a complete flowchart of a method performed by the gateway device in the example 2. FIG. 22 is the complete flowchart of the method performed by the gateway device in a direction from a client to a storage node. In a procedure shown in FIG. 22, S77 in the procedure shown in FIG. 19 in the example 1 is replaced with S77′, and the gateway device constructs an additional field of a packet. For other steps of the procedure shown in FIG. 22, refer to FIG. 19.

FIG. 23 is the complete flowchart of the method performed by the gateway device in a direction from a storage node to a client. In a procedure shown in FIG. 23, S86 in the procedure shown in FIG. 20 in the example 1 is replaced with S86′, and the gateway device processes an additional field of a packet. For other steps of the procedure shown in FIG. 23, refer to FIG. 20.

Technical effect of the example 2 is the same as that of the example 1. Through comparison of the example 1 and the example 2, the gateway device provided in the example 2 does not need to deploy an NOF context table, thereby reducing consumption of an internal storage space of the gateway device. In addition, in the example 2, a process of table lookup and writing is reduced. However, in the example 2, an RDMA protocol needs to be modified, so that the RDMA protocol supports identification and processing of the additional field.

### Example 3

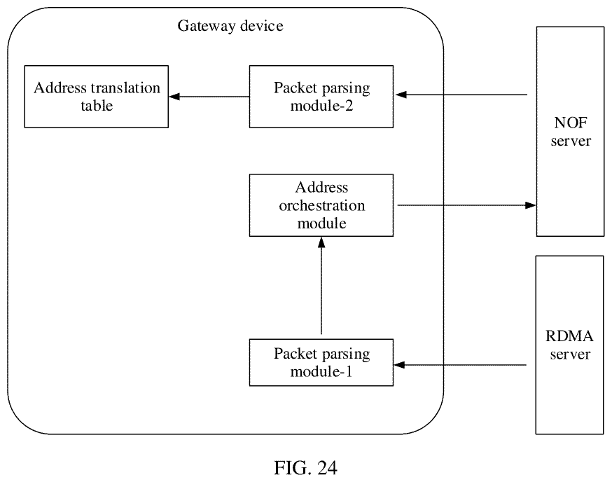

The example 3 is a supplement to the example 1 and the example 2. The example 3 mainly supplements a control plane procedure. FIG. 24 is a diagram of a logical function architecture in the example 3. As shown in FIG. 24, the gateway device in the example 3 includes a packet parsing module, an address translation table, and an address orchestration module. The packet parsing module and the address translation table in the example 3 are similar to those in the example 1. The example 3 mainly describes how to deliver an address of a storage node to the gateway device. The example 3 relates to a two-sided RDMA operation and an information exchange message of an NOF control channel.

### Address Orchestration Module

The address orchestration module is configured to process the information exchange packet of the NOF control channel and a packet for registering a storage address space through an RDMA in the two-sided RDMA operation. The address orchestration module performs unified orchestration management on RDMA storage nodes based on an NVMe storage address segment in the information exchange packet of the NOF control channel and a memory address reported by a two-sided operation packet, and then generates a unified virtual address, and the generated virtual address is subsequently written to the address translation table. The address orchestration module provides the following specific functions (1) to (3).

### (1) Address Resolution

In an RDMA protocol, an RDMA node registers an address of a memory space of an RDMA storage node by performing a send operation or a receive operation of the two-sided operation, and reports the address of the memory space to a user. Subsequently, the user can directly operate the address of the memory space based on the address reported by the RDMA node. In an NOF protocol, an NOF storage node notifies the user of an available hard disk address segment of the storage node through the control channel, and subsequently, the user can directly operate the hard disk address segment based on an address reported by the NOF storage node. The address orchestration module is configured to resolve, from a packet sent by the RDMA node, the memory address reported by the RDMA node, and resolve, from a packet sent by the NOF node, the hard disk address reported by the NOF node.

### (2) Address Orchestration

The address orchestration module uniformly orchestrates addresses reported by storage nodes into a global virtual address. The address obtained by the address orchestration module through orchestration is content in the address translation table. The address obtained by the address orchestration module through orchestration is specifically an index, namely, an NVMe logical address, used to search the address translation table for information about a destination storage node. The information about the destination storage node stored in the address translation table is the addresses reported by the storage nodes.

### (3) Output

The address orchestration module outputs an address entry obtained through orchestration to the address translation table.

This embodiment is described by using an example in which the NOF storage node reports the hard disk address to the gateway device through the control channel in the NOF protocol. In some other embodiments, a packet dedicated to reporting an address is provided, and the NOF storage node reports the hard disk address by sending the dedicated packet.

The address translation table in the example 3 is the same as that in the example 1. The example 1 describes a procedure of querying the address translation table, and the example 3 describes a procedure of writing the address translation table.

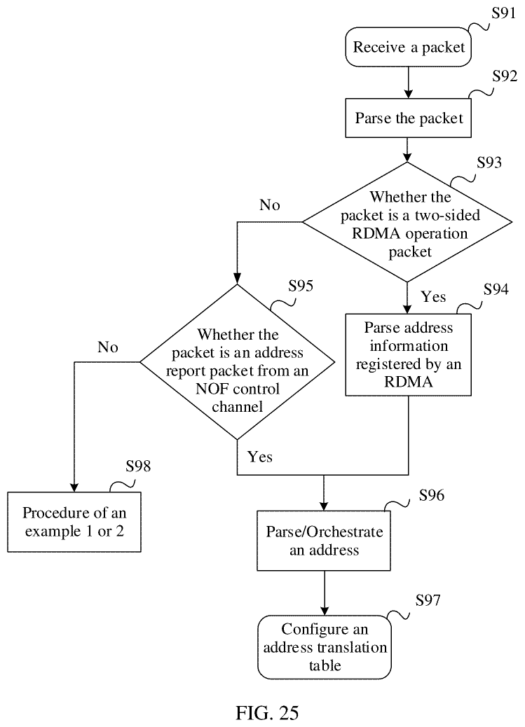

FIG. 25 is a complete flowchart of a method performed by the gateway device in the example 3. As shown in FIG. 25, a method procedure performed by the gateway device includes S91 to S98 as follows.

S91: The gateway device receives a packet.

S92: The gateway device parses the received packet.

S93: The gateway device determines whether the received packet is a two-sided RDMA operation packet.

If the received packet is the two-sided RDMA operation packet, the gateway device performs S94. If the received packet is not the two-sided RDMA operation packet, the gateway device performs S95.

S94: The gateway device parses address information registered by an RDMA.

S95: The gateway device determines whether the received packet is an address report packet from an NOF control channel. If the received packet is the address report packet from the NOF control channel, the gateway device performs S96. If the received packet is not the address report packet from the NOF control channel, the gateway device performs S98.

S96: The gateway device performs address orchestration based on an address carried in the packet, or resolves the address carried in the packet.

S97: The gateway device configures an address translation table.

S98: The gateway device performs the procedure in the example 1 or the example 2. The following describes technical effect of the example 3.

In the example 3, details about the example 1 and the example 2 are supplemented, and the control plane procedure is supplemented. The gateway device provided in this embodiment parses out a memory address reported by an RMDA storage node when the RMDA storage node registers a memory and a hard disk address reported by an NOF storage node through the control channel. The gateway device uniformly orchestrates addresses reported by storage nodes, and finally generates an entry of the address translation table.

In some other embodiments, the gateway device or each storage node reports a memory address of an RMDA storage node and a hard disk address of an NOF storage node to a service end that provides unified address orchestration management and control software. The service end performs address orchestration, and sends content of the address translation table to the gateway device.

According to the solutions of the foregoing embodiments, embodiments of this application implements the gateway device. The gateway device is optionally deployed in a conventional NOF storage network, and the gateway device implements the following functions (1) to (4).

(1) Supporting both the NOF protocol stack and the RDMA protocol stack

The gateway device provided in embodiments of this application can process the RDMA protocol stack, to implement the connection and interaction between the gateway device and the RDMA storage node.

The gateway device provided in embodiments of this application can process the NOF protocol stack, parse out the information about the NOF protocol stack, and maintain the status information of the NOF protocol stack. The gateway device can replace the NOF server to return the NOF packet to the client, to implement a function of serving as a proxy of the NOF server.

(2) NOF-RDMA protocol logic conversion mechanism. The NOF-RDMA protocol logic conversion mechanism is specifically used to convert the NOF request packet into the RDMA request packet and convert the RDMA response packet into the NOF response packet.

(3) NOF-RDMA address translation table

In embodiments, the NOF-RMDA address translation table is deployed on the gateway device. The address translation table implements mapping from the NVMe destination logical address in the NOF to the RDMA destination logical address.

(4) Replacing an original simple NOF hard disk medium storage solution in the NOF storage network with a hybrid storage mode of NOF hard disk medium storage and RDMA memory medium storage

The storage solution provided in embodiments of this application is optionally combined with the memory hard disk, to play a greater role.

Currently, most RDMA storage nodes are servers. In this embodiment, the RDMA storage node needs to implement basic functions: network protocol parsing, bus data migration, and memory medium operation, and does not need to have a strong CPU capability. Currently, an intelligent network interface card-PCIe bus-memory passthrough device is being researched. The intelligent network interface card-PCIe bus-memory passthrough device is lighter than the server. In this embodiment, this device is optionally used as the storage node to implement a massive storage solution of the NOF storage network. For example, with reference to the embodiment shown in FIG. 9, in a possible implementation, the first RDMA storage node in the embodiment shown in FIG. 9 is an intelligent network interface card-PCIe bus-memory passthrough device, and S405, S406, S407, and S408 in the embodiment shown in FIG. 9 are performed by an intelligent network interface card in the first RDMA storage node. In S406, the intelligent network interface card in the first RDMA storage node performs data transmission with the memory through the PCIe bus, to perform the read/write operation. Therefore, processing work of the CPU is offloaded to the intelligent network interface card. This reduces computing burden of the CPU and improves running efficiency of the embodiment shown in FIG. 9.

Optionally, the NOF uses another network except for an RoCE as a fabric carrying an NVMe. This embodiment is optionally applied to a scenario in which the NVMe is carried over another fabric, for example, applied to an NVMe over TCP scenario. In the NVMe over TCP scenario, the NVMe is directly carried over a TCP instead of a UDP and an IB. For example, with reference to the embodiment shown in FIG. 9, in a possible implementation, the first NOF request packet in S401 and the first NOF response packet in S411 in the embodiment shown in FIG. 9 are TCP packets, and the NOF status information includes a sequence number in the TCP. In this way, the gateway device supports interaction with the client according to the TCP, to meet more service scenarios.

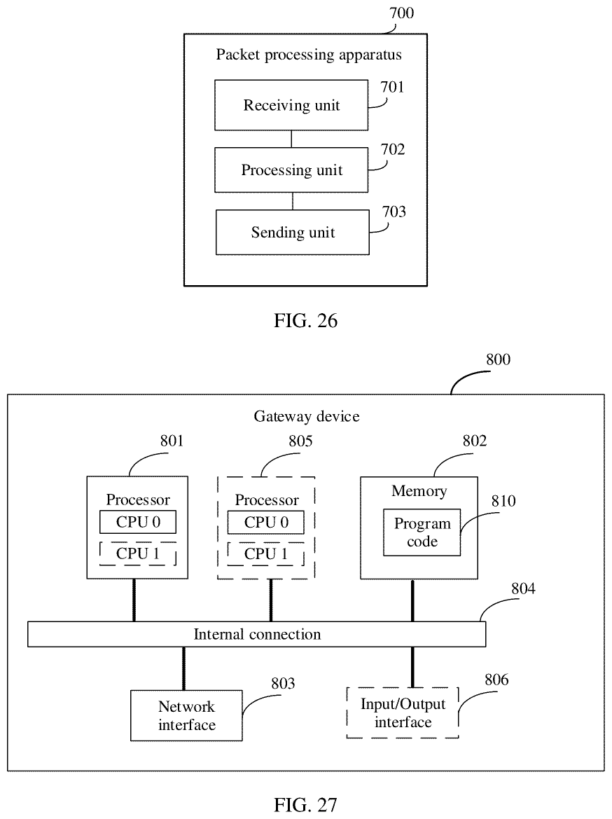

FIG. 26 is a schematic diagram of a structure of a packet processing apparatus 700 according to an embodiment of this application. The apparatus 700 shown in FIG. 26 is disposed on a gateway device. The apparatus 700 includes a receiving unit 701, a processing unit 702, and a sending unit 703.

Optionally, with reference to the application scenario shown in FIG. 8, the apparatus 700 shown in FIG. 26 is disposed on the gateway device 33 shown in FIG. 8.

Optionally, with reference to the method procedure shown in FIG. 9, the apparatus 700 shown in FIG. 26 is disposed on the gateway device shown in FIG. 9. The receiving unit 701 is configured to support the gateway device shown in FIG. 9 in performing S402 and S409. The processing unit 702 is configured to support the gateway device shown in FIG. 9 in performing S403 and S410. The sending unit 703 is configured to support the gateway device shown in FIG. 9 in performing S404 and S411.

Optionally, with reference to the method procedure shown in FIG. 11, the apparatus 700 shown in FIG. 26 is disposed on the gateway device shown in FIG. 11. The receiving unit 701 is configured to support the gateway device shown in FIG. 11 in performing S502 and S509. The processing unit 702 is configured to support the gateway device shown in FIG. 11 in performing S503 and S510. The sending unit 703 is configured to support the gateway device shown in FIG. 11 in performing S504 and S511.

Optionally, with reference to the application scenario shown in FIG. 12, the apparatus 700 shown in FIG. 26 is disposed on the gateway device shown in FIG. 12. The receiving unit 701 and the sending unit 703 are implemented through a network port in the gateway device shown in FIG. 12. The receiving unit 701 is configured to support the gateway device shown in FIG. 12 in receiving the NOF request packet from the client shown in FIG. 12. The sending unit 703 is configured to support the gateway device shown in FIG. 12 in sending the RDMA request packet to the RDMA storage node A shown in FIG. 12 or sending the NOF request packet to the NOF storage node shown in FIG. 12.

Optionally, with reference to the application scenario shown in FIG. 13, the apparatus 700 shown in FIG. 26 is disposed on the gateway device shown in FIG. 13. The apparatus 700 shown in FIG. 26 further includes a storage unit, and the storage unit is implemented by using a cache in the gateway device shown in FIG. 13.

Optionally, with reference to the application scenario shown in FIG. 14, the apparatus 700 shown in FIG. 26 is disposed on the gateway device shown in FIG. 14. The processing unit 702 includes the RDMA adapter and the NOF monitoring module in FIG. 14, and the receiving unit 701 and the sending unit 703 include ports in FIG. 14.

Optionally, with reference to the method procedure shown in FIG. 15, the apparatus 700 shown in FIG. 26 is disposed on the gateway device shown in FIG. 15. The processing unit 702 is configured to support the gateway device shown in FIG. 15 in performing S612, searching for an address translation table, performing simple NOF proxy processing, performing NOF-RDMA packet conversion, and performing RDMA-NOF packet conversion. The receiving unit 701 is configured to support the gateway device shown in FIG. 15 in receiving the address translation table delivered in S614, an NOF read/write request in S621, an NOF read/write response in S623, and an RDMA read/write response in S632. The sending unit 703 is configured to support the gateway device shown in FIG. 15 in performing S622, S631, and S633.

Optionally, with reference to the architecture shown in FIG. 16, the apparatus 700 shown in FIG. 26 is disposed on the gateway device shown in FIG. 16. The processing unit 702 includes the NOF-RDMA conversion module, the RDMA-NOF conversion module, and the packet parsing module in FIG. 16, and the sending unit 703 includes the NOF proxy packet sending module and the RDMA proxy packet sending module in FIG. 16. The apparatus 700 shown in FIG. 26 further includes a storage unit, and the storage unit is configured to store the NOF context table shown in FIG. 16.

Optionally, with reference to the architecture shown in FIG. 17, the apparatus 700 shown in FIG. 26 is disposed on the gateway device shown in FIG. 17. The apparatus 700 shown in FIG. 26 further includes a storage unit, and the storage unit is configured to store the address translation table shown in FIG. 17.

Optionally, with reference to the architecture shown in FIG. 18, the apparatus 700 shown in FIG. 26 is disposed on the gateway device shown in FIG. 18. The sending unit 703 includes the NOF proxy packet sending module and the RDMA proxy packet sending module in FIG. 18. The processing unit 702 is configured to perform the steps of storing the NOF status and searching for the NOF status shown in FIG. 18. The apparatus 700 shown in FIG. 26 further includes a storage unit, and the storage unit is configured to store the address translation table shown in FIG. 18.

Optionally, with reference to the method procedure shown in FIG. 19, the apparatus 700 is configured to support the gateway device in performing the method procedure shown in FIG. 19. The receiving unit 701 is configured to support the gateway device in performing S71 in FIG. 19. The processing unit 702 is configured to support the gateway device in performing S72, S73, S74, S75, S76, and S77 in FIG. 19. The sending unit 703 is configured to support the gateway device in performing S78, S79, and S710 in FIG. 19.

Optionally, with reference to the method procedure shown in FIG. 20, the apparatus 700 is configured to support the gateway device in performing the method procedure shown in FIG. 20. The receiving unit 701 is configured to support the gateway device in performing S81 in FIG. 20. The processing unit 702 is configured to support the gateway device in performing S82, S83, S84, S85, and S86 in FIG. 20. The sending unit 703 is configured to support the gateway device in performing S87 and S88 in FIG. 20.

Optionally, with reference to the architecture shown in FIG. 21, the apparatus 700 shown in FIG. 26 is disposed on the gateway device shown in FIG. 21. The processing unit 702 includes the packet parsing module, the NOF-RDMA conversion module, and the RDMA-NOF conversion module in FIG. 21. The sending unit 703 includes the RDMA proxy packet sending module and the NOF proxy packet sending module in FIG. 21. The apparatus 700 shown in FIG. 26 further includes a storage unit, and the storage unit is configured to store the address translation table shown in FIG. 21.

Optionally, with reference to the method procedure shown in FIG. 22, the apparatus 700 is configured to support the gateway device in performing the method procedure shown in FIG. 22. The receiving unit 701 is configured to support the gateway device in performing S71 in FIG. 22. The processing unit 702 is configured to support the gateway device in performing S72, S73, S74, S75, S76, and S77′ in FIG. 22. The sending unit 703 is configured to support the gateway device in performing S78, S79, and S710 in FIG. 22.

Optionally, with reference to the method procedure shown in FIG. 23, the apparatus 700 is configured to support the gateway device in performing the method procedure shown in FIG. 23. The receiving unit 701 is configured to support the gateway device in performing S81 in FIG. 23. The processing unit 702 is configured to support the gateway device in performing S82, S83, S84, S85, and S86′ in FIG. 23. The sending unit 703 is configured to support the gateway device in performing S87 and S88 in FIG. 23.

Optionally, with reference to the method procedure shown in FIG. 25, the apparatus 700 is configured to support the gateway device in performing the method procedure shown in FIG. 25. The receiving unit 701 is configured to support the gateway device in performing S91 in FIG. 25. The processing unit 702 is configured to support the gateway device in performing S92, S93, S94, S95, S96, and S97 in FIG. 25.

The described apparatus embodiment shown in FIG. 26 is merely an example. For example, division into the units is merely logical function division and may be other division during actual implementation. For example, a plurality of units or components may be combined or integrated into another system, or some features may be ignored or not performed. Functional units in embodiments of this application may be integrated into one processing unit, each of the units may exist alone physically, or two or more units are integrated into one unit.

All or some of the units in the apparatus 700 are implemented by software, hardware, firmware, or any combination thereof.

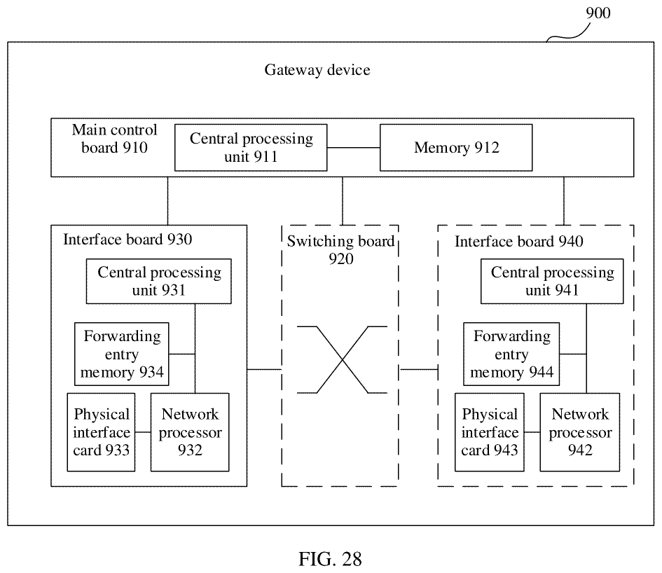

When software is used for implementation, for example, the processing unit 702 is implemented by a software functional unit that is generated after at least one processor 801 in FIG. 27 reads program code 810 stored in a memory 802. For another example, the processing unit 702 is implemented by a software functional unit that is generated after a network processor 932, a central processing unit 911, or a central processing unit 931 in FIG. 28 reads program code stored in a memory 912 or a memory 934.

When hardware is used for implementation, for example, the units in FIG. 26 are respectively implemented by different hardware in a device. For example, the processing unit 702 is implemented by at least one processor 801 in FIG. 27, or a part of processing resources (for example, one or two cores in a multi-core processor) of a network processor 932, a central processing unit 911, or a central processing unit 931 in FIG. 28, or is implemented by a programmable device such as a field-programmable gate array (FPGA) or a coprocessor. The receiving unit 701 and the sending unit 703 are implemented by a network interface 803 in FIG. 27 or an interface board 930 in FIG. 28.

FIG. 27 is a schematic diagram of a structure of a gateway device 800 according to an embodiment of this application. The gateway device 800 includes at least one processor 801, a memory 802, and at least one network interface 803.

Optionally, with reference to the application scenario shown in FIG. 8, the gateway device 800 shown in FIG. 27 is the gateway device 33 shown in FIG. 8.

Optionally, with reference to the method procedure shown in FIG. 9, the gateway device 800 shown in FIG. 27 is the gateway device shown in FIG. 9. The network interface 803 is configured to support the gateway device shown in FIG. 9 in performing S402, S404, S409, and S411. The processor 801 is configured to support the gateway device shown in FIG. 9 in performing S403 and S410.

Optionally, with reference to the method procedure shown in FIG. 11, the gateway device 800 shown in FIG. 27 is the gateway device shown in FIG. 11. The network interface 803 is configured to support the gateway device shown in FIG. 11 in performing S502, S504, S509, and S511. The processor 801 is configured to support the gateway device shown in FIG. 11 in performing S503 and S510.

Optionally, with reference to the application scenario shown in FIG. 12, the gateway device 800 shown in FIG. 27 is the gateway device shown in FIG. 12. The network interface 803 is a network port in the gateway device shown in FIG. 12.

Optionally, with reference to the application scenario shown in FIG. 13, the gateway device 800 shown in FIG. 27 is the gateway device shown in FIG. 13. The memory 802 includes a cache in the gateway device shown in FIG. 13.

Optionally, with reference to the application scenario shown in FIG. 14, the gateway device 800 shown in FIG. 27 is the gateway device shown in FIG. 14. The processor 801 includes the RDMA adapter and the NOF monitoring module in FIG. 14, and the network interface 803 includes ports in FIG. 14.

Optionally, with reference to the method procedure shown in FIG. 15, the gateway device 800 shown in FIG. 27 is the gateway device shown in FIG. 15. The processor 801 is configured to support the gateway device shown in FIG. 15 in performing S612, searching for an address translation table, performing simple NOF proxy processing, performing NOF-RDMA packet conversion, and performing RDMA-NOF packet conversion. The network interface 803 is configured to support the gateway device shown in FIG. 15 in receiving the address translation table delivered in S614, an NOF read/write request in S621, an NOF read/write response in S623, and an RDMA read/write response in S632, and performing S622, S631, and S633.

Optionally, with reference to the architecture shown in FIG. 16, the gateway device 800 shown in FIG. 27 is the gateway device shown in FIG. 16. The processor 801 includes the NOF-RDMA conversion module, the RDMA-NOF conversion module, and the packet parsing module in FIG. 16, and the network interface 803 includes the NOF proxy packet sending module and the RDMA proxy packet sending module in FIG. 16. The memory 802 is configured to store the NOF context table shown in FIG. 16.

Optionally, with reference to the architecture shown in FIG. 17, the gateway device 800 shown in FIG. 27 is the gateway device shown in FIG. 17. The memory 802 is configured to store the address translation table shown in FIG. 17.

Optionally, with reference to the architecture shown in FIG. 18, the gateway device 800 shown in FIG. 27 is the gateway device shown in FIG. 18. The network interface 803 includes the NOF proxy packet sending module and the RDMA proxy packet sending module in FIG. 18. The processor 801 is configured to perform the steps of storing the NOF status and searching for the NOF status shown in FIG. 18. The memory 802 is configured to store the address translation table shown in FIG. 18.

Optionally, with reference to the method procedure shown in FIG. 19, the gateway device 800 is configured to perform the method procedure shown in FIG. 19. The network interface 803 is configured to perform S71, S78, S79, and S710 in FIG. 19. The processor 801 is configured to perform S72, S73, S74, S75, S76, and S77 in FIG. 19.

Optionally, with reference to the method procedure shown in FIG. 20, the gateway device 800 is configured to perform the method procedure shown in FIG. 20. The network interface 803 is configured to perform S81, S87, and S88 in FIG. 20. The processor 801 is configured to perform S82, S83, S84, S85, and S86 in FIG. 20.

Optionally, with reference to the architecture shown in FIG. 21, the gateway device 800 shown in FIG. 27 is the gateway device shown in FIG. 21. The processor 801 includes the packet parsing module, the NOF-RDMA conversion module, and the RDMA-NOF conversion module in FIG. 21. The network interface 803 includes the RDMA proxy packet sending module and the NOF proxy packet sending module in FIG. 21. The memory 802 is configured to store the address translation table shown in FIG. 21.

Optionally, with reference to the method procedure shown in FIG. 22, the gateway device 800 is configured to perform the method procedure shown in FIG. 22. The network interface 803 is configured to perform S71, S78, S79, and S710 in FIG. 22. The processor 801 is configured to perform S72, S73, S74, S75, S76, and S77′ in FIG. 22.

Optionally, with reference to the method procedure shown in FIG. 23, the gateway device 800 is configured to perform the method procedure shown in FIG. 23. The network interface 803 is configured to perform S81, S87, and S88 in FIG. 23. The processor 801 is configured to perform S82, S83, S84, S85, and S86′ in FIG. 23.

Optionally, with reference to the method procedure shown in FIG. 25, the gateway device 800 is configured to perform the method procedure shown in FIG. 25. The network interface 803 is configured to perform S91 in FIG. 25. The processor 801 is configured to perform S92, S93, S94, S95, S96, and S97 in FIG. 25.

The processor 801 is, for example, a general-purpose central processing unit (CPU), a network processor (NP), a graphics processing unit (GPU), a neural network processing unit (neural network processing unit, NPU), a data processing unit (DPU), a microprocessor, or one or more integrated circuits configured to implement the solutions of this application. For example, the processor 801 includes an application-specific integrated circuit (ASIC), a programmable logic device (PLD), or a combination thereof. The PLD is, for example, a complex programmable logic device (CPLD), a field-programmable gate array (FPGA), a generic array logic (GAL), or any combination thereof.

In some embodiments, the processor 801 includes one or more CPUs, for example, a CPU 0 and a CPU 1 shown in FIG. 27.

The memory 802 is, for example, a read-only memory (ROM) or another type of static storage device that can store static information and instructions, or a random access memory (RAM) or another type of dynamic storage device that can store information and instructions, or an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, and the like), a magnetic disk storage medium or another magnetic storage device, or any other medium that can be used to carry or store expected program code in a form of instructions or a data structure and that is accessible by a computer, but is not limited thereto. Optionally, the memory 802 exists independently, and is connected to the processor 801 through an internal connection 804. Alternatively, the memory 802 and the processor 801 are optionally integrated together.

The network interface 803 is configured to communicate with another device or a communication network by using any transceiver-type apparatus. The network interface 803 includes, for example, at least one of a wired network interface or a wireless network interface. The wired network interface is, for example, an ethernet interface. The ethernet interface is, for example, an optical interface, an electrical interface, or a combination thereof. The wireless network interface is, for example, a wireless local area network (WLAN) interface, a cellular network interface, or a combination thereof.

In some embodiments, the processor 801 and the network interface 803 collaborate with each other to complete processes of sending a packet and receiving a packet in the foregoing embodiments.

For example, the process of sending the first RDMA request packet includes: The processor 801 indicates the network interface 803 to send the first RDMA request packet. In a possible implementation, the processor 801 generates an instruction and sends the instruction to the network interface 803, and the network interface 803 sends the first RDMA request packet according to the instruction of the processor 801.

For example, the process of receiving the first NOF request packet includes: The network interface 803 receives the first NOF request packet, performs partial processing (for example, decapsulation) on the first NOF request packet, and then sends the first NOF request packet to the processor 801, so that the processor 801 obtains information (for example, a first destination address) that is carried in the first NOF request packet and that is required in the foregoing embodiment.

In some embodiments, the gateway device 800 optionally includes a plurality of processors, for example, the processor 801 and a processor 805 shown in FIG. 27. Each of these processors is, for example, a single-core processor (single-CPU) or a multi-core processor (multi-CPU). The processor herein is optionally one or more devices, circuits, and/or processing cores configured to process data (for example, computer program instructions). In a possible implementation, a plurality of cores or a plurality of processors respectively perform some steps in the foregoing method embodiments.

In some embodiments, the gateway device 800 further includes the internal connection 804. The processor 801, the memory 802, and the at least one network interface 803 are connected through the internal connection 804. The internal connection 804 includes a channel for transmitting information between the foregoing components. Optionally, the internal connection 804 is a board or a bus. Optionally, the internal connection 804 is classified into an address bus, a data bus, a control bus, and the like. In some embodiments, the gateway device 800 further includes an input/output interface 806.

Optionally, the processor 801 implements the methods in the foregoing embodiments by reading program code 810 stored in the memory 802, or the processor 801 implements the methods in the foregoing embodiments by using program code stored therein. When the processor 801 implements the methods in the foregoing embodiments by reading the program code 810 stored in the memory 802, the memory 802 stores the program code for implementing the methods in embodiments of this application.

For more details of implementing the foregoing functions by the processor 801, refer to the descriptions in the foregoing method embodiments.

FIG. 28 is a schematic diagram of a structure of a gateway device 900 according to an embodiment of this application. The gateway device 900 includes a main control board 910 and an interface board 930.

Optionally, with reference to the application scenario shown in FIG. 8, the gateway device 900 shown in FIG. 28 is the gateway device 33 shown in FIG. 8.

Optionally, with reference to the method procedure shown in FIG. 9, the gateway device 900 shown in FIG. 28 is the gateway device shown in FIG. 9. The interface board 930 is configured to support the gateway device shown in FIG. 9 in performing S402, S404, S409, S411, S403, and S410.

Optionally, with reference to the method procedure shown in FIG. 11, the gateway device 900 shown in FIG. 28 is the gateway device shown in FIG. 11. The interface board 930 is configured to support the gateway device shown in FIG. 11 in performing S502, S504, S509, S511, S503, and S510.

Optionally, with reference to the application scenario shown in FIG. 12, the gateway device 900 shown in FIG. 28 is the gateway device shown in FIG. 12. The interface board 930 includes a network port in the gateway device shown in FIG. 12.

Optionally, with reference to the application scenario shown in FIG. 13, the gateway device 900 shown in FIG. 28 is the gateway device shown in FIG. 13. A forwarding entry memory 934 includes a cache in the gateway device shown in FIG. 13.

Optionally, with reference to the application scenario shown in FIG. 14, the gateway device 900 shown in FIG. 28 is the gateway device shown in FIG. 14. The interface board 930 includes the RDMA adapter, the NOF monitoring module, and ports shown in FIG. 14.

Optionally, with reference to the method procedure shown in FIG. 15, the gateway device 900 shown in FIG. 28 is the gateway device shown in FIG. 15. The interface board 930 is configured to support the gateway device shown in FIG. 15 in performing S612, searching for an address translation table, performing simple NOF proxy processing, performing NOF-RDMA packet conversion, performing RDMA-NOF packet conversion, receiving the address translation table delivered in S614, an NOF read/write request in S621, an NOF read/write response in S623, and an RDMA read/write response in S632, and performing S622, S631, and S633.

Optionally, with reference to the architecture shown in FIG. 16, the gateway device 900 shown in FIG. 28 is the gateway device shown in FIG. 16. The interface board 930 includes the NOF-RDMA conversion module, the RDMA-NOF conversion module, the packet parsing module, the NOF proxy packet sending module, and the RDMA proxy packet sending module in FIG. 16. The forwarding entry memory 934 is configured to store the NOF context table shown in FIG. 16.

Optionally, with reference to the architecture shown in FIG. 17, the gateway device 900 shown in FIG. 28 is the gateway device shown in FIG. 17. The forwarding entry memory 934 is configured to store the address translation table shown in FIG. 17.

Optionally, with reference to the architecture shown in FIG. 18, the gateway device 900 shown in FIG. 28 is the gateway device shown in FIG. 18. The interface board 930 includes the NOF proxy packet sending module and the RDMA proxy packet sending module in FIG. 18. The memory 912 or the forwarding entry memory 934 is configured to store the address translation table shown in FIG. 18.

Optionally, with reference to the method procedure shown in FIG. 19, the gateway device 900 is configured to perform the method procedure shown in FIG. 19. The interface board 930 is configured to perform S71, S78, S79, S710, S72, S73, S74, S75, S76, and S77 in FIG. 19.

Optionally, with reference to the method procedure shown in FIG. 20, the gateway device 900 is configured to perform the method procedure shown in FIG. 20. The interface board 930 is configured to perform S81, S87, S88, S82, S83, S84, S85, and S86 in FIG. 20.

Optionally, with reference to the architecture shown in FIG. 21, the gateway device 900 shown in FIG. 28 is the gateway device shown in FIG. 21. The interface board 930 includes the packet parsing module, the NOF-RDMA conversion module, the RDMA-NOF conversion module, the RDMA proxy packet sending module, and the NOF proxy packet sending module in FIG. 21. The forwarding entry memory 934 is configured to store the address translation table shown in FIG. 21.

Optionally, with reference to the method procedure shown in FIG. 22, the gateway device 900 is configured to perform the method procedure shown in FIG. 22. The interface board 930 is configured to perform S71, S78, S79, S710, S72, S73, S74, S75, S76, and S77′ in FIG. 22.

Optionally, with reference to the method procedure shown in FIG. 23, the gateway device 900 is configured to perform the method procedure shown in FIG. 23. The interface board 930 is configured to perform S81, S87, S88, S82, S83, S84, S85, and S86′ in FIG. 23.

Optionally, with reference to the method procedure shown in FIG. 25, the gateway device 900 is configured to perform the method procedure shown in FIG. 25. The interface board 930 is configured to perform S91, S92, S93, and S95 in FIG. 25, and the main control board 910 is configured to perform S94, S96, and S97 in FIG. 25.

The main control board 910 is also referred to as a main processing unit (MPU) or a route processor card. The main control board 910 controls and manages components in the gateway device 900, including functions of route calculation, device management, device maintenance, and protocol processing. The main control board 910 includes a central processing unit 911 and a memory 912.

The interface board 930 is also referred to as a line processing unit (LPU), a line card (line card), or a service board. The interface board 930 is configured to provide various service interfaces and forward a data packet. The service interface includes, but is not limited to, an ethernet interface, a POS (packet over SONET/SDH) interface, and the like. The ethernet interface is, for example, a flexible ethernet service interface (FlexE client). The interface board 930 includes a central processing unit 931, a network processor 932, a forwarding entry memory 934, and a physical interface card (PIC) 933.

The central processing unit 931 on the interface board 930 is configured to control and manage the interface board 930, and communicate with the central processing unit 911 on the main control board 910.

The network processor 932 is configured to forward a packet. A form of the network processor 932 may be a forwarding chip. Specifically, the network processor 932 is configured to forward a received packet based on a forwarding table stored in the forwarding entry memory 934. If a destination address of the packet is an address of the gateway device 900, the network processor 932 sends the packet to a CPU (for example, the central processing unit 911) for processing. If the destination address of the packet is not an address of the gateway device 900, the network processor 932 searches, based on the destination address, the forwarding table for a next hop and an outbound interface that correspond to the destination address from, and forwards the packet to the outbound interface corresponding to the destination address. Processing of an uplink packet includes processing an inbound interface of the packet and searching for the forwarding table. Processing of a downlink packet includes searching for the forwarding table and the like.

The physical interface card 933 is configured to implement a physical layer connection function, from which original traffic enters the interface board 930, and a processed packet is sent from the physical interface card 933. The physical interface card 933 is also referred to as a subcard, which may be installed on the interface board 930, and is responsible for converting an optical/electrical signal into a packet, performing validity check on the packet, and then forwarding the packet to the network processor 932 for processing. In some embodiments, the central processing unit may also perform a function of the network processor 932, for example, implement software forwarding based on a general-purpose CPU. Therefore, the network processor 932 is not required in the physical interface card 933.

Optionally, the gateway device 900 includes a plurality of interface boards. For example, the gateway device 900 further includes an interface board 940. The interface board 940 includes a central processing unit 941, a network processor 942, a forwarding entry memory 944, and a physical interface card 943.

Optionally, the gateway device 900 further includes a switching board 920. For example, the switching board 920 may also be referred to as a switch fabric unit (SFU). When the gateway device has a plurality of interface boards 930, the switching board 920 is configured to complete data exchange between the interface boards. For example, the interface board 930 and the interface board 940 may communicate with each other by using the switching board 920.

The main control board 910 and the interface board 930 are coupled. For example, the main control board 910, the interface board 930, the interface board 940, and the switching board 920 are connected to a system backplane through a system bus to implement interworking. In a possible implementation, an inter-process communication protocol (IPC) channel is established between the main control board 910 and the interface board 930, and communication is performed between the main control board 910 and the interface board 930 through the IPC channel.

Logically, the gateway device 900 includes a control plane and a forwarding plane. The control plane includes the main control board 910 and the central processing unit 931. The forwarding plane includes components that perform forwarding, such as the forwarding entry memory 934, the physical interface card 933, and the network processor 932. The control plane performs functions of a router, generating a forwarding table, processing signaling and protocol packets, and configuring and maintaining a device status. The control plane delivers the generated forwarding table to the forwarding plane. On the forwarding plane, the network processor 932 performs, based on the forwarding table delivered by the control plane, table lookup and forwarding on a packet received by the physical interface card 933. The forwarding table delivered by the control plane is stored, for example, in the forwarding entry memory 934. In some embodiments, the control plane and the forwarding plane are, for example, completely separated, and are not on a same device.

An operation on the interface board 940 is consistent with an operation on the interface board 930.

There may be one or more main control boards. When there are a plurality of main control boards, the main control boards include, for example, an active main control board and a standby main control board. There may be one or more interface boards. A network device with a stronger data processing capability provides a larger number of interface boards. There may also be one or more physical interface cards on the interface board. There may be no switching board or one or more switching boards. When there are a plurality of switching boards, load balancing and redundancy backup may be implemented together. In a centralized forwarding architecture, the network device may not need a switching board, and the interface board provides a function of processing service data of an entire system. In a distributed forwarding architecture, the network device may have at least one switching board, and data exchange between a plurality of interface boards is implemented by using the switching board, to provide a large-capacity data exchange and processing capability. Therefore, a data access and processing capability of the network device in the distributed architecture is greater than that of the device in the centralized architecture. Optionally, the network device may alternatively be in a form in which there is only one card. To be specific, there is no switching board, and functions of the interface board and the main control board are integrated on the card. In this case, the central processing unit on the interface board and the central processing unit on the main control board may be combined to form one central processing unit on the card, to perform functions obtained by combining the two central processing units. The device in this form (for example, the network device such as a low-end switch or a router) has a weak data exchange and processing capability. A specific architecture that is to be used depends on a specific networking deployment scenario, and is not limited herein.

Embodiments in this specification are described in a progressive manner. For same or similar parts in embodiments, refer to each other. Each embodiment focuses on a difference from other embodiments.

That A refers to B means that A is the same as B or that A is a simple variant of B.

In the specification and claims in embodiments of this application, the terms “first”, “second”, and the like are for distinguishing between different objects, but are not intended to describe a particular order of the objects, and cannot be understood as an indication or implication of relative importance. For example, the first RDMA storage node and the second RDMA storage node are used to distinguish between different RDMA storage nodes, but are not used to describe a particular order of the RDMA storage nodes, and cannot be understood as that the first RDMA storage node is more important than the second RDMA storage node.

In embodiments of this application, unless otherwise specified, “at least one” means one or more, and “a plurality of” means two or more. For example, a plurality of RDMA storage nodes are two or more RDMA storage nodes.

All or some of the foregoing embodiments may be implemented by software, hardware, firmware, or any combination thereof. When the software is used for implementation, all or some of the foregoing embodiments may be implemented in a form of a computer program product. The computer program product includes one or more computer instructions. When the computer program instructions are loaded and executed on a computer, all or some of the described procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, DVD), a semiconductor medium (for example, a solid state disk (SSD)), or the like.

The foregoing embodiments are merely intended for describing the technical solutions of this application other than limiting this application. Although this application is described in detail with reference to the foregoing embodiments, a person of ordinary skill in the art should understand that modifications may still be made to the technical solutions described in the foregoing embodiments or equivalent replacements may still be made to some technical features thereof, without departing from the scope of the technical solutions of embodiments of this application.

What is claimed is:

1. A packet processing method, comprising:
receiving, by a gateway device, a first non-volatile memory express (NVMe) over fabrics (NOF) request packet from a client, wherein the first NOF request packet carries an NVMe instruction instructing to perform a read/write operation on a first destination address;
obtaining, by the gateway device, information about a first remote direct memory access (RDMA) storage node based on the first destination address; and
sending, by the gateway device, a first RDMA request packet to the first RDMA storage node, wherein the first RDMA request packet carries an RDMA instruction corresponding to the NVMe instruction.

2. The method according to claim 1, wherein obtaining the information about the first RDMA storage node comprises:
obtaining, by the gateway device, the information about the first RDMA storage node by querying a first correspondence between the first destination address and the information about the first RDMA storage node.

3. The method according to claim 1, wherein the information about the first RDMA storage node comprises at least one of: a second destination address, network location information of the first RDMA storage node, identifiers of one or more queue pairs (QPs) in the first RDMA storage node, and a remote key (R_Key), wherein the second destination address points to a memory space of the first RDMA storage node, and the R_Key indicates permission to access a memory of the first RDMA storage node.

4. The method according to claim 3, wherein the network location information comprises at least one of a medium access control (MAC) address, an internet protocol (IP) address, a multi-protocol label switching (MPLS) label, or a segment identifier (SID).

5. The method according to claim 1, wherein after sending the first RDMA request packet to the first RDMA storage node, the method further comprises:
receiving, by the gateway device, an RDMA response packet from the first RDMA storage node, wherein the RDMA response packet is for the first RDMA request packet;
generating, by the gateway device, a first NOF response packet based on the RDMA response packet, wherein the first NOF response packet is for the first NOF request packet; and
sending, by the gateway device, the first NOF response packet to the client.

6. The method according to claim 5, wherein generating the first NOF response packet based on the RDMA response packet comprises:
obtaining, by the gateway device, RDMA status information based on the RDMA response packet, wherein the RDMA status information indicates a correspondence between the RDMA response packet and the first RDMA request packet;
obtaining, by the gateway device, NOF status information by querying a second correspondence based on the RDMA status information, wherein the second correspondence comprises a correspondence between the RDMA status information and the NOF status information, and the NOF status information indicates a correspondence between the first NOF response packet and the first NOF request packet; and
generating, by the gateway device, the first NOF response packet based on the NOF status information.

7. The method according to claim 6, wherein before obtaining the NOF status information by querying the second correspondence based on the RDMA status information, the method further comprises:
obtaining, by the gateway device, the NOF status information based on the first NOF request packet; and
establishing, by the gateway device, the second correspondence, wherein the second correspondence is between the NOF status information and the RDMA status information.

8. The method according to claim 5, wherein generating the first NOF response packet based on the RDMA response packet comprises:
generating, by the gateway device, the first NOF response packet based on NOF status information in the RDMA response packet.

9. The method according to claim 5, wherein the first RDMA request packet includes a first NOF packet header, the RDMA response packet includes a second NOF packet header generated by the first RDMA storage node based on the first NOF packet header, and the first NOF response packet includes the second NOF packet header.

10. The method according to claim 2, wherein the first correspondence further comprises information about a second RDMA storage node, the method further comprising:
in association with the NVMe instruction indicating the write operation, sending, by the gateway device, a second RDMA request packet to the second RDMA storage node, wherein the second RDMA request packet carries the RDMA instruction corresponding to the NVMe instruction.

11. The method according to claim 10, wherein the first RDMA request packet and the second RDMA request packet are multicast packets; or
the first RDMA request packet and the second RDMA request packet are unicast packets.

12. The method according to claim 2, further comprising:
in association with the NVMe instruction indicating the read operation, selecting, by the gateway device, the first RDMA storage node from a plurality of RDMA storage nodes according to a load balancing algorithm.

13. A gateway device, comprising:
a processor; and
a network interface, wherein
the processor is coupled to a memory,
the network interface is configured to receive or send a packet, and
the memory is configured to store one or more computer readable instructions that, when executed by the processor, cause the gateway device to:
receive a first non-volatile memory express (NVMe) over fabrics (NOF) request packet from a client, wherein the first NOF request packet carries an NVMe instruction instructing to perform a read/write operation on a first destination address;
obtain information about a first remote direct memory access (RDMA) storage node based on the first destination address; and
send a first RDMA request packet to the first RDMA storage node, wherein the first RDMA request packet carries an RDMA instruction corresponding to the NVMe instruction.

14. The gateway device according to claim 13, wherein the gateway device is further caused to:
obtain the information about the first RDMA storage node by querying a first correspondence between the first destination address and the information about the first RDMA storage node.

15. The gateway device according to claim 13, wherein the information about the first RDMA storage node comprises at least one of: a second destination address, network location information of the first RDMA storage node, identifiers of one or more queue pairs (QPs) in the first RDMA storage node, and a remote key (R_Key), wherein the second destination address points to a memory space of the first RDMA storage node, and the R_Key indicates permission to access a memory of the first RDMA storage node.

16. The gateway device according to claim 13, wherein the gateway device is further caused to:
receive an RDMA response packet from the first RDMA storage node, wherein the RDMA response packet is for the first RDMA request packet;
generate a first NOF response packet based on the RDMA response packet, wherein the first NOF response packet is for the first NOF request packet; and
send the first NOF response packet to the client.

17. The gateway device according to claim 16, wherein the gateway device is further caused to:
obtain RDMA status information based on the RDMA response packet, wherein the RDMA status information indicates a correspondence between the RDMA response packet and the first RDMA request packet;
obtain NOF status information by querying a second correspondence between the RDMA status information and the NOF status information, and the NOF status information indicates a correspondence between the first NOF response packet and the first NOF request packet; and
generate the first NOF response packet based on the NOF status information.

18. A storage system, comprising one or more RDMA storage nodes and the gateway device according to claim 13.

19. A non-transitory computer-readable storage medium having one or more computer readable instructions that, when executed by a computer, cause the computer to provide execution comprising:
receiving, by a gateway device, a first non-volatile memory express (NVMe) over fabrics (NOF) request packet from a client, wherein the first NOF request packet carries an NVMe instruction instructing to perform a read/write operation on a first destination address;
obtaining, by the gateway device, information about a first remote direct memory access (RDMA) storage node based on the first destination address; and
sending, by the gateway device, a first RDMA request packet to the first RDMA storage node, wherein the first RDMA request packet carries an RDMA instruction corresponding to the NVMe instruction.

20. A computer program product comprising one or more computer program instructions that, when loaded and run by a computer, enable the computer to perform the method according to claim 1.
